(19) United States
(12) Patent Application Publication
(10) Pub. No.: US 2006/0092329 A1
(43) Pub. Date: May 4, 2006

(54) Image display apparatus and correction apparatus thereof

(75) Inventor: Minoru Noji, Sagamihara-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/258,204

(22) Filed: Oct. 26, 2005

(30) Foreign Application Priority Data
Oct. 29, 2004 (JP) 2004-315604
Sep. 5, 2005 (JP) 2005-256773

(51) Int. Cl. H04N 17/02; H04N 9/12

(52) U.S. Cl. 348/607; 348/383; 348/189; 345/690

(57) ABSTRACT

An image display apparatus for correcting an unevenness of brightness or color in a plurality of pixels in a display unit, comprising: a correction circuit that corrects the unevenness of brightness or color in the pixels by correcting an image input signal using correction data for correcting the unevenness in the pixels of the display unit, wherein said correction circuit includes: a first memory that holds the correction data; a second memory that holds compressed data obtained by compressing the correction data; and an operation unit that performs a processing for sequentially extending the compressed data for every part of the compressed data based on the compressed data read from the second memory, to provide the correction data on a part of corresponding pixels to be corrected, wherein the correction data held in the first memory is sequentially rewritten for the every part of the correction data by the operation unit.

### BACKGROUND OF THE INVENTION

1. Field of the Invention

The present invention relates to an image display apparatus and a correction apparatus of an image display apparatus. The present invention is adapted particularly suitably to an image display apparatus capable of improving so-called display screen uniformity such as gradation characteristics, a luminance difference, and a color difference on a display screen, that is, capable of improving a luminance difference or a brightness difference in every pixel.

2. Description of the Related Art

In recent years, as a display screen is made larger in size, various display devices such as a CRT projector, a liquid crystal projector, a plasma display, and a liquid crystal display as well as a conventional CRT direct viewing television have entered the market. These image display apparatuses are required to have high-level luminance and chromaticity uniformity on a screen according to purposes.

A three-LCD projector as one example of a conventional image display apparatus will be described.

Namely, as a display area of a projector is recently made larger in size, there occurs a uniformity failure such as a luminance difference or a color difference on the screen resulting from characteristic differences in a light source, an optical system, and a liquid crystal display device serving as an image display device that constitute the apparatus.

It is, therefore, necessary to incorporate a circuit that corrects the uniformity failure resulting from a combination of these factors into the image display apparatus. Such a technique is disclosed in, for example, Japanese Patent Application Laid-Open No. 61-234395. The technique disclosed in Japanese Patent Application Laid-Open No. 61-234395 will now be described. FIG. 23 is a block diagram of the conventional liquid crystal projector or image display apparatus disclosed in Japanese Patent Application Laid-Open No. 61-234395.

As shown in FIG. 23, the conventional liquid crystal projector includes an image signal input terminal 1, a signal processing circuit 90, a timing signal generating unit 20 that includes a sync separation circuit 201 and a phase synchronization circuit (PLL circuit) 202, an adder 91, a AD converter 92, a drive circuit 93, and a memory device 96 that includes a memory 94 and an address counter 95.

A fixed-level video signal is input to the image signal input terminal 1 of the image display apparatus, and a picture corresponding to this video signal is displayed on a screen. As shown in FIG. 24, a luminance level of each area obtained by appropriately dividing the display screen is measured by a video camera or the like, and a DC differential data between the measured luminance level and a target luminance level is recorded in the memory 94 as luminance correction data.

The memory 94 in which the correction data is recorded is incorporated into a luminance correction circuit of the image display apparatus. To read this correction data, addresses of the memory 94 corresponding to the display area divided during the luminance measurement are calculated from a horizontal, vertical synchronization signal of input signal.

This correction data is converted into an analog value by the DA converter 92. This analog correction value is added to the input video signal by the adder 91, and the liquid crystal display device is driven by the resultant video signal through the drive circuit 93 of the image display apparatus. The uniformity failure on the display screen is thereby corrected.

### SUMMARY OF THE INVENTION

However, according to knowledges and considerations of the inventor of the present invention, the luminance measurement based on which the correction data is formed is performed at a certain luminance level. Due to this, there is a probability that the luminance and color differences are not corrected in all areas from input of a video signal at a low luminance (near a black level) to input of a video signal at a high luminance (near a white level).

Further, according to this conventional technique, the correction is made using a typical correction value for each area obtained by appropriately dividing the display area. Due to this, an unnatural color or a luminance discontinuity tends to appear to a corrected display image on each area boundary on the screen.

It is an object of the present invention to provide a display apparatus capable of correcting an unevenness of brightness or an unevenness of color using small memory capacity.

To achieve the object, according to a first aspect of the present invention, there is provided a correction apparatus of an image display apparatus for correcting an unevenness of brightness or color in a plurality of pixels in a display unit, comprising:

a correction circuit that corrects the unevenness of brightness or color by correcting an image input signal for the each gradation level of the image input signal using correction data for correcting the unevenness in a display surface of the display unit, the correction data being provided independently for each displayable gradation level,

wherein the correction circuit includes:

a first memory that has rewritable data for the each pixel and that holds the correction data;

a second memory that holds data on a differential value between initial correction data and the correction data between the pixels; wherein

an operation unit that reproduces the correction data on the pixel to be corrected by an operation processing based on the data on the differential value read from the second memory, and

the correction data of the first memory is rewritten by the operation unit.

In addition, here, the unevenness of brightness is not restricted to the unevenness of luminance which is one of brightness in a narrow sense.

The brightness includes all degrees of the strength of light that can be perceived. In a display device using a pulse width modulation, integration value of luminance in a predetermined period can be adopted as the degree of the strength of the light. A horizontal selecting period or a frame period can be adopted as the predetermined period.

Preferably, according to the first aspect of the present invention, the second memory holds the initial correction data and the data on the differential value between the pixels in a horizontal direction, for every horizontal scan line of the display unit, and rewrites the data of the first memory for the each pixel based on the initial correction data and the data on the differential value.

Preferably, according to the first aspect of the present invention, the second memory holds the initial correction data and the data obtained by coding the number of pixels in a horizontal direction until the correction data on the pixels in the horizontal direction is changed to a predetermined value, for every horizontal scan line of the display unit, and rewrites the data of the first memory for the each pixel based on the initial correction data and the data on the differential value.

According to a second aspect of the present invention, there is provided an image display apparatus for correcting unevenness of brightness or color in a plurality of pixels in a display unit, comprising:

a correction circuit that corrects the unevenness of brightness or color in the pixels by correcting an image input signal using correction data for correcting the unevenness in the pixels of the display unit, wherein

the correction circuit includes:

a first memory that holds the correction data;

a second memory that holds compressed data obtained by compressing the correction data; and

an operation unit that performs a processing for sequentially extending the compressed data for every part of the compressed data based on the compressed data read from the second memory, to thereby provide the correction data on a part of corresponding pixels to be corrected, wherein

the correction data held in the first memory is sequentially rewritten for the every part of the correction data by the operation unit.

According to the second aspect of the present invention, it is unnecessary to hold all of necessary correction data on all pixels needed to be corrected in the first memory at a time. According to this second aspect of the present invention, the compressed correction data (compressed data) read from the second memory is extended to a part of the correction data so as to rewrite the data of the first memory. It is thereby possible to suppress a necessary memory from being made large in size. Further, according to the second aspect of the present invention, the correction circuit includes the first memory and the second memory to hold the correction data within the image display apparatus. By doing so, even if the compressed data is used for reducing a storage capacity of the memory, the unevenness of brightness or color in the pixels can be corrected without decreasing a processing rate. Further, even a display apparatus in which both the unevenness of brightness and the unevenness of color are correct simultaneously can be practiced without difficulty.

According to a third aspect of the present invention, there is provided an image display apparatus comprising: a first memory capable of rewriting gradation correction data at least for each display pixel clock; a second memory that prestored correction data on a difference in a display screen for every horizontal scan line as initial value data on each horizontal line for generating gradation correction data and differential compressed data including a code indicating an increase and a reduction of a correction value between the pixels in the horizontal direction for every class of a gradation correction value subsequent to the initial value data; an initial value data reproducing unit that reads the correction data from the second memory for the every scan line; an addition/subtraction unit that executes one of or both of an addition operation processing and a subtraction operation processing; a correction data reproducing unit that includes a data holding unit holding the gradation correction data one pixel clock period before for one pixel clock in the addition/subtraction unit; and a timing signal generating unit that generates a timing signal for controlling the first memory, the second memory, the initial valued at a reproducing unit, and the correction data reproducing unit at a predetermined timing, wherein the initial value data reproducing unit reproduces the initial value data sequentially read from the second memory for the every scan line, the correction data reproducing unit sequentially reproduces the differential compressed data on the correction values between the pixels in the horizontal direction for every class of the gradation correction value, the differential compressed data sequentially read from the second memory based on the reproduced initial value data, and the image display apparatus further comprises a correction unit that rewrites a correction table value in the first memory as the gradation correction data intrinsic to each pixel for every pixel clock, that converts the image signal input to the first memory into a table value adaptable to a correction table of the first memory for every pixel clock, and that simultaneously executes the gradation correction, the color difference correction, and a correction of the unevenness of brightness.

According to a fourth aspect of the present invention, there is provided an image display apparatus, comprising: a first memory capable of rewriting gradation correction data at least for each display pixel clock; a second memory that prestored horizontal line initial value data for generating gradation correction data for every horizontal scan line, data subsequent to the horizontal line initial value data and indicating whether a correction value between pixels in a horizontal direction at each class of a gradation correction value is increased or reduced by a predetermined value, and compressed code data on the number of pixels in the horizontal direction changed by the predetermined value; an initial value data reproducing unit that reads the correction data from the second memory for every scan line; decoding means for decoding the compressed coded data for the every class of the gradation correction value; and a timing signal generating unit that generates a timing signal for controlling the first memory, the second memory, the initial value data reproducing unit, and the decoding means at a predetermined timing, wherein the initial value data reproducing unit reproduces the initial value data sequentially read from the second memory for the every scan line, the decoding means decodes the data indicating whether the correction value between the pixels in the horizontal direction for the every class of the gradation correction value is increased or reduced by the predetermined value, the data sequentially read from the second memory based on the reproduced initial value data, and the compressed coded data represented by data indicating the number of pixels in the horizontal direction changed by the predetermined value, and reproduces correction data, and a correction table value of the first memory is rewritten as the gradation correction data intrinsic to the each pixel for every pixel clock or synchronously with a pixel clock based on the correction data, and the image display apparatus further comprises a correction unit that converts an image signal input to the first memory into a table value corresponding to a correction table in the first memory for the every pixel clock, and that simultaneously executes the gradation correction, the color difference correction, and the correction of the unevenness of brightness.

According to the third and the fourth aspects of the present invention, it is preferable that the second memory is constituted by a rewritable recording medium, the image display apparatus further includes a third memory having rewritable data, and that an information processing unit constituted to be able to execute an operation processing rewrites the data held in the second memory based on the data of the third memory.

Preferably, according to the third and fourth aspect of the present invention, there is provided an image display apparatus, wherein the addition/subtraction unit of correction circuit includes: a data holding unit that holds gradation correction initial value data on one scan line before for one line period; and a control timing generating unit that controls the second memory, at least in the second memory, a data area from which the gradation correction data can be read before timing of reading the gradation correction data on a first scan line, and a data area from which a differential value of the initial value data on the line from at least one change value and data indicating whether the change value is subjected to an increase or a reduction can be read as the initial value data on one line before, for a second line to a final line are constituted, on the first scan line, difference correction is executed by initial values of memory addresses corresponding to the first scan line and inter-pixel correction data on the memory addresses corresponding to the first scan line, on each of scan lines following the first scan line, the difference correction is executed by initial values obtained by performing an operation between the initial value data on one line before and initial value differential data on the initial value data on the memory addresses of the scan line, and the inter-pixel correction data on the memory addresses corresponding to the scan line.

Further, according to the present invention, the second memory includes (1/m) first memory blocks and (m−1)/m second memory blocks for each of n gradations. Each first memory block includes data addresses for the initial value data on the difference correction value on each scan line and the differential value data on the difference correction value between a plurality of pixels by as much as the number corresponding to the scan lines. A second memory block includes the initial value data on the difference correction value on each scan line by as much as the number corresponding to the scan lines. On this scan line and all scan lines, the difference correction is executed for every (1/m) gradations of the n gradations based on the initial value data on the difference correction value in each scan line and the differential value data on the difference correction value of the pixel and difference correction values among a plurality of pixels on the first memory blocks at each class. The initial value data on the difference correction value on each scan line in the second memory blocks and the differential value data on the difference correction value of the pixel and the difference correction values among a plurality of pixels at the closest scan line addresses in the first memory blocks are selected for every ((m−1)/m) gradations of the n gradations, the correction data is reproduced, and the difference correction is executed on this scan line and all scan lines based on the reproduced correction data. It is preferable that the correction data addresses in the first memory blocks of the second memory include an initial value data address for every plural lines and a differential value data address of a difference correction value for every plural pixels. The correction data addresses in the second memory blocks of the second memory include an initial value data address for every plural lines, pieces of the correction data common to a plurality of classes, a plurality of lines, and a plurality of pixels are reproduced, and the difference correction is executed.

Furthermore, in the correction apparatus of the image display apparatus according to the present invention, the second memory includes (1/m) first memory blocks and (m−1)/m second memory blocks for each of n gradations, where n is natural number. Each first memory block includes data addresses by as much as the number corresponding to the scan lines for the data indicating whether the difference correction value between the initial value data on the difference correction value on each scan line and the pixel is increased or reduced by a predetermined value and the code data represented by data on the number of pixels in the horizontal direction changed by a predetermined value. Each second memory block includes the initial value data on the difference correction value on each scan line by as much as the number corresponding to the scan lines. On this scan line and all scan lines, the difference correction is executed for every (1/m) gradations of the n gradations based on the initial value data on the difference correction value in each scan line, the data indicating whether the difference correction value between the pixels is increased or reduced by a predetermined value, and the code data represented by data on the number of pixels in the horizontal direction changed by a predetermined value in the first memory blocks of each class. The initial valued at a on the difference correction value on each scan line in the second memory blocks, the data indicating whether the difference correction value between the pixels at the closest scan line addresses in the first memory block is increased or reduced by a predetermined value, and the code data represented by data on the number of pixels in the horizontal direction changed by a predetermined value are selected for every ((m−1)/m) gradations of then gradations, the correction data is reproduced, and the difference correction is executed on this scan line and all scan lines based on the reproduced correction data.

### DESCRIPTION OF THE DRAWINGS

FIG. 1 is a block diagram that depicts all constituent circuits according to a first embodiment of the present invention;

FIG. 2 is a schematic diagram that depicts a configuration of a projection unit of a three-LCD projector according to the first embodiment of the present invention;

FIG. 3 is a block diagram that depicts a gradation correction unit according to the first embodiment of the present invention;

FIG. 4 is a block diagram that depicts a configuration of a memory cell in a first LUT unit according to the first embodiment of the present invention;

FIG. 5 depicts an address configuration of a memory cell in a second LUT unit according to the first embodiment of the present invention;

FIG. 6 is a graph that depicts one example of a gradation correction characteristic for one pixel;

FIG. 7 is a timing chart that depicts a read timing of reading data from the memory cells in the second LUT unit according to the first embodiment of the present invention;

FIG. 8 is a schematic diagram that depicts a configuration of a gradation correction unit according to a second embodiment of the present invention;

FIG. 9 depicts a data configuration of a memory cell in a second LUT unit according to the second embodiment of the present invention;

FIG. 10 is a code table according to the second embodiment of the present invention;

FIG. 11 is a timing chart that depicts a read timing of reading data from the memory cells in the second LUT unit according to the second embodiment of the present invention;

FIG. 12 is a block diagram that depicts a circuit configuration of an extension processing unit according to the second embodiment of the present invention;

FIG. 13 is a block diagram that depicts a display apparatus according to a third embodiment of the present invention;

FIG. 14 is a circuit block diagram of a gradation correction unit according to a fourth embodiment of the present invention;

FIG. 15 depicts an address configuration of a memory cell in a second LUT unit according to the fourth embodiment of the present invention;

FIG. 16 depicts an address configuration of a memory cell in a second LUT unit according to a fifth embodiment of the present invention;

FIG. 17 is a timing chart that depicts a read timing of reading data from the memory cells of the second LUT unit according to the fifth embodiment of the present invention;

FIG. 18 depicts an address configuration of a memory cell in a second LUT unit according to a sixth embodiment of the present invention;

FIG. 19 depicts an address configuration of a memory cell in a second LUT unit according to a seventh embodiment of the present invention;

FIG. 20 depicts a second LUT unit, an initial value generating unit, and a correction data reproducing unit according to a ninth embodiment of the present invention;

FIG. 21 depicts an address configuration of a memory cell in the second LUT unit according to the ninth embodiment of the present invention;

FIG. 22 is a timing chart that depicts timings of memory cell reading and correction value reproduction according to the ninth embodiment of the present invention;

FIG. 23 is a circuit block diagram of a conventional display apparatus; and

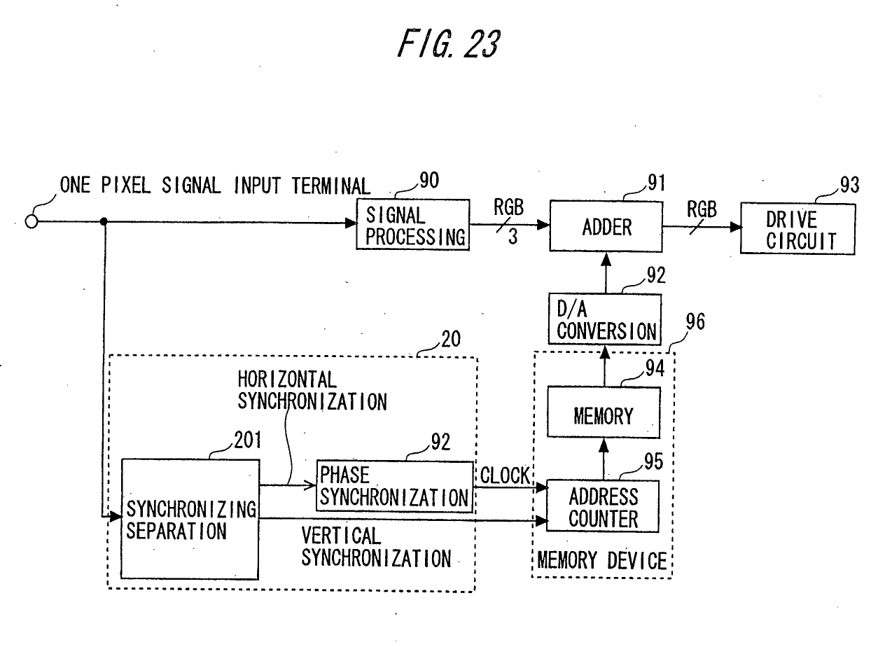

FIG. 24 is a schematic diagram that depicts an example of dividing a screen in the conventional display apparatus.

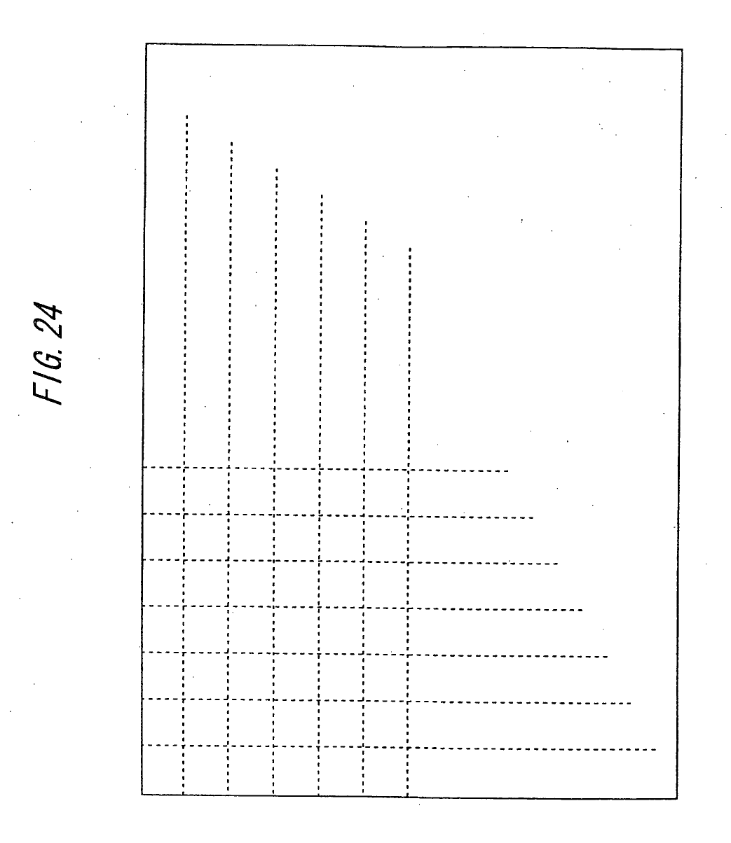

### DETAILED DESCRIPTION OF THE INVENTION

Embodiments of the present invention will be described hereinafter with reference to the drawings. In all the drawings of the embodiments, like or corresponding constituent elements are denoted by the same reference numerals, respectively.

### FIRST EMBODIMENT

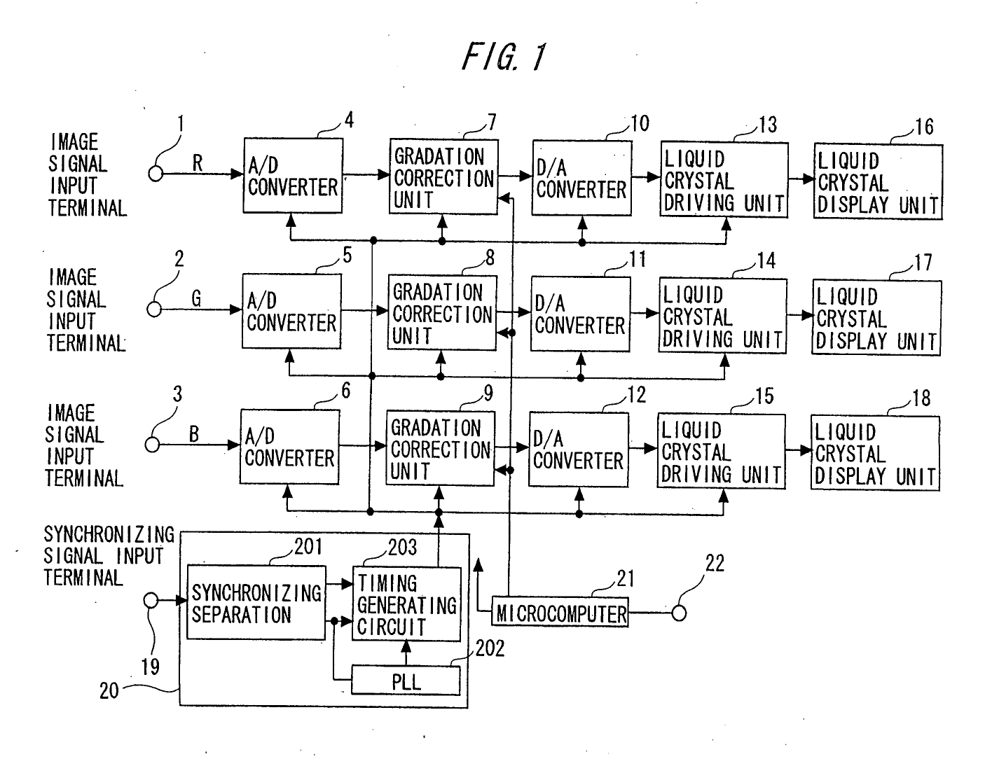

An image display apparatus according to a first embodiment of the present invention will be described. FIG. 1 is a block diagram of the image display apparatus according to the first embodiment.

As shown in FIG. 1, the image display apparatus according to this first embodiment includes image signal input terminals 1, 2, and 3 in which primary color image signals of red (R), green (G), and blue (B) are input, respectively, AD converters 4, 5, and 6, gradation correction units 7, 8, and 9, DA converters 10, 11, and 12, liquid crystal driving units 13, 14, and 15, liquid crystal display units 16, 17, and 18, a synchronizing signal input terminal 19, a microcomputer unit 21, and a timing signal generating unit 20 that includes a sync separation circuit 201, a PLL circuit 202, and a timing signal generating circuit 203.

The primary color image signals of red (R), green (G), and blue (B) are input to the respective image signal input terminals 1, 2, and 3. These primary color image signals are supplied to the AD converters 4, 5, and 6 in rear of the respective image signal input terminals 1, 2, and 3 and quantized by the AD converters 4, 5, and 6, respectively. According to the first embodiment, each of the primary color image signals of red (R), green (G), and blue (B) is quantized to 8 bits.

The quantized 8-bit digital image signals of red (R), green (G), and blue (B) are supplied to the gradation correction units 7, 8, and 9, respectively. The gradation correction units 7, 8, and 9 simultaneously perform a gradation correction and a so-called screen difference correction of correcting a luminance difference and a color difference as will be described later. According to this first embodiment, 10-bit digital output image signals of red (R), green (G), and blue (B) are output from the gradation correction units 7, 8, and 9, respectively.

The 10-bit digital output image signals of red (R), green (G), and blue (B) output from the gradation correction units 7, 8, and 9 are converted into analog image signals of red (R), green (G), and blue (B) by the DA converters 10, 11, and 12, respectively. The liquid crystal driving units 13, 14, and 15 appropriately generate polarity inverting or optimum level drive signals for the liquid crystal display units 16, 17, and 18, and supply the generated drive signals to the liquid crystal display units 16, 17, and 18 in rear of the liquid crystal driving units 13, 14, and 15, respectively. The drive signals are displayed as red (R), green (G), and blue (B) intrinsic images on the liquid crystal display units 16, 17, and 18, respectively.

Each of the liquid crystal display units 16, 17, and 18 is a TFT liquid crystal display unit consisting of so-called transmission polycrystalline silicon or the like, including a plurality of scan lines and a plurality of data lines (not shown), and constituted by a liquid crystal driving unit including pixel electrodes and switching elements arranged in a matrix to correspond to intersections between the scan lines and the data lines, a data line driving unit that supplies a data line signal, a scan signal and the like to the data lines, the scan lines, and the like at predetermined timing, a scan line driving circuit, and the like. According to this first embodiment, it is assumed that effective display areas are those of red (R), green (G), and blue (B), 1024 pixels are provided in a horizontal direction, and that 768 lines are provided in a vertical direction.

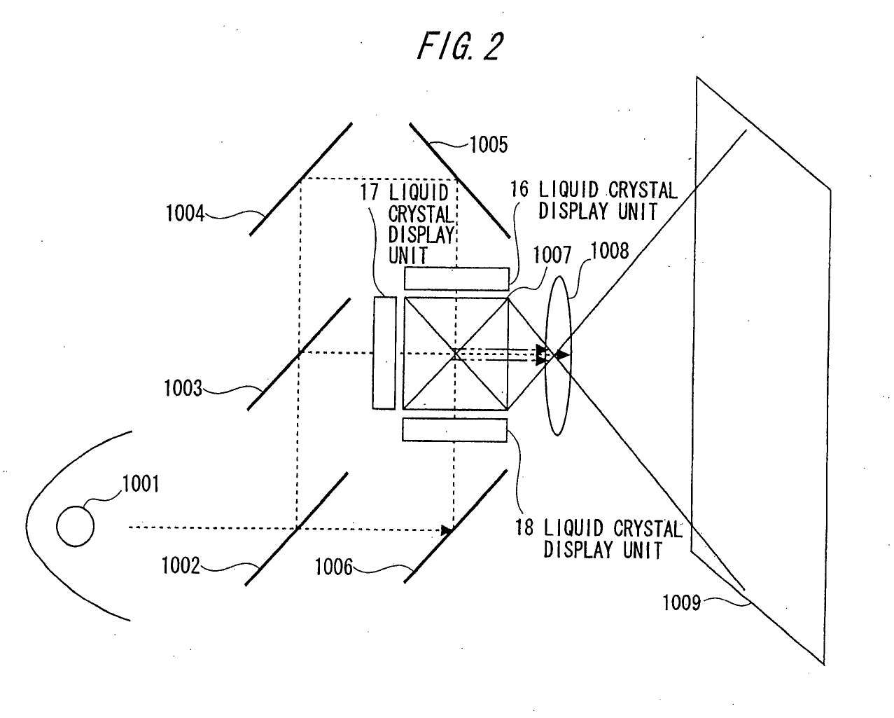

The three-LCD projector according to the first embodiment will be described. FIG. 2 depicts an example of an optical configuration of a projection unit of the three-LCD projector.

As shown in FIG. 2, the three LCD liquid crystal projector according to this first embodiment includes liquid crystal display units 16, 17, and 18 corresponding to red (R), green (G), and blue (B) respectively, a light source 1001 consisting of a metal halide lamp or the like, dichroic mirrors 1002 and 1003 for color separation, mirrors 1004, 1005, and 1006 for optical path change, a cross-dichroic prism 1007 for combining three color images, a projection lens 1008, and a screen 1009.

Further, for displayed images by the liquid crystal display units 16, 17, and 18 corresponding to red (R), green (G), and blue (B), respectively, projected images are obtained by intrinsic illumination lights of red (R), green (G), and blue (B) in a projection optical system shown in FIG. 2. The projected images are combined by a dichroic prism image combining unit into a color image, and the color image is projected and displayed on the screen 1009.

As shown in FIG. 1, synchronizing signals corresponding to the input image signal input simultaneously with the input image signals are input as a combined synchronizing signal from the synchronizing signal input terminal 19 and input to the timing signal generating unit 20.

In the sync separation circuit 201, the combined synchronizing signal is separated into a horizontal synchronizing signal and a vertical synchronizing signal. The PLL circuit 202 generates a fundamental clock signal at a frequency which is an integer multiple of a frequency of the horizontal synchronizing signal out of these signals, and supplies the fundamental clock signal to the timing signal generating circuit 203.

The timing signal generating circuit 203 makes clock phases optimum and supplies the optimum clock phases to the AD converters 4, 5, and 6, the gradation correction units 7, 8, and 9, the DA converters 10, 11, and 12, the liquid crystal driving units 13, 14, and 15, the liquid crystal display units 16, 17, 18, and the like while setting them at predetermined timings, respectively, so as to drive them. The respective constituent elements shown in FIG. 1 are appropriately set by the microcomputer unit 21. In this first embodiment, digital image signals may be input using a digital interface without using the AD converters 4, 5, and 6. If the image signals input to the liquid crystal display units 16, 17, and 18 and their driving units are digital signals, the DA converters 10, 11, and 12 may be omitted.

(Gradation Correction Unit)

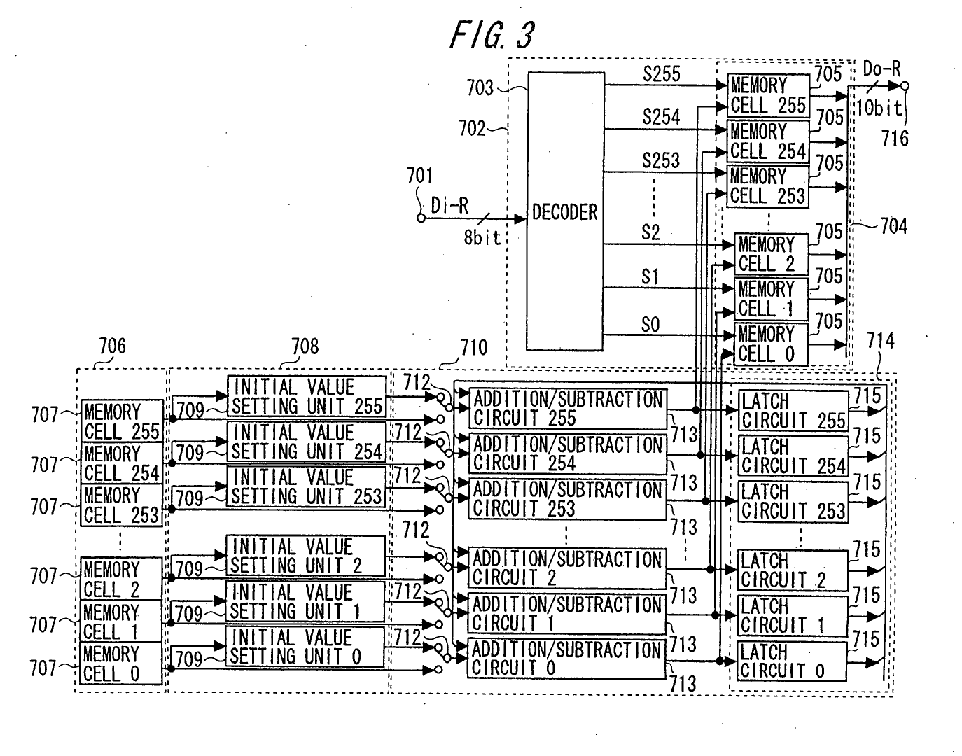

The gradation correction units 7, 8, and 9 shown in FIG. 1 will be described. Since the gradation correction units 7, 8, and 9 are equal in configuration, a configuration and an operation of the red (R) gradation correction unit 7 will be described by way of example. FIG. 3 shows an example of circuit block configuration of the gradation correction unit 7 of red signal (R).

As shown in FIG. 3, the gradation correction unit 7 includes a digitally-converted red signal image signal input unit 701, a first lookup table (“LUT”) unit 702 serving as a first memory, a second LUT unit 706 serving as a second memory, an initial value generating unit 708, and a correction data reproducing unit 710. The second LUT unit 706 stores color difference and gradation difference correction value data on display images in advance, and constituted by 256 memory cells 707 (of 0^{th} to 255^{th} classes).

The initial value generating unit 708 includes 256 initial value setting units 709. The correction data reproducing unit 710 includes 256 switching circuits 712 (of 0^{th} to 255^{th} classes), 256 addition/subtraction circuits 713 (of 0^{th} to 255^{th} classes), and a latch unit 714 constituted by 256 latch circuits 715 (of 0^{th} to 255^{th} classes) each holding an output of each addition/subtraction circuit 713 for one pixel (one clock) period. In addition, a red image signal output terminal 716 is connected to the DA converter 10 shown in FIG. 1.

(First LUT Unit)

The first LUT unit 702 includes an address decoder 703, and a first memory table unit 704 constituted by 256 memory cells 705 (of 0^{th} to 255^{th} classes). Namely, the first LUT unit 702 is constituted by the address decoder 703, which inputs an 8-bit digital image input signal (Di-R) and which decodes and outputs the signal Di-R from 256 parallel ports, and the first memory table unit 704 constituted by 256 memory cells 705 corresponding to 0 to 255 gradations.

The address decoder 703 is a decimal demodulator. Namely, the 8-bit red input digital signal (Di-R) input to the address decoder 703 is demodulated into a signal in the decimal notation by the address decoder 703, and output from 256 decimal demodulation output ports S0 to S255.

In FIG. 3, an output of the port S0 from which a digital gradation demodulation output is input to the memory cell 705 is positive when the output corresponds to a gradation of an input value 0. An output of the port S255 from which the digital gradation demodulation output is input to the memory 705 is positive when the output corresponds to a gradation of a highest input value 255. Likewise, for the other demodulation output ports S1 to S254, an output of the port corresponding to the digital gradation demodulation output of the input digital signal (Di-R) is positive.

The output of the port S0 is positive when the digital gradation demodulation output corresponds to the gradation of the input value 0, and the output of the port S255 is positive when the digital gradation demodulation output corresponds to the gradation of the highest input value 255. Likewise, for the other demodulation output ports S1 to S254, the output of the port corresponding to the digital gradation demodulation output of the red image input signal (Di-R) from the address decoder 703 is positive. The first memory table unit 704 is constituted by 256 memory cells 705 corresponding to gradations 0 to 255, respectively. Hereinafter, each circuit block is described as a class corresponding to a gradation of 0^{th} to 225^{th}, respectively.

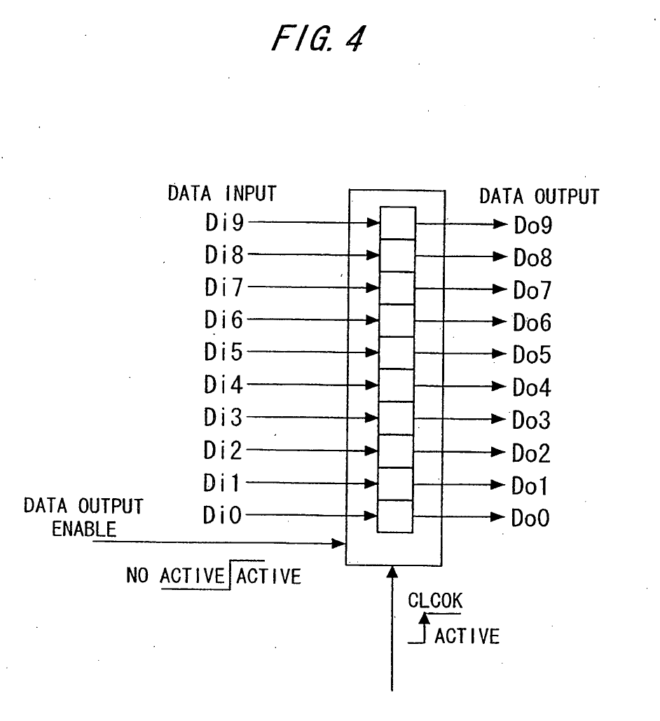

FIG. 4 depicts a configuration of each memory cell 705. As shown in FIG. 4, the memory cell 705 includes digital input terminals of 10 bits, one data output enable terminal, one clock input terminal, and digital output terminals of 10 bits.

Digital inputs of 10 bits are input to a 10-bit latch circuit. The latch circuit can be constituted by arranging 10 D flip-flops in parallel, and outputs of the 10 D flip-flops correspond to one output of the memory cell 705 that outputs data of 10 bits. The 10-bit memory cell 705 outputs low impedance data when being activated by the data output enable terminal.

Digital data output terminals of the 256 (0 to 255) memory cells 705 are connected in parallel to constitute one output data bus. A Do-R signal is output to the DA converter 10 (not shown in FIG. 4) in rear of the gradation correction unit 7 from the first LUT unit 702 shown in FIG. 3 through an image signal output terminal 716.

If the data enable terminal of one memory cell 705 shown in FIG. 4 is inactive, the 10-bit memory cell 705 outputs high impedance data, so that the output of the other active memory cell 705 is given a higher priority than that of this memory cell 705.

The 256 memory cells 705 are not simultaneously active but one memory cell 705 coincident with the digital signal value of the input signal Di-R is active and the output digital signal Do-R is output by 10 bits. Data is written to each memory cell 705 at an active edge of a clock signal input to the clock input terminal for each pixel. The data written to the memory cell 705 is supplied from the addition/subtraction circuit 713 of the correction data reproducing unit 710 to be described later.

The data of the first LUT unit 702 thus configured is sequentially rewritten to correction data output from the addition/subtraction circuit 713 of the correction data reproducing unit 710 at high rate for each pixel clock of the display unit. Using the sequentially rewritten correction data of the first LUT unit 702, the red image input signal Di-R is subjected to a gradation correction and a color difference and luminance difference correction.

Further, this first LUT unit 702 reads the correction data from the correction data reproducing unit 710, to be described later, at a data write timing and outputs the gradation-corrected red image output signal Do-R at a data read timing with an address input of a random access memory (RAM) set as the image input signal Di-R.

(Second LUT Unit)

As shown in FIG. 3, the second LUT unit 706 hierarchically includes 256 memory cells 707 of 0^{th} to 255^{th} classes. The memory cells 707 hierarchically provided in the second LUT unit 706 are distinguished from one another by being referred to as 0^{th} to 255^{th} class memory cells 707, respectively.

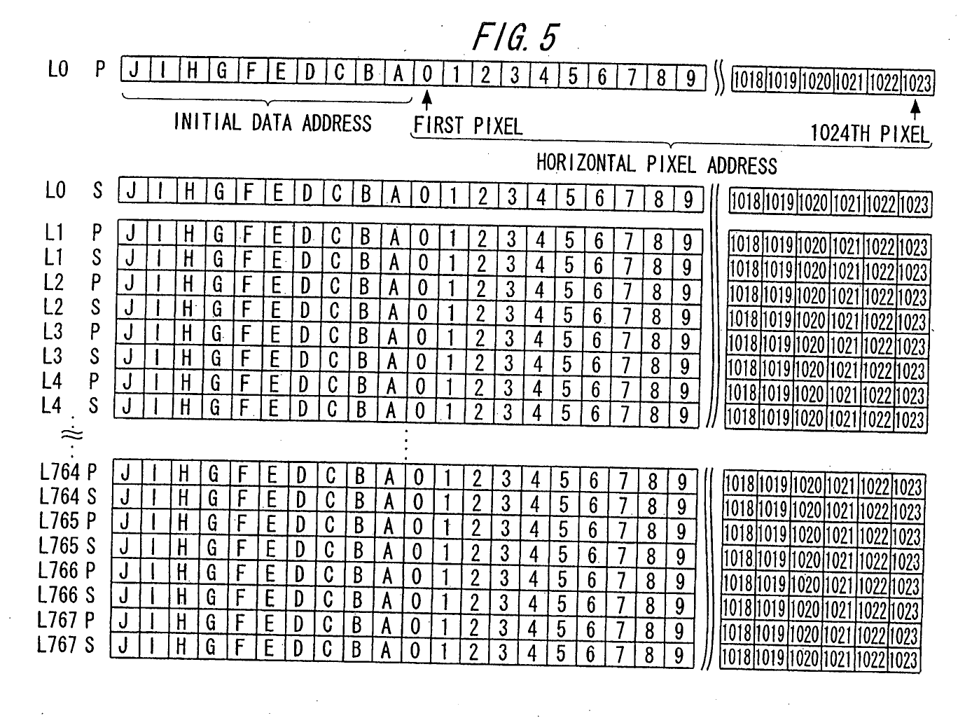

The second LUT unit 706 stores gradation correction data on the display image in advance to correspond to pixels of entire areas of the display screen, respectively, as will be described later. One memory cell 707 includes an address space shown in FIG. 5. In FIG. 5, line address configurations of 768 effective scan lines are denoted by L0 to L767, respectively. Each of these scan lines L0 to L767 includes a data width of 2 bits corresponding data P and data S. Accordingly, a line address of each memory cell 707 is constituted by L0P to L767P and L0S to L767S by as much as 768 effective display scan lines.

The respective scan line addresses include 10 initial data addresses J, I, H, G, F, E, D, C, B, and A (e.g., L0PJ to L0PA for the scan line L0), and 2048 pixel correction data addresses corresponding to a first pixel to a 1024^{th} pixel (e.g., L0P0 to L0P1023 and L0S0 to L0S1023 for the scan line L0)

(Initial Value Generating Unit)

As shown in FIG. 3, the initial value generating unit 708 includes 256 initial value setting units 709 of 0^{th} to 255^{th} classes. Each initial value setting unit 709 is constituted by a shift register including 10 flip-flops and includes a serial-to-parallel conversion function.

The 10-bit initial value data on the addresses J to A of the second LUT unit 706 is input to the shift register of each initial value setting unit 709 as serial data for each pixel clock, and output to a first input of the switching circuit 712 of the correction data reproducing unit 710 in rear of the initial value setting unit 709 as 10-bit parallel data.

(Correction Data Reproducing Unit)

The correction data reproducing unit 710 includes 256 switching circuits 712 of 0^{th} to 255^{th} classes inputting the initial value data output from the 256 initial value setting units 709 of 0^{th} to 255^{th} classes as first inputs, and inputting the outputs from the second LUT unit 706 as second inputs, respectively.

Outputs of these switching circuits 712 are supplied to second inputs of 256 addition/subtraction circuits 713 of 0^{th} to 255^{th} classes, respectively. Each addition/subtraction circuit 713 includes a first input, the second input, and an addition/subtraction control terminal (not shown).

In the first embodiment, “subtraction” means subtraction of a second input value from a first input value of the addition/subtraction circuit 713. As the first inputs of the addition/subtraction circuits 713 of 0^{th} to 255^{th} classes, 256 outputs from the latch circuits 715 of 0^{th} to 255 classes of the latch unit 714, to be described later, are supplied, respectively.

As the second inputs of the 256 addition/subtraction circuit 713 of 0^{th} to 255^{th} classes, pieces of data selected by the switching circuits 712 in the correction data reproducing unit 710 are supplied, respectively.

The data S out of the 2-bit output from the second LUT unit 706 is sequentially input to the addition/subtraction control terminal (not shown) of each addition/subtraction circuit 713. Data for designating either addition or subtraction is stored in a data table for the S data out of the 2-bit output from the second LUT unit 706. Absolute value data for addition or subtraction is stored in a data table for the P data.

Therefore, the designation of either addition or subtraction by the addition/subtraction control terminal of the addition/subtraction circuit 713 is sequentially supplied from the data table for the S data out of the 2-bit output from each memory cell 707 of the second LUT unit 706, thereby controlling the addition/subtraction circuit 713.

As can be seen, the 256 addition/subtraction circuit 713 of 0^{th} to 255^{th} classes in the correction data reproducing unit 710 allow addition or subtraction results of the first inputs and the second inputs to be supplied to the 256 latch circuits 715 of 0^{th} to 255^{th} classes and to 10-bit data input terminals of the 256 memory cells 705 corresponding to the 0^{th} to 255^{th} classes of the first LUT unit 702, respectively.

(Latch Unit)

The latch unit 714 includes 256 10-bit latch circuits 715 of 0^{th} to 255^{th} classes each including a 10-bit input terminal, a 10-bit output terminal, and a clock terminal.

A 10-bit operation output from the addition/subtraction circuit 713 is input to the input terminal of each latch circuit 715. This input 10-bit data is fetched by an internal latch circuit at an active edge of a clock input to the clock input terminal. The data is held in the latch circuit 715 until a next clock active edge timing, and supplied to the first input of corresponding one of the addition/subtraction circuits 713 of 0^{th} to 255^{th} classes in the correction data reproducing unit 710 from the output terminal of the latch circuit 715.

This latch unit 714 may be data holding unit for causing each latch circuit 715 to hold data for one pixel clock period, and to provide the operation result of the corresponding addition/subtraction circuit 713 one pixel clock before to the addition/subtraction circuit 713. Therefore, the latch unit 714 can be constituted by memory circuits, delay circuits, or delay elements.

A specific gradation correction operation performed by the functions of the respective constituent elements configured as stated above and shown in FIG. 1 will next be described.

(Measurement of Display Data and Data Processing)

To measure uncorrected display characteristics of the display apparatus, a gradation correction of each gradation correction unit is turned off. Next, a red signal at a highest input level of the display apparatus is input from a test signal generator, a display image is picked up by, for example, a video camera and captured as a capture image into a personal computer (hereinafter, “PC”), and a display difference in the display area is measured.

The level of the red signal output from the test signal generator is attenuated to (254/255) and the display difference is similarly measured. The level of the red signal output from the test signal generator is sequentially attenuated to (253/255), (252/255), and (251/255), and display differences in the display area at the respective input levels are measured. This measurement is continued until the level of the red signal output from the test signal generator is equal to (1/255) and (0/255). Likewise, display differences in the display area are measured for green (G) and blue (B) at 256 levels from (255/255) to (1/255) and (0/255), respectively.

As a result of the measurement, display difference data on respective colors of red, green, and blue at input levels of 255 to 0 is captured into the PC. Next, color difference correction data is generated by an operation of the PC.

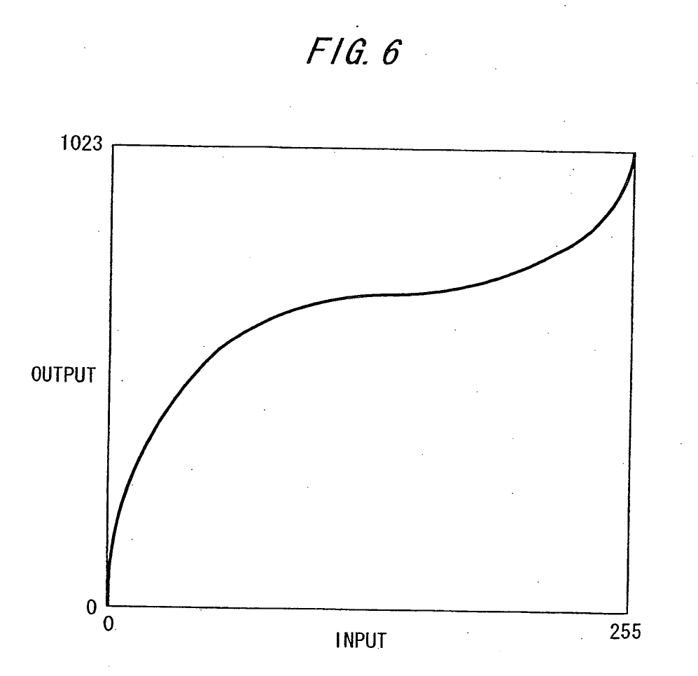

According to this first embodiment, the color difference correction data is a correction data group by as much as the number of all pixels, i.e., 1024 pixels in the horizontal direction by 768 lines in the vertical direction corresponding to the number of display pixels. FIG. 6 depicts one example of a gradation correction characteristic for one pixel. If a two-dimensional difference is present in the image, this characteristic varies depending on its two-dimensional coordinates. Namely, this characteristic has three-dimensionality.

As shown in FIG. 6, examples of the correction characteristic according to the first embodiment include a degamma correction characteristic for an input image signal and a correction characteristic to a nonlinear display characteristic that is a so-called voltage-to-transmission (or reflection) characteristic of the liquid crystal display unit. In the first embodiment, the input image signal is generated as gradations of 8 bits and corrected gradation outputs of 10 bits.

(Operation for Writing Display Correction Data to Second LUT Unit)

Further, correction data corresponding to the above-stated correction characteristic shown in FIG. 5 is written to a total of 786432 2-bit gradation correction addresses corresponding to pixels and each indicated by P and S and a total of 7680 2-bit initial value data address configurations corresponding to the scan lines, respectively and each indicated by P and S in 256 memory cells 707 of 0^{th} to 255^{th} classes in the second LUT unit 706.

The second LUT unit 706, i.e., the memory including the 256 memory cells 707 of 0^{th} to 255^{th} classes is constituted by, for example, a read-only memory (ROM), an electrically erasable, programmable read-only memory (EEPROM), an erasable programmable read-only memory (EPROM), a one-time ROM, or a flash memory. These memories are classified as nonvolatile memories. Data is written to such a memory in a data format, to be described later, according to the operation and processing of the PC.

As shown in a third embodiment to be described later, the second LUT unit 706 can be constituted by a random-access memory (RAM). In this case, data can be read through such a microprocessor described later from a storage unit within the same apparatus when the apparatus is turned on or based on arbitrary setting conditions, and the data can be written to the second LUT unit 706 constituted by the RAM.

(Correction Initial Data)

With the address configuration of each of the memory cells 707 of the second LUT unit 706 shown in FIG. 5, ten addresses of J to A are provided before a pixel address 0 corresponding to a first effective display pixel in a horizontal scan period of each memory cell 707, and gradation correction initial data for this period is generated.

(Class)

The gradation correction data in this case is constituted by 0^{th} to 255^{th} 256 classes corresponding to the gradations of the input image signal input to the gradation correction unit 7 shown in FIG. 1. Namely, as shown in the example of the gradation correction characteristic for one pixel shown in FIG. 6, gradation levels of all 256 gradations of the 8-bit image input signal (Di-R) input to the gradation correction unit 7 are allocated to correspond to the 256 memory cells 707 of 0^{th} to 255^{th} classes of the second LUT unit 706, respectively.

Next, FIG. 5 depicts the example of the address configuration of the 255^{th} class memory cell 707 corresponding to the 255^{th} gradation as one class generated by the above-stated PC.

(Address Configuration)

As shown in FIG. 5, L0P serving as a first bit of the scan line L0 corresponding to the first scan line of the display image stores data of 10 bits in all in respective addresses J to A in the initial value data address period. As for the 255^{th} class, as an example of correction data, “1, 1, 1, 1, 1, 1, 1, 1, 1, 1” are stored in the addresses J to A of the L0P, respectively, with the maximum value of the effective display pixel number set as 1023 based on the correction characteristic shown in FIG. 6.

In the example shown in FIG. 5, pieces of data are arranged in the respective addresses while the address A side closest to the address 0 is set as least significant bit (LSB). The data stored in the addresses M to A of L0S corresponds to an ignorable period in which no data is present according to the first embodiment.

Further, in each of the effective display pixel addresses 0 to 1023 subsequent to the address data stored in the addresses J to A of L0P and L0S, 2-bit correction data of P and S is stored. Here, “S” indicates data for designating either “increase” or “reduction” of a correction value of “1” for increase or “0” for reduction, and “P” indicates “1” or “0” as an absolute value of a change value from a value of one pixel before.

Namely, if a second pixel value is “1022” for an initial value (a first pixel value) of “1023” as the gradation correction value of the line address L0, “1” and “0” are stored as correction data in the addresses of the L0P1 and those of the L0S1, respectively. Likewise, the correction data from L0P2 to L0P1023 and L0S2 to L0S1023 is recorded in these addresses.

The example of the address configuration of the correction data in one horizontal period of the 255^{th} class memory cell 707 has been described so far. As shown in FIG. 5, a total of 1034 pieces of data are recorded in the 10 initial value addresses of J to A and the pixel correction value addresses of 0 to 1023 as line addresses L1P to L767 and L1S to L767S for second to 768^{th} lines subsequent to first line.

(Example of Horizontal Difference Correction Data)

It is assumed, for example, that the measured color difference data indicates that the correction data needs to have a correction characteristic for attenuating the red display image eventually by 20% from left to right (specifically from the pixel addresses 0 to 1023). If a change value per pixel is expressed by quantization level, the change value per pixel is 0.2 quantization level, with a maximum value being 1024, as expressed as follows.
(1024×0.2)/1024=0.2

In addition, a minimum level unit dealt with in the first embodiment is 1 quantization level value. The number of target pixels in the horizontal direction before the level is changed by 1 quantization level is 1/0.2=5. Thus, the correction data is data attenuated by one for every five pixels.

Specifically, according to a program operation of the PC, for example, “1, 1, 1, 1, 1, 1, 1, 1, 1, 1” (MSB:LSB) corresponding to 1023 in the decimal notation are sequentially stored in the addresses J to A of L0P of the memory cell 707 of the second LUT unit 706 stated above, with the MSB and the LSB stored in the addresses J and A, respectively.

Subsequently, “0” is stored in the address L0P0,
“0” in the address L0P0,
“0” in the address L0S0,
“0” in the address L0P1,
“0” in the address L0S1,
“0” in the address L0P2,
“0” in the address L0S2,
“0” in the address L0P3,
“0” in the address L0S3,
“0” in the address L0P4,
“0” in the address L0S4,
“1” in the address L0P5,
“0” in the address L0SS,
“0” in the address L0P6, and
“0” in the address L0S6.

Data having the data configuration in which data is attenuated by one per every five line addresses up to the address L0P1023 and L0S1023 is stored in the PC. This example is on premise that no color difference is present in the vertical direction to the screen, i.e., perpendicular direction to the screen from the first to the 768^{th} lines. As the correction value, the same correction data is written to the L1P to L767P and L1S to L767S. The operation for writing the correction data stated so far is an operation for writing data related to the 255^{th} class to the memory cell 707.

Likewise, pieces of correction data related to the 254^{th} to 0^{th} classes as in the example of the gradation correction characteristic shown in FIG. 6 are written to the respective memory cells 707 corresponding to the 254^{th} to 0^{th} classes.

(Example of Vertical Difference Correction Data)

Next, an instance in which correction data differs along the vertical direction and the image is linearly attenuated by 20% with the first line storing the highest level data of 1023 and the final line (768^{th} line) attenuated by 20% will be described. The initial value of the first line is 1023, an attenuation value of the second line is (1024×0.2)/768=0.2666 less than 1 and the initial value of the second line is, therefore, 1023. Likewise, the initial value of the third line is 1023. The level attenuation by 1 or more starts with 3.75^{th} pixel since 1/0.2666=3.75. The initial value of the fourth line is 1022. Likewise, the initial value of the fifth line is 1022 and the level is attenuated by 2 at the 7.5^{th} pixel. The initial value of the eighth line is, therefore, 1021.

By the proportional attenuation, the initial value of the 768^{th} line is 1023−(1024×0.2)=818 with an attenuation of (1024×0.2)/768=0.2666.

Accordingly, as the initial value data stored in the first line, pieces of data corresponding to “1023” in the decimal notation are stored in the initial value addresses L0PJ to L0PA by 10 bits, respectively. Thereafter, pieces of data corresponding to “1023” in the decimal notation are stored in the initial value addresses L1PJ to L1PA and L2PJ to L2PA by 10 bits, respectively.

Pieces of data corresponding to “1022” in the decimal notation are stored in the initial value addresses L3PJ to L3PA of the fourth line. Pieces of data corresponding to “1022” in the decimal notation are stored in each of the initial value addresses L4PJ to L4PA, L5PJ to L5PA, and L6PJ to L6PA, respectively. Pieces of data corresponding to “1021” in the decimal notation are stored in the initial value addresses L7PJ to L7PA of the eighth line, respectively. Pieces of data corresponding to “781” in the decimal notation are stored in the initial value addresses L767PJ to L767PA of the 768^{th} line, respectively.

Pieces of data stored in pixel correction addresses LXP0 to LXP1023 and LXS0 to LXS1023 (where X is a line address value) corresponding to the first to the 1024^{th} pixels subsequent to 10 bits of the initial value J to A of each line address as inter-pixel differential values in the horizontal direction.

As stated, the initial value data on the scan lines and the gradation correction data as inter-pixel differential values in the horizontal direction are written to the 256 memory cells 707 of 0^{th} to 255^{th} classes of the second LUT unit 706 in the form of a data table for 256 classes.

(Operation for Writing Data)

Data is written by the PC through an interface under communication control of the microcomputer unit 21. It is noted that even if the ROM or flash memory into which the data is written in advance is mounted in the apparatus, the same functions can be acquired.

The memory that constitutes the second LUT unit 706 is one of the ROM, the EEPROM, the EPROM, the one time ROM, the flash memory and the like. These memories are classified as nonvolatile memories. The data is written to the memory based on the operation performed by the PC in the data format to be described later. In the third embodiment, to be described later, the second LUT unit 706 is constituted by the RAM.

(Operation for Reading Correction Data)

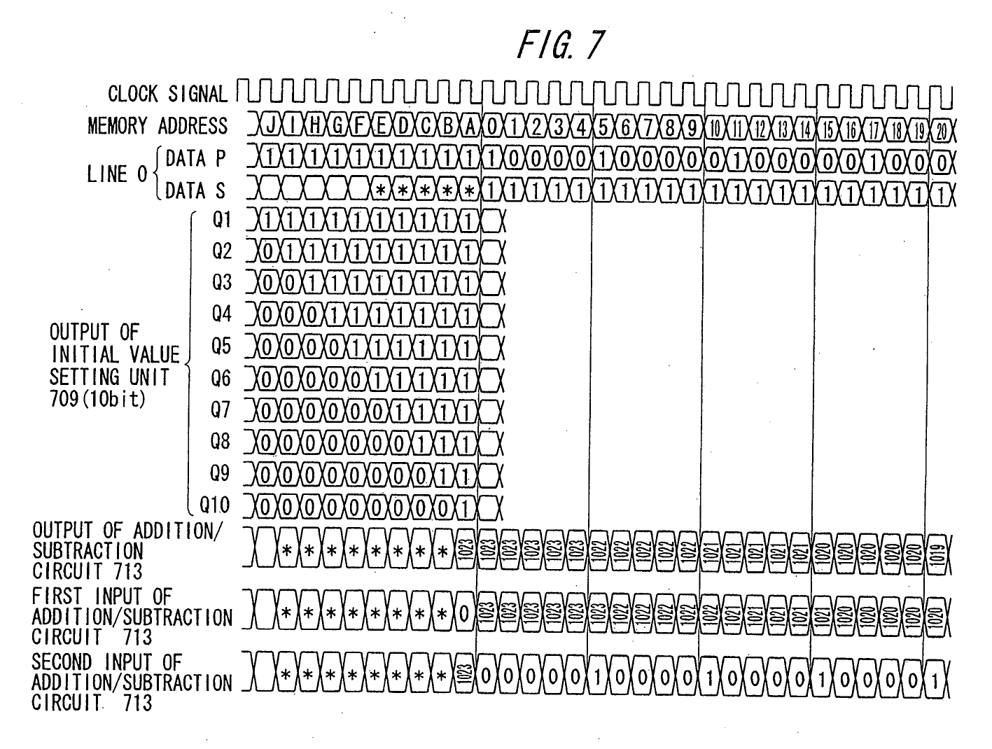

As stated, the “differential value data” in the gradation correction value of the value of one pixel, to which the data is written, before the target pixel in the second LUT unit 706 shown in FIG. 3 is read at a clock signal timing synchronously with horizontal synchronization and vertical synchronization from the timing signal generator 20 shown in FIG. 1, and supplied to the initial value generating units 708 as data on the respective classes FIG. 7 depicts the data read timing in this case.

In FIG. 7, the data P and the data S are sequentially read along the memory addresses shown in FIG. 5 as a data sequence in clock signals. The read timing is generated and supplied by the timing generating circuit 203 shown in FIG. 1.

(1) At a vertical image start timing, not shown, the initial value data address is read from memory addresses J, I, H, G, F, E, D, C, B, and A in response to a horizontal read start pulse on the first scan line, and the correction value address is read from the addresses 0, 1, 2, 3, to 1023. The correction value data thus read is output by 2 bits of the data P and the data S for every class.

(2) After reading the data up to the data of the correction value address 1023, reading is awaited until a horizontal synchronizing read start pulse on the next scan line is generated.

(3) In response to the horizontal read start pulse on the second horizontal line, the initial value data address is read from the memory addresses J, I, H, G, F, E, D, C, B, and A on the second line and the correction value data is read from the correction value addresses 0, 1, 2, 3, . . . , and 1023 similarly to (1)

(4) Likewise, the data is read from the third horizontal line to the 768^{th} line, and the reading operation of (1) to (4) is executed at each vertical synchronizing timing according to the clock timing.

(Generation of Initial Value)

As stated above, the correction data read from the memory cells 707 of 0^{th} to 255^{th} classes in the second LUT unit 706 is supplied to the initial value generating unit 708. Pieces of initial value data P read from the memory addresses J, I, H, G, F, E, D, C, B, and A are sequentially input to the shift registers of the initial value setting units 709 provided to correspond to the 0^{th} to 255^{th} classes in the initial value generating unit 708 for every clock, and stored in the 10 flip-flops (denoted by Q1 to Q10) as serial data.

Examples of the data stored in the flip-flops Q1 to Q10 of the respective initial value setting units 709 for each of the memory address timings J, I, H, G, F, E, D, C, B, and A are denoted by Q1 to Q10 in FIG. 7. As already stated, the data P on the first line of the memory of the 255^{th} class is sequentially read as “1, 1, 1, 1, 1, 1, 1, 1, 1, 1” from each of the memory addresses J, I, H, G, F, E, D, C, B, and A.

Further, all pieces of data Q1 to Q10 in the shift registers are stored at the timing of reading the data from the address A. At the next timing of accessing the memory address 0, the data Q1 to Q10 are input to the second inputs of the addition/subtraction circuits 713 through the respective switching circuits 712.

At this stage, the outputs from the latch circuits 715 are input to the first inputs of the respective addition/subtraction circuits 713. At the timing of accessing the memory address 0, the latch circuits 715 are just reset. Therefore, the parallel data of 10 bits of “0, 0, 0, 0, 0, 0, 0, 0, 0, 0” is input to the first input of each addition/subtraction circuit 713.

Due to this, at the timing of accessing the memory address 0, the initial value data of “1, 1, 1, 1, 1, 1, 1, 1, 1, 1” input to the second input of each addition/subtraction circuit 713 is output from the addition/subtraction circuit 713. The first input value of the addition/subtraction circuit 713 and the output of the addition/subtraction circuit 713 at the timing of the pixel address 0 shown in FIG. 7 are data corresponding to “1023” in the decimal notation.

Through the above-stated operation, the correction value data on the 255^{th} class at the timing of the address 0 of the line 0 is output from the addition/subtraction circuit 713 and stored in the 255 10-bit input in the table corresponding to the 255^{th} class in the first LUT unit 702.

At the same time, the data at the pixel address timing 0 output from the addition/subtraction circuits 713 in the correction data reproducing unit 710 is captured into the latch circuit 715 corresponding to the 255^{th} class in the latch unit 714 at a timing of clock signal, and stored before generation of the next clock. Thereafter, the data output from the addition/subtraction circuit 713 of the corresponding class in the correction data reproducing unit 710 connected at each clock is stored for one clock period by the latch circuit 715.

(Generation of Correction Value from Differential Value)

As shown in the data reproducing timing shown in FIG. 7, the data P is output as “0” and the data S is output as “1” at the pixel address timing 1 of the line address L0 of the memory cell 707 in the second LUT unit 706. Using this data S, addition or subtraction is designated to the addition/subtraction circuit 713 corresponding to the 255^{th} class in the correction data reproducing unit 710. In the designation according to this first embodiment, “1” functions as addition and “0” functions subtraction.

The data P is input as 1-bit differential value data, the correction value data P read at which timing is “0”. In addition, the correction value data at the 255^{th} class at the pixel address timing 1 of the line address L0 is output as the decimal value “1023” equal to the initial value data of “1, 1, 1, 1, 1, 1, 1, 1, 1, 1 (MSB:LSB)” from the addition/subtraction circuit 713 of the 255^{th} class in the correction data reproducing unit 710, and stored in the memory cell 705 of the 255^{th} class in the first LUT unit 702 as 10-bit data.

Likewise, at pixel address timings 1 to 4 of the line address L0, “0” is output as the data P and “0” is output as the data S.

Accordingly, the output of the addition/subtraction circuit 713 of the 255^{th} class in the correction data reproducing unit 710 is not changed and the data corresponding to “1023” in the decimal notation is sequentially written by the 10-bit data input of the memory cell 705 of the 255^{th} class among the 0^{th} to 255^{th} classes in the first LUT unit 702.

Next, at the pixel address timing 5 of the line address L0, “1” is output as the data P and “0” is output as the data S. This data S is supplied to the addition/subtraction control terminal of the addition/subtraction circuit 713. Therefore, the addition/subtraction circuit 713 of the 255^{th} class in the correction data reproducing unit 710 subtracts the second input data from the first input data. The data corresponding to “1023” in the decimal notation at the timing one clock before is input to the first input of the addition/subtraction circuit 713. In addition, “1” is input to the second input thereof. On the other hand, the addition/subtraction circuit 713 of the 255^{th} class in the correction data reproducing unit 710 output data corresponding to (1023−1=) 1022 in the decimal notation. This value is stored in the memory cell 705 of the 255^{th} class in the first LUT unit 702.

Next, at pixel address timings 6 to 9 of the line address 0, no addition or subtraction is performed and the output of the addition/subtraction circuit 713 of the 255^{th} class in the correction data reproducing unit 702 remains 1022, which value is sequentially written to the memory cell 705 of the 255^{th} class in the first LUT unit 702. At a pixel address timing 10, “1” is output as the data P and “0” is output as the data S, the addition/subtraction circuit 713 subtracts 1 from the data and output “1022”, which value is stored in the memory cell 705 of the 255^{th} class in the first LUT unit 702.

Thereafter, in the first embodiment, the data P is “1” and the data S is “0” once for five pixel clock timings until a pixel address timing 1023 of the line address L0. The addition/subtraction circuit 713 of the 255^{th} class in the correction data reproducing unit 710 subtracts 1 from the data output value at the timing one clock before the timing 1023, which value is sequentially written to the memory cell 705 of the 255^{th} class in the first LUT unit 702, respectively.

Likewise, the data is read from the memory cells 707, the corrected values are reproduced, and the corrected values are sequentially stored in the memory cell 705 of the 255^{th} class in the first LUT unit 702 for the line addresses L1 to L767.

As can be seen, the correction initial value data on each of the scan lines of 256 classes written to the 256 memory cells 707 of the 0^{th} to the 255^{th} classes in the second LUT unit 706 and gradation correction differential values between the pixel addresses is generated as gradation correction values for the respective pixels by the 256 addition/subtraction circuits 713 of the 0^{th} to 255^{th} classes. The gradation correction values are sequentially written to the 256 memory cells 705 in the first LUT unit 702 at the respective pixel clock timings.

(Gradation Correction in First LUT)

In the first LUT unit 702, the 8-bit red image signal Di-R is input to and decoded by the address decoder 703 shown in FIG. 3.

If input values of the 8-bit red image input signal Di-R input to each memory cell 707 of the second LUT unit 706 at the memory address timing 0 as the first pixel in the display unit at the line address L0 are, for example, 1, 1, 1, 1, 1, 1, 1, 1 (MSB:LSB) of 8 bits, then the decoded value decoded by the address decoder 703 is “255”, the output signal from the port S255 of the address decoder 703 is active, and output enable of the memory cell 705 of the 255^{th} class in the first LUT unit 702 is active. From this memory cell 705 of the 255^{th} class, 11-bit output correction values “1, 1, 1, 1, 1, 1, 1, 1, 1, 1” (MSB:LSB) from the addition/subtraction circuit 713 are supplied to the DA converter 10 in rear of the circuit 713 through the image signal output terminal 716 as a parallel red image output signal Do-R. After the signal Do-R is subjected to DA conversion, the liquid crystal driving signal is obtained by the liquid crystal driving unit 13 and supplied to the liquid crystal display unit 16.

10-bit digital outputs of each of the 255 memory cells 705 in the first LUT unit 702 are connected in parallel in binary values to constitute the 10-bit data bus. However, only one memory cell 705 selected by the address decoder 703 is active among the 255 memory cells 705.

Similarly, the input values of the 8-bit red image signal Di-R input through the image signal input unit 701 for the read signal from the first to the 1024^{th} pixels at the display line address L0 are continuous signals of 1, 1, 1, 1, 1, 1, 1, 1 (MSB:LSB) in the binary notation corresponding to “255” in the decimal notation, assuming that the signals are input at 100% white according to the first embodiment. In the first memory table unit 704, the memory cell 705 of the 255^{th} class is always active.

Namely, the gradation correction data value output from the first LUT unit 702 at the timing of the pixel address 0 of the display line address L0 is “1023”. Thereafter, the gradation correction data value is gradually attenuated by 1 per every five addresses, and reduced to about “818” at the pixel address 1023.

Likewise, output values of the difference-corrected red image output signal Do-R output from the first LUT unit 702 for the display line addresses 1 to L767 are similar to those for the display line address L0, supplied to the DA converter 10 in rear of the gradation correction unit 7, and subjected to DA conversion, transformed into the liquid crystal driving signal by the liquid crystal driving unit 13, and supplied to the liquid crystal display unit 16, thereby displaying an image.

The other green and blue image signals are displayed on the liquid crystal display units 17 and 18 while no corrections are made to differences, and projected.

As can be seen, for the color difference according to the first embodiment that a red component of the image is greater from left to right on the screen and that the red component is increased by 20% on the right end of the screen, the horizontal color difference on the display screen of this display apparatus is corrected by the output values of the red image output signal Do-R having a linearly and gradual change with an attenuation of 20% on the right end of the screen relative to the left end thereof and output from the first LUT unit 702, and a uniform white image is obtained.

Likewise, at the input level “254”, the 10-bit data of the memory cell 705 of the 254^{th} class in the first LUT unit 702 is output as the red image output signal Do-R of the first LUT unit 702 of the gradation correction unit 7. At each of the input levels “253” to “0”, the 10-bit data of each of the corresponding memory cells 705 of the 253^{rd} to the 0^{th} classes of the first LUT unit 702 is output, thereby correcting the color difference in the display image.

In the above-stated embodiment, the red color difference is reduced by correcting the gradation correction characteristic of the red image signal for each pixel. By correcting the gradation correction characteristics of all the red, green, and blue image signals by the gradation correction units 7, 8, and 9 shown in FIG. 1 for each pixel, respectively, the color difference in the display image can be corrected at high accuracy at all gradations of all colors corresponding to logic levels of the input images.

As stated so far, according to the first embodiment, correction data for correcting the image signal for designating a gradation level of a predetermined pixel is stored in the first LUT unit serving as a first memory. A plurality of pieces of correction data corresponding to a plurality of gradation levels which the image signal is to have are extended from the data stored in the second LUT unit serving as a second memory (in which pieces of correction data corresponding to a plurality of pixels and corresponding to gradation levels of the respective pixels are compressed and held), and held in the first memory. To suppress a capacity of the first memory, the display apparatus is configured so that extension of the compressed correction data to uncompressed data (to make compressed data be easily utilized) is not performed in advance to correspond to all the pixels. That is, noticing that it suffices that the image signals sequentially input as the image signals can be sequentially corrected, the extension of the image corresponding to each pixel and supply of the extended image to the first memory is performed for every partial pixels (for every one or plurality of pixels (note that data corresponding to a plurality of pixels (not all pixels of the display apparatus) may be extended in consideration of operation time required to extend the compressed data, in which case, the first memory has a capacity enough to be able to simultaneously hold the correction data corresponding to the respective gradation levels of each of the pixels)). Since the configuration in which pieces of compressed correction data corresponding to all the pixels are not extended in advance is adopted, the memory capacity can be greatly reduced. Furthermore, by extending the correction data corresponding to each of the gradation levels of the pixels corresponding to the correction target image data in advance, the image data can be corrected to appropriately correspond to all the possible gradation levels of the image signal.

### SECOND EMBODIMENT

A display apparatus according to a second embodiment of the present invention will be described. The display apparatus according to the second embodiment is basically equal in entire configuration for the signal processing shown in FIG. 1 according to the first embodiment except for a configuration and an operation of the gradation correction units 7, 8, and 9. The number of display pixels in the display unit of the display apparatus according to the second embodiment is 1920 pixels in the horizontal direction and 1080 lines (pixels) in the vertical direction. If the display apparatus is a 3-LCD projector, the number of pixels of each of the display units of the respective liquid crystal displays is equally 1920 pixels in the horizontal direction and 1080 lines (pixels) in the vertical direction.

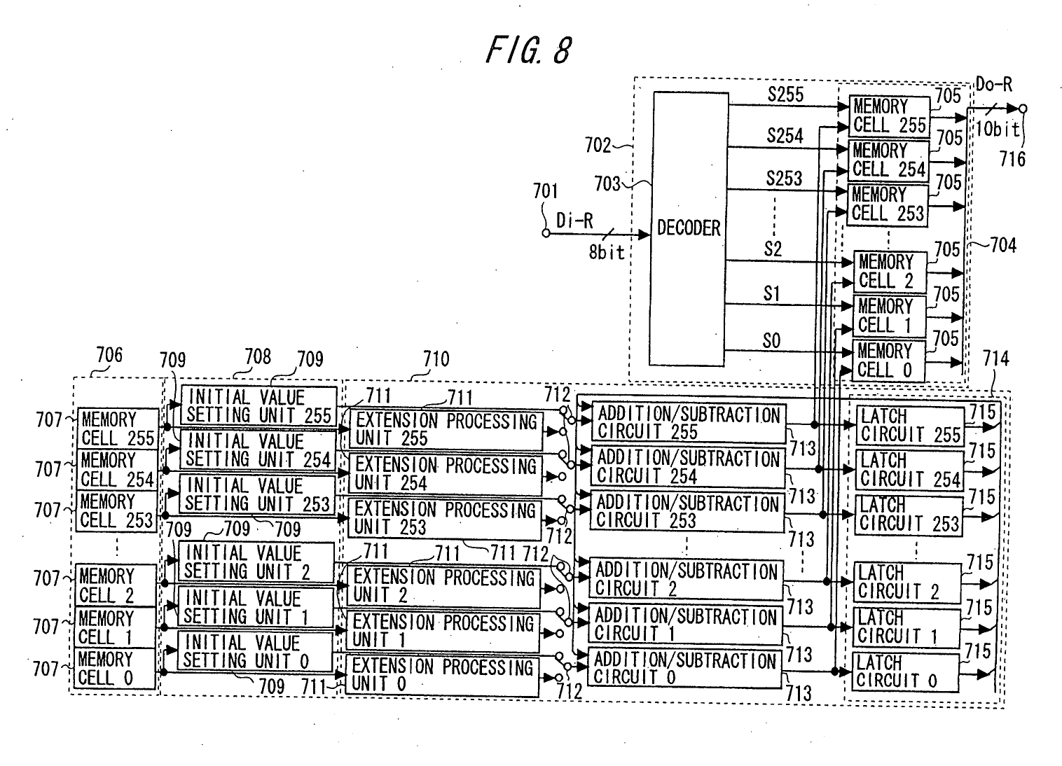

FIG. 8 depicts a red signal gradation correction unit according to this second embodiment. As shown in FIG. 8, the red image signal input unit 701 is an input unit through which an input image signal is input from the AD converter 4 in front of the gradation correction unit 7. Through this input unit 701, a Di-R signal as the 8-bit red digital image signal is input and supplied to the first LUT unit 702.

(First LUT Unit)

As shown in FIG. 8, the first LUT unit 702 is equal in configuration to that according to the first embodiment. Similarly to the first embodiment, 10-bit correction data is supplied for each class to the first LUT unit 702 from the correction data reproducing unit 710 at each pixel clock timing. In addition, data in the 256 memory cells 705 of 0^{th} to 255^{th} classes in the first LUT unit 702 is controlled to be sequentially rewritten at respective pixel clock timings.

(Second LUT Unit)

The second LUT unit 706 will next be described. This second LUT unit 706 includes 256 memory cells 707 that store gradation correction data on the display image in advance by as much as 256 image input gradations, and corresponding to the 0^{th} to 255^{th} classes, respectively.

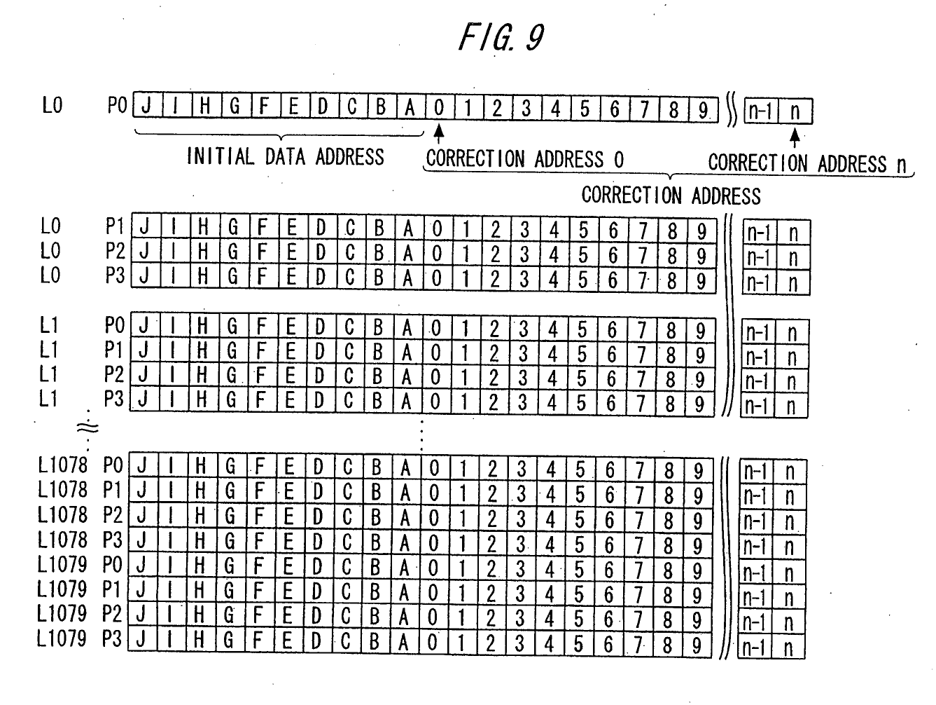

The second LUT unit 706 according to the second embodiment differs from that according to the first embodiment in a memory address structure of each memory cell 707. FIG. 9 depicts this memory address structure. FIG. 9 depicts a model of a memory address configuration of the memory cell 707 corresponding to one class in the second LUT unit 706 shown in FIG. 8. In the second embodiment, the gradation correction data for one pixel of the memory cell 707 is constituted by 4 bits. Hereafter, pieces of correction data of 4 bits will be referred to as P0, P1, P2, and P3, respectively.

The number of pixels in the vertical direction of the display screen, that is, the number of horizontal lines is 1080, and the number of pixels in the horizontal direction thereof is 1920 dots. The memory cell 707 includes addresses L0 to L1079 corresponding to scan lines 1 to 1080, respectively. Each of the lines L0 to L1079 has a data width of 4 bits indicated by P0, P1, P2, and P3.

The address L0 corresponding to the first line includes line addresses L0P0, L0P1, L0P2, and L0P3. Likewise, the address corresponding to the second line includes line addresses LLP0, L1P1, L1P2, and L1P3. Further, the address corresponding to the 1080^{th} line includes line addresses L1079P0, L1079P1, L1079P2, and L1079P3.

Each of the line addresses from L0P0, L0P1, L0P2, L0P3 to L1079P0, L1079P1, L1079P2, and L1079P3 includes 10 initial value addresses indicated by J, I, H, G, F, E, D, C, B, and A and corresponding to 10 pixel clock periods, respectively.

Each of these line addresses includes correction data pixel addresses corresponding to display pixels of 1920 dots from 0^{th} to 1919^{th} pixels arranged in the horizontal direction of the display screen. Differently from the first embodiment, correction data is stored in the correction data pixel addresses to correspond to the 1^{st} to the 1920^{th} display pixels in the horizontal direction while being compressed to 4-bit correction data indicated by P0, P1, P2, and P3. Therefore, fewer addresses are used relative to a compressibility corresponding to the arrangement of these 1920 pixels in the horizontal direction. Each address is expressed by a numeric value from 0 to n, where n is changed by a change state of a gradation correction value of each pixel in the horizontal pixel direction of the correction data.

(Initial Value Generating Unit)

The initial value generating unit 708 according to the second embodiment shown in FIG. 8 includes 256 initial value setting units 709 similarly to the first embodiment.

Each of these initial value setting units 709 captures 10-bit initial value data on the initial value addresses J to A shown in FIG. 9 allocated to one of the memory cells 707 corresponding to the respective 0^{th} to 255^{th} classes in the second LUT unit 706 into a 10-bit shift register. The initial value generating unit 708 converts the 10-bit initial value data into 10-bit parallel data, and supplies the 10-bit parallel data to the first input of the switching circuit 712 of the correction data reproducing unit 710 connected to each initial value setting unit 709 shown in FIG. 8.

(Data Reproducing Unit)

The correction data reproducing unit 710 includes 256 extension processing units 711 provided to correspond to the 0^{th} to 255^{th} classes, 256 switching circuits 764 provided to correspond to the 0^{th} to 255^{th} classes, and 256 addition/subtraction circuits 713 provided to correspond to the 0 to 255^{th} classes, respectively.

In the correction data reproducing unit 710, outputs of the 256 initial value setting units 709 of the 0^{th} to 255^{th} classes in the initial value generating unit 708 are input to the 256 switching circuits 712 of the 0^{th} to 255^{th} classes as first inputs thereof so as to coincide with the respective classes.

Pieces of data read from the 256 memory cells 707 in the second LUT unit 706 are supplied to the respective extension processing units 711. Outputs of the extension processing units 711 are supplied to the 256 switching circuits 712 corresponding to the 0^{th} to 255^{th} classes as second inputs thereof, respectively.

Outputs of the 256 switching circuits 712 corresponding to the 0^{th} to 255^{th} classes are supplied to second inputs of the 256 addition/subtraction circuits 713 serving as operation units corresponding to the 0^{th} to 255^{th} classes, respectively. Outputs of the 256 latch circuits 715 corresponding to the 0^{th} to 255^{th} classes in the latch unit 714 in rear of the correction data reproducing unit 710 are supplied to first inputs of the respective addition/subtraction circuits 713 corresponding to the 0^{th} to 255^{th} classes.

Outputs of each of the 256 addition/subtraction circuits 713 are divided into two outputs. One is supplied as a data input terminal of one of the memory cells 705 of the corresponding class in the first LUT unit 702, whereas the other is input to one of the 256 latch circuits 715 of the corresponding class of 0^{th} to 255^{th} in the latch unit 714.

(Latch Unit)

Similarly to the first embodiment, the latch unit 71-4 according to the second embodiment includes 256 10-bit latch circuits 715 of 0^{th} to 255^{th} classes each including a 10-bit input terminal, a 10-bit output terminal, and a clock terminal.

As already described in relation to the correction data reproducing unit 710, a 10-bit operation output from each of the 256 addition/subtraction circuits 713 of the 0^{th} to 255^{th} classes is input to the data input terminal of each of the 256 latch circuits 715 of the 0^{th} to 255^{th} classes.

The input 10-bit data input to this latch circuit 715 is captured by the latch circuit 715 at an active edge of a pixel timing clock input to the clock input terminal thereof. The data is held in the latch circuit 715 until a next pixel timing clock active edge timing, delayed by one pixel timing period, and supplied to the first input terminal of corresponding one of the addition/subtraction circuits 713 of 0^{th} to 255^{th} classes in the correction data reproducing unit 710 from the output terminal of the latch circuit 715.

Namely, the latch unit 714 holds data for one pixel clock period, and provides a one-pixel-clock-before operation result of the corresponding addition/subtraction circuit 713 of the correction data reproducing unit 710 to the addition/subtraction circuit 713 of the correction data reproducing unit 710.

A specific gradation correction operation performed by the display apparatus according to this second embodiment thus configured will next be described.

(Measurement of Display Data and Data Processing)

To measure uncorrected display characteristics of the display apparatus, a red signal at a highest input level of the display apparatus is input from a test signal generator, a display image is picked up by, for example, a video camera and captured as a capture image into a PC, and a display difference in the display area is measured, similarly to the first embodiment.

The level of the red signal output from the test signal generator is gradually attenuated to (254/255) and the display difference is similarly measured. The level of a white signal output from the test signal generator is sequentially attenuated to (253/255), (252/255), and (251/255), and display differences in the display screen at the respective input levels are measured. This measurement is continued until the level of the white signal output from the test signal generator is equal to (1/255) and (0/255). Likewise, display differences in the display area are measured for green (G) and blue (B) at 255 levels from (255/255) to (1/255) and (0/255), respectively.

As a result of the measurement, display difference data on respective colors of red, green, and blue at input levels of 255 to 0 is captured into the PC.

Next, color difference correction data is generated by an operation of the PC. In this case, the correction data is a correction data group by as much as the number of all pixels, i.e., 1920 pixels in the horizontal direction by 1080 lines in the vertical direction corresponding to the number of display pixels of this second embodiment. FIG. 6 depicts one example of the gradation correction for one pixel.

Examples of the correction characteristic H according to the first embodiment include a degamma correction characteristic for an input image signal and a correction characteristic to a nonlinear display characteristic that is a so-called voltage-to-transmission (or reflection) characteristic of the liquid crystal display unit according to this second embodiment. In the second embodiment, the input image signal is generated as gradations of 8 bits and corrected gradations of 10 bits.

Further, to write the generated data to the second LUT unit 706 as the display correction data using the PC, the data is converted into a predetermined format. An operation for writing the data to the second LUT unit 706 will now be described.

(Operation for Writing Display Correction Data to Second LUT Unit)

An operation for writing the display correction data to the second LUT unit 706 will be described. As already described in relation to the configuration of the second LUT unit 706, 10-bit initial values of gradation correction value for lines are sequentially stored in the 10 initial value addresses indicated by J, I, H, G, F, E, D, C, B, and A of each of the line addresses from L0P0, L0P1, L0P2, L0P3 to L1079P0, L1079P1, L1079P2, and L1079P3 of the 256 memory cells 707 each having the correction data address configuration shown in FIG. 9 and corresponding to the 0^{th} to 255^{th} classes in the second LUT unit 706, respectively.

According to the second embodiment, the address is configured to have a data width of 4 bits indicated by P0, P1, P2, and P3, respectively, as shown in FIG. 9. However, to avoid complicated description, only the address having the 1-bit data width is considered as the initial value data address and the other addresses having the 3-bit data width indicated by P1, P2, and P3 are ignored. Namely, the latter addresses are unnecessary addresses and can be deleted.

An initial value for each line at each class is a 10-bit value. Due to this, if the data width of P0, P1, P2, and P3 is entirely used, it suffices to use a data area by as much as 3 clocks of initial addresses C, B, A of each line address. In this case, if data is captured into C, B, and A of three stages in the latch circuit for every 4 bits, and data is read simultaneously as parallel data at the time of displaying the first pixel, i.e., at the timing of the address 0, the initial value data can be similarly reproduced. Accordingly, the memory capacity is reduced by as much as 4-bit widths of the remaining initial value addresses J, I, H, G, F, E, and D, that is, 28 bits in all. 30240 bits corresponding to the number of lines are reduced for the full screen, and 7741440 bits are reduced for all classes.

Next, correction value data on the first to the 1920^{th} pixels following the initial values is stored after the correction initial value addresses indicated by J, I, H, G, F, E, D, C, B, and A, respectively, of each line as correction data having the data width of 4 bits indicated by P0, P1, P2, and P3, respectively.

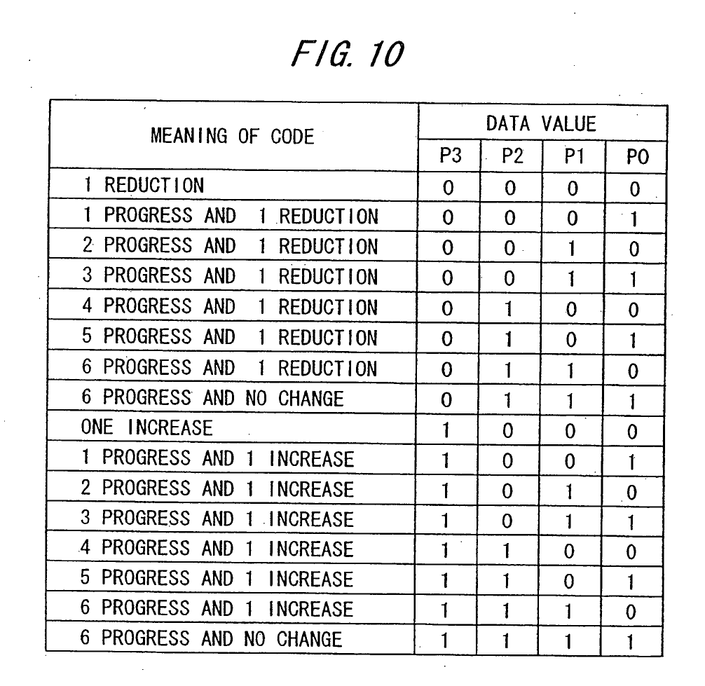

As shown in FIG. 10, correction values on the first to the 1920^{th} pixels each written by 4 bits are indicated by expressions that data value has 1 increase, 1 reduction, or no change. In addition, the correction values include data on the number of pixels having 1 change. Therefore, differently from the first embodiment, not the data value for every pixel but the correction value compressed according to a change amount of the correction value by as much as a period of a plurality of pixels is recorded in one address. A data amount of the gradation correction data on the entire screen can be reduced. Namely, differently from the first embodiment, it is unnecessary to fixedly provide all pixel addresses for each line address, and the data amount in the pixel address direction is not fixed according to the change value of the correction data.

Using the horizontal data format stated above, data corresponding to 1080 lines is written in the vertical direction. The correction data corresponding to one class is stored in corresponding one of the memory cells 707. Likewise, data corresponding to the remaining 254 classes is stored in the 254 memory cells 707 as correction values of the respective classes.

(Example of Correction Data)

Operations for generating the correction data and writing the correction data to the memory cell will be described. In these operations, a process until the correction data considered necessary based on color difference data measured for the red signal, for example, is written to the memory cells will be described. In this example, despite input of the white signal, the display image for which a white balance kept on the left of the screen, and the red component of which is greater toward the right side of the screen is corrected.

First, attention is paid to the highest display level class and a color difference at this class is measured. A result of the measurement of the color difference indicates that the correction data needs to have a correction characteristic for attenuating the signal level of the red signal eventually by 20% from left to right relative to the horizontal address 1919, specifically from the horizontal pixel addresses 0 to 1919. If so, an attenuation amount in the horizontal display period is:
(All gradations)×(attenuation amount)=(1023×0.2)=204.6 (quantization level)

An attenuation amount per pixel is:
(Attenuation amount in horizontal display period)÷(the number of effective horizontal pixels)=204.6÷1920≈0.1065

The number of pixels changed by 1 quantization level is roughly:
1÷0.1065≈9.38.

Therefore, the correction data is attenuated by 1 almost for every 9.38 pixels.

Using application software of the PC, “1, 1, 1, 1, 1, 1, 1, 1, 1, 1” in the binary notation corresponding to “1023” in the decimal notation is stored in the initial value data addresses indicated by J, I, H, G, F, E, D, C, B, and A of the line address L0P0, with MSB and LSB stored in J and A, respectively.

Following the initial value data addresses, the correction data on the first to 1920^{th} pixels is recorded while encoding the correction data based on a table shown in FIG. 10.

In the table of FIG. 10, processings performed on codes indicated by 4-bit data values of P3, P2, P1, and P1 when the data recorded in advance is read and reproduced are defined.

Data is allocated, as “0111 (P3 to P0)” to the correction address 0 of each of the addresses L0P0, L0P1, L0P2, and L0P3 corresponding to the first line. Data is allocated, as “0100 (P3 to P0)”, to the correction value address 1 for which the data is next reproduced. The meanings of these codes are “6 progress and no change” and “4 progress and 1 reduction”, respectively, as shown in the table of FIG. 10.

Likewise, data is allocated, as “0111 (P3 to P0)” to the correction value address 2 of each of the addresses L02P0, L2P1, L2P2, and L2P3 corresponding to the first line. Data is allocated, as “0100 (P3 to P0)”, to the correction value address 3 from which data is reproduced next. Subsequently, “0111 (P3 to P0)” and “0100 (P3 to P0)” are alternately stored in the correction value memory addresses up to the address 191. Thus, the initial value and the correction data for one line are constituted.

In this case, no color difference is present in the vertical direction of the screen, i.e., in the direction from the first to the 1080^{th} lines, so that the same initial value data and correction value data as those for the first line are recorded as the correction value. The correction data thus constituted is the data written about the 255^{th} class.

Likewise, for the 254^{th} to the 0^{th} classes, the initial value data and the correction value data are recorded. For the 254^{th} to the 0^{th} classes, if attention is paid to one pixel, the gradation characteristic of the pixel is, for example, that shown in FIG. 6.

In FIG. 6, the X axis indicates input and the Y axis indicates the gradation correction value. The input on the X axis indicates an input level of the gradation correction unit 7 and a highest quantization level thereof is 255. The gradation correction value on the Y axis indicates a signal level and a highest quantization level thereof is 1023. This characteristic is changed according to pixels.

If the correction data differs along the vertical direction or specifically, if the data on the first line is at the highest level of 1023 and the level of the data on the final line or 1080^{th} line is linearly attenuated by 20%, the correction data can be expressed as (1024−(L×(1024×0.2)/1080))), where L denotes the number of lines.

The initial values for the respective scan lines will be expressed down to the third decimal place as follows:
Initial value for the first line: 1023
Initial value for the second line: 1022.81
For the third and the subsequent lines,
Initial value for the third line: 1022.621
Initial value for the fourth line: 1022.432
Initial value for the fifth line: 1022.242
Initial value for the sixth line: 1022.053
Initial value for the seventh line: 1021.863
Initial value for the ninth line: 1021.674
Initial value for the tenth line: 1021.484
Initial value for the eleventh line: 1021.295
Initial value for the 12^{th} line: 1021.106
Initial value for the 13^{th} line: 1020.916
Initial value for the 14^{th} line: 1020.727
Initial value for the 15^{th} line: 1020.537
Initial value for the 16^{th} line: 1020.348
Initial value for the 17^{th} line: 1020.158
Initial value for the 18^{th} line: 1019.969
Initial value for the 19 line: 1019.779

Finally, the initial value for the 1080^{th} line is 818.589.

These values are basically non-integers. However, since a logic level resolution of an actual circuit is 1, these values are expressed as integers by rounding them to two decimal places, respectively. By doing so, the initial value for the first line is 1023, and that for the second line is 1023. In addition, the initial value for the third line is 1023, those for the fourth to the eighth lines are 1022, those for the ninth to the 14^{th} lines are 1021, those for the 15^{th} to the 19^{th} lines are 1020, and that for the 20^{th} line is 1019. The initial value for the 1079^{th} line is 819 and that for the 1080^{th} line is 819. The initial values for the respective scan lines in the vertical direction are thus changed.

In the latter example, the image is considered to have the color difference only in the vertical direction. Due to this, in the horizontal direction of each scan line, “0111 (P3 to P0)” is stored in the correction value address 0 of each of the addresses L0P0, L0P1, L0P2, and L0P3 corresponding to the first line subsequent to the initial value data addresses. Thereafter, “0111 (P3 to P0)” is repeated 319 times, starting at the correction value address 1.

As can be seen, in the color difference correction data, the initial value for each scan line is expressed by 4 bits for the pixel addresses on each scan line depending on the initial value address for each line in the horizontal and vertical directions. As for the detailed configuration and operation, the extension processing unit 711, to be described later, determines whether the addition/subtraction circuit 713 performs an operation, performs an addition operation, or performs a subtraction operation, and determines to which pixel the correction progresses by this operation or non-operation. Results of the determination are encoded and stored. Therefore, if the data has a smaller change, the correction data for one line can be smaller.

In the first embodiment, for example, the correction data for one line at one class is 1920×2 (bits)=3840 (bits) In the second embodiment, by contrast, the correction data for one line at one class is about 191×4 (bits)=764 (bits). As can be seen, the change value of the gradation correction characteristic in the horizontal direction of the display pixels is encoded, compressed, and recorded in the second LUT unit 706.

Operations for reading and reproducing the “difference” correction data stored in the second LUT unit 706 and for correcting the “difference” will be described. An operation for reading the correction data from the second LUT unit 706 will first be described.

(Operation for Reading Correction Data from Second LUT)

The correction value coded data written to the memory cell 707 of the 255^{th} class among the 256 memory cells 707 corresponding to the 0^{th} to the 255^{th} classes in the second LUT unit 706 shown in FIG. 8 is read from the memory cell 707 at a clock signal timing synchronous with a vertical synchronizing signal and a horizontal synchronizing signal from the timing signal generator 20 shown in FIG. 1.

As stated, the data is stored in the memory cell 707 of the 256^{th} class in the address format shown in FIG. 9. At a vertical image start timing, the initial value data is sequentially read from the 10 initial data addresses J, I, H, G, F, E, D, C, B, and A of the memory address L0P0 on the line L0 in response to a horizontal synchronizing read start pulse for the first scan line in a total of 10 pixel clock period. In the second embodiment, the data having a width of 3 bits indicated by the other P1, P2, and P3 is dealt with as ignorable data in the period of reading the initial value data from the addresses J, I, H, G, F, E, D, C, B, and A.

Likewise, the initial value data is read from the initial value data addresses J, I, H, G, F, E, D, C, B, and A of LLP0, L2P0 to L1079P0 for every horizontal synchronization at an initial timing for each scan line.

(Generation of Initial Value)

As stated above, the initial value data read from the memory cells 707 of 0^{th} to 255^{th} classes in the second LUT unit 706 is supplied to the initial value generating unit 708. As stated, the initial value generating unit 708 is constituted by 256 initial value setting units 709 corresponding to the 0^{th} to the 255^{th} classes, respectively. As a typical example of this initial value setting unit 709, an instance of generating an initial value of the red signal at the 255^{th} class will be described.

The initial value data stored in the initial value data addresses J, I, H, G, F, E, D, C, B, and A of the memory line address L0P0 of the memory cell 707 of the 255^{th} class is read sequentially for every pixel clock timing, and read sequentially by the 10 flip-flops (hereinafter, Q1 to Q10) from a serial data input terminal of the initial value setting unit 709 as serial data. The data stored in the initial value data addresses J, I, H, G, F, E, D, C, B, and A is “1, 1, 1, 1, 1, 1, 1, 1, 1, 1 (MSB:LSB)” similarly to the example of the write operation. When the data at the address A is captured at the pixel clock timing, 10-bit parallel outputs “1, 1, 1, 1, 1, 1, 1, 1, 1, 1 (MSB:LSB)” that are outputs from the 10 flip-flops Q1 to Q10 that constitute the shift register of the initial value setting unit 709 are supplied to the first input of the switching circuit 712 corresponding to the 255^{th} class in the correction data reproducing unit 710 in rear of the initial value correction unit 708.

Through the above-stated operation, the initial value data corresponding to the 255^{th} class is reproduced and input to the second input of the addition/subtraction circuit 713 corresponding to the 255^{th} class through the switching circuit 712 corresponding to the 255^{th} class.

The output of the latch circuit 715 corresponding to the 255^{th} class in the latch unit 714 is connected to the first input of the addition/subtraction circuit 713 corresponding to the 255^{th} class. At the timing of accessing the memory address 0 after the initial value generation stage, the latch circuit 715 is just reset. Therefore, the parallel data of 10 bits of “0, 0, 0, 0, 0, 0, 0, 0, 0, 0 (MSB:LSB)” is input to the first input of the addition/subtraction circuit 713.

Due to this, at the timing of accessing the correction value data address 0 of the line address L0P0 of the memory cell 707 corresponding to the 255^{th} class, the initial value data of “1, 1, 1, 1, 1, 1, 1, 1, 1, 1 (MSB:LSB)” input to the second input of this addition/subtraction circuit 713 is output from the addition/subtraction circuit 713. The output signal from this addition/subtraction circuit 713 is supplied to the 10-bit data input terminal of the memory cell 705 corresponding to the 255^{th} class in the first LUT unit 702.

At the same time, the gradation correction data at the timing 0 of the pixel addresses output from this addition/subtraction circuit 713 is captured into the latch circuit 715 corresponding to the 255^{th} class in the latch unit 714 synchronized with the pixel clock timing, and held until the next pixel clock timing. Thereafter, the data output from the addition/subtraction circuit 713 of the corresponding class in the correction data reproducing unit 710 connected at each pixel clock timing is captured and held for one clock period by the latch circuit 715.

(Generation of Corrected Value from Corrected Data)

As shown in the “memory address configuration” of FIG. 9, after the initial value data is read from the memory cells 707 corresponding to the 0^{th} to the 255^{th} classes in the second LUT unit 706, respectively, i.e., after the data stored in the initial value addresses J, I, H, G, F, E, D, C, B, and A of the respective memory cells 707 in the second LUT unit 706, correction data is read.

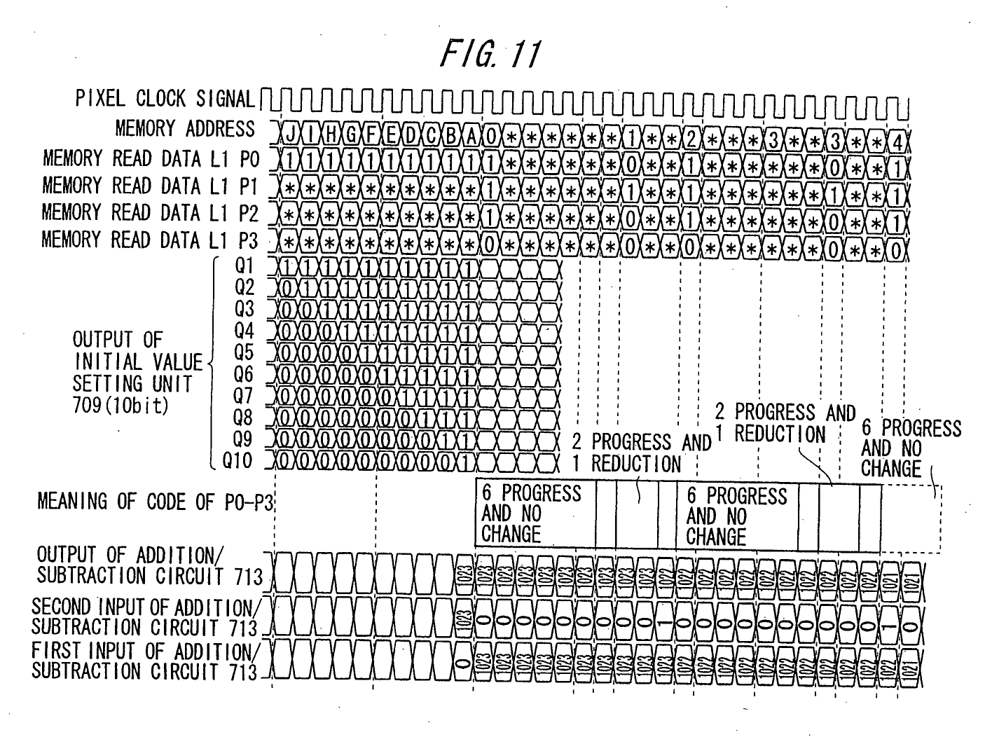

Further, as indicated by “memory cell read timing chart” shown in FIG. 11, the correction data read at this moment is constituted by 4-bit data of P0, P1, P2, and P3 as already stated and input to each extension processing unit 711 in the correction data reproducing unit 710. The data is decoded by this extension processing unit 711.

The data decoded by the extension processing unit 711 is supplied to the second input of the switching circuit 712, switched over from the initial value data through the switching circuit 712, and supplied to the second input of the addition/subtraction circuit 713.

(Operation of Extension Processing Unit)

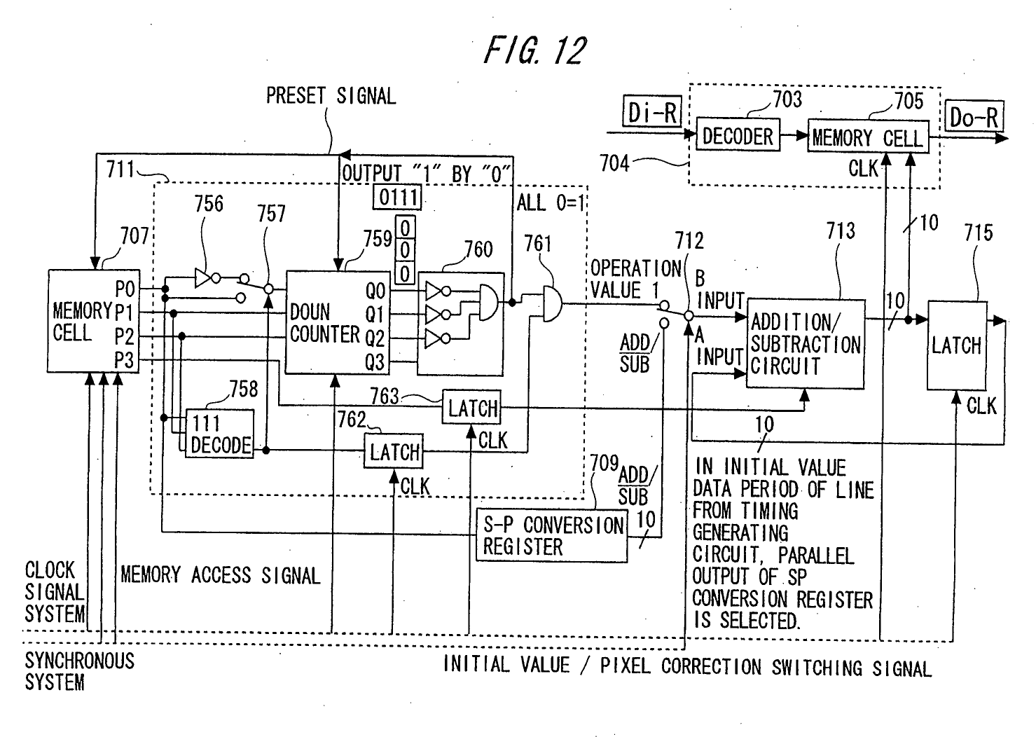

An operation performed by the extension processing unit 711 will be described in detail FIG. 12 depicts an example of a configuration of the extension processing unit 711 and those of peripheral circuits of the extension processing unit 711. Further, other 0^{th} to 254^{th} classes have a similar configuration.

As shown in FIG. 12, the 4-bit correction data of P0 to P3 is supplied from each memory cell 707 to the extension processing unit 711 in the correction data reproducing unit 710. Among the data P0 to P3 of 4 bits, P1 and P2 are directly supplied to a counter 759. In addition, P0 is supplied to an input of the counter 759 either through an inverting circuit 756 or a switching circuit 757 in which the data P0 is switched over, without passing through the inverting circuit 756. This counter 759 is a down-counter.

Further, P3 is supplied to a latch circuit 763 of 1 bit. At the same time, 3-bit data of P0 to P2 of the memory cell 707 is divided and input to a decoder 758. An output from the decoder 758 is input to a control terminal of a switching circuit 757 and supplied to an input of a latch circuit 762. The data P0 output from the memory cell 707 is supplied, as serial data, to the initial value setting unit 709 of the initial value generating unit 708.

Next, an output of a 0-level decoder 760 is connected to an input of a data switch 761. An output of this data switch 761 is supplied to a second input of the switching circuit 712. The output of the latch circuit 761 is supplied to an ON/OFF control terminal of the data switch 761. An output of the latch circuit 723 is input to the addition/subtraction control terminal of the addition/subtraction circuit 713. The connection among the memory cell 705 in the first LUT unit 702, the addition/subtraction circuit 713, the latch circuit 715, the initial value setting unit 709 in the initial value generating unit 708, and the switching circuit 712 is based on the connection configuration shown in FIG. 8.

An extension processing operation for extending coded data output from the memory cell 707 by the configurations of the extension processing unit 711 and its peripheral circuits will be described specifically.

(1) If the data (hereinafter, “P3 to P0”) read from the memory cell 707 in the second LUT unit 706 is, for example, 0110 (P3:P0), the data 110 of P2 to P0 is preset to the counter 759 at a pixel timing of reading this data from the memory cell 707 in the second LUT unit 706.

Next, the counter 759 executes a subtraction counting for every pixel clock and a counter output is 000 at a sixth pixel timing. The 0-level decoder 760 detects the data “000 (P2:P0)” and outputs “1”, and the value of the second input of the addition/subtraction circuit 713 becomes “1” at the sixth pixel timing. In this case, the data switch 761 is turned on and the second input of the circuit 713 is selected by the switching circuit 712.

The data P3 output from the memory cell 707 in the second LUT unit 706 is 0 at a read timing. Therefore, an output value of the latch circuit 723 in rear of the circuit 713 remains 0, and the addition/subtraction circuit 713 is controlled to perform “subtraction” for designation of addition or subtraction.

Accordingly, from the timing of reading the data 0110 (P3:P0) from this memory cell 707 to the sixth pixel timing, the addition/subtraction circuit 713 subtracts “1” from the first input value.

Namely, if the initial value is, for example, 1023, the initial value “1022” is supplied to the latch circuit 715 and the memory cell 705 in the first LUT unit 702 from the data read timing to the sixth pixel timing.

(2) If the data (P3 to P0) read from the memory cell 707 in the second LUT unit 706 is, for example, 0101 (P3:P0), the data 101 of P2 to P0 is preset to the counter 759 at the pixel timing of reading this data from the memory cell 707. The counter 759 executes a subtraction counting for every pixel clock and a counter output is 000 at a fifth pixel timing. The 0-level decoder 760 detects the data outputs “1”, and the value of the second input of the addition/subtraction circuit 713 becomes “1”. In this case, the data switch 761 is turned on and the second input of the circuit 713 is selected by the switching circuit 712. The data P3 output from the memory cell 707 in the second LUT unit 706 is 0 at the read timing. Therefore, the output value of the latch circuit 723 remains 0, and the addition/subtraction circuit 713 is controlled to perform “subtraction” for designation of addition or subtraction.

Accordingly, from the timing of reading the data 0101 (P3 to P0) from the memory cell 707 to the fifth pixel timing, the addition/subtraction circuit 713 subtracts “1” from the first input value.

Namely, if the initial value is 1023, the initial value “1022” is supplied to the latch circuit 715 and the memory cell 705 in the first LUT unit 702 from the data read timing to the fifth pixel timing.

(3) Similarly, if the data (P3 to P0) read from the memory cell 707 in the second LUT unit 706 is, for example, 0100 (P3:P0), the second input value (B) of the addition/subtraction circuit 713 is 1 at a fourth pixel timing. At this fourth pixel timing, the addition/subtraction circuit 713 subtracts “1” from the first input value and supplies the output to the latch circuit 715 and the memory cell 705 in the first LUT unit 702.

(4) If the data (P3 to P0) read from the memory cell 707 in the second LUT unit 706 is, for example, 0011 (P3:P0), the second input value (B) of the addition/subtraction circuit 713 is 1 at a third pixel timing. At this third pixel timing, the addition/subtraction circuit 713 subtracts “1” from the first input value and supplies the output to the latch circuit 715 and the memory cell 705 in the first LUT unit 702.

(5) If the data (P3 to P0) read from the memory cell 707 in the second LUT unit 706 is, for example, 0010 (P3:P0), the second input value (B) of the addition/subtraction circuit 713 is 1 at a second pixel timing. At this second pixel timing, the addition/subtraction circuit 713 subtracts “1” from the first input value and supplies the output to the latch circuit 715 and the memory cell 705 in the first LUT unit 702.

(6) If the data (P3 to P0) read from the memory cell 707 in the second LUT unit 706 is, for example, 0001 (P3:P0), the second input value (B) of the addition/subtraction circuit 713 is 1 at a first pixel timing. At this first pixel timing, the addition/subtraction circuit 713 subtracts “1” from the first input value and supplies the output to the latch circuit 715 and the memory cell 705 in the first LUT unit 702.

(7) If the data (P3 to P0) read from the memory cell 707 in the second LUT unit 706 is, for example, 0000 (P3:P0), an output of the counter 759 is 000 at the timing of reading this data. The 0-level decoder 760 outputs “1”, and the value of the second input of the addition/subtraction circuit 713 becomes “1”. In addition, the data P3 output from the memory cell 707 in the second LUT unit 706 is captured into the latch circuit 723 and the latch circuit 723 outputs “0”. Therefore, the addition/subtraction circuit 713 is controlled to perform “subtraction” for designation of addition or subtraction.

Accordingly, at the timing of reading the data 0000 (P3:P0) from this memory cell 707 in the second LUT unit 706, the addition/subtraction circuit 713 subtracts the second input value “1” from the first input value of this addition/subtraction circuit 713 and an output from the addition/subtraction circuit 713 is supplied to the latch circuit 715 and the memory cell 705 in the first LUT unit 702.

Namely, if the initial value is, for example, 1023, the initial value “1022” is supplied to the latch circuit 715 and the memory cell 705 in the first LUT unit 702 at the timing of reading the data from the memory cell 707.

(8) If the data (P3 to P0) read from the memory cell 707 in the second LUT unit 706 is, for example, 0111 (P3:P0), a 111 decoder 758 constituted by an AND circuit detects the data “111” and outputs “1” at the pixel timing of reading this data. In response to this output 1, the data P0 output from the memory cell 707 is inverted by a polarity switching unit constituted by an inverter 756 and a switching circuit 757, and the inverted data P0 and the data P1 and P2 are supplied to the counter 759 and preset thereto.

Namely, the value “0110 (P3: P0)” is preset to the counter 759. The 111 decoder 758 detects 1 and the output 1 is held by the latch circuit 762. A decoder data output of the 0-level decoder 760, which outputs “1” when the data 000 (P0:P2) is input, is turned off by the data switch 761, thereby stopping outputting 0-level decoding signal to the second input of the addition/subtraction circuit 713. In other words, “1” is not output thereto.

The counter 759 counts down the data for every pixel clock and an output of counter 759 is 000 at a sixth pixel timing. The 0-level decoder 760 outputs “1”, and the counter 759 is initialized at a rising edge of a next pixel clock timing.

Accordingly, if the data (P3 to P0) read from the memory cell 707 in the second LUT unit 706 is 0111 (P3:P0), then the counter 759 counts down the data during a period from the timing of reading the data from the memory cell 707 to the sixth pixel clock timing, and the addition/subtraction circuit 713 does not execute an operation.

If the initial value is 1023, the value 1023 is supplied to the latch circuit 715 and the data input terminal of the memory cell 705 of the first LUT unit 702 for every pixel clock timing during a period of six pixel clock timings.

As can be seen, if the data P3 to P0 read from the memory cell 707 in the second LUT unit 706 is any one of 0110 (P3:P0), 0101 (P3:P0), 0100 (P3:P0) 0011 (P3:P0), 0010 (P3:P0), 0001 (P3:P0), 0000 (P3:P0), and 0111 (P3:P0), a fourth digit (P3) is 0, and the addition/subtraction circuit 713 executes the subtraction operation.

(9) If the data (P3 to P0) read from the memory cell 707 in the second LUT unit 706 is, for example, 1110 (P3:P0), the data 110 (P2 to P0) of P2 to P0 out of the data read at the pixel timing of reading this data from the memory cell 707 in the second LUT unit 706 is preset to the counter 759.

The counter 759 executes a subtraction counting for every pixel clock and a counter output of the counter 759 is 000 at a sixth pixel timing. The 0-level decoder 760 detects the data “000 (Q2:Q0) and outputs “1”, and the value of the second input of the addition/subtraction circuit 713 becomes “1” at the sixth pixel timing.

The data P3 output from the memory cell 707 in the second LUT unit 706 is 1 at the read timing. Therefore, an output value of the latch circuit 723 in rear of the circuit 713 remains 1, and the addition/subtraction circuit 713 is controlled to perform “addition”.

Accordingly, from the timing of reading the data 1110 (P3:P0) from this memory cell 707 in the second LUT unit 706 to the sixth pixel timing, the addition/subtraction circuit 713 adds the second input value “1” to the first input value.

Namely, if the initial value is, for example, “256”, the value “257” is supplied to the latch circuit 715 and the memory cell 705 in the first LUT unit 702.

(10) If the data (P3 to P0) read from the memory cell 707 in the second LUT unit 706 is, for example, 1101 (P3:P0), the data 101 (P2:P0) of P2 to P0 out of the data read at the pixel timing of reading this data from the memory cell 707 in the second LUT unit 706 is preset to the counter 759. The counter 759 executes a subtraction counting for every pixel clock and a counter output is 000 at a fifth pixel timing. The 0-level decoder 760 detects the data “000 (Q2:Q0) and outputs “1”, and the value of the second input of the addition/subtraction circuit 713 becomes “1”. The data P3 output from the memory cell 707 in the second LUT unit 706 is 1 at the read timing. Therefore, an output value of the latch circuit 723 in rear of the circuit 713 remains 1, and the addition/subtraction circuit 713 is controlled to perform “addition”.

Accordingly, from the timing of reading the data 1101 (P3:P0) from this memory cell 707 in the second LUT unit 706 to the fifth pixel timing, the addition/subtraction circuit 713 adds the second input value “1” to the first input value. Namely, if the initial value is, for example, “256”, the value “257” is supplied to the latch circuit 715 and the memory cell 705 in the first LUT unit 702.

(11) Likewise, if the data (P3 to P0) read from the memory cell 707 in the second LUT unit 706 is, for example, 1100 (P3:P0), the second input value (B) of the addition/subtraction circuit 713 is 1 at a fourth pixel timing. The addition/subtraction circuit 713 adds “1” to the first input value and supplies the output to the latch circuit 715 and the memory cell 707 in the first LUT unit 702.

(12) Likewise, if the data (P3 to P0) read from the memory cell 707 in the second LUT unit 706 is, for example, 1011 (P3 to P0), the second input value (B) of the addition/subtraction circuit 713 is 1 at a third pixel timing. The addition/subtraction circuit 713 adds “1” to the first input value and supplies the output to the latch circuit 715 and the memory cell 707 in the first LUT unit 702.

(13) Likewise, if the data (P3 to P0) read from the memory cell 707 in the second LUT unit 706 is, for example, 1010 (P3 to P0), the second input value (B) of the addition/subtraction circuit 713 is 1 at a second pixel timing. The addition/subtraction circuit 713 adds “1” to the first input value and supplies the output to the latch circuit 715 and the memory cell 707 in the first LUT unit 702.

(14) Likewise, if the data (P3 to P0) read from the memory cell 707 in the second LUT unit 706 is, for example, 1001 (P3:P0), the second input value (B) of the addition/subtraction circuit 713 is 1 at a first pixel timing. The addition/subtraction circuit 713 adds “1” to the first input value and supplies the output to the latch circuit 715 and the memory cell 707 in the first LUT unit 702.

(15) If the data (P3 to P0) read from the memory cell 707 in the second LUT unit 706 is, for example, 1000 (P3:P0), the output of the counter 759 is Oh at the timing of reading this data. The 0-level decoder 760 outputs 1, and the value of the second input of the addition/subtraction circuit 713 becomes “1”. The data P3 output from the memory cell 707 in the second LUT unit 706 is 1 at the read timing. Therefore, an output value of the latch circuit 723 in rear of the circuit 713 remains 1, and the addition/subtraction circuit 713 is controlled to perform “addition”.

Accordingly, at the timing of reading the data 1000 (P3:P0) from this memory cell 707 in the second LUT unit 706, the addition/subtraction circuit 713 adds the second input value “1” to the first input value. The output of this addition/subtraction circuit 713 is supplied to the latch circuit 715 and the memory cell 705 in the first LUT unit 702. If the initial value is, for example, “256”, the value “257” is supplied to the latch circuit 715 and the memory cell 705 in the first LUT unit 702.

(16) If the data (P3 to P0) read from the memory cell 707 in the second LUT unit 706 is, for example, 1111 (P3:P0), the 111 decoder 758 constituted by the 3-input AND circuit detects the value “111 (P0:P3)” and outputs “1” at the pixel timing of reading this data.

In response to this output 1, the data P0 output from the memory cell 707 is inverted by the polarity switching unit constituted by the inverter 756 and the switching circuit 757, and the inverted data P0 and the data P1 and P2 are supplied to the data input of the counter 759 and preset thereto. Namely, the lower three bits out of the input data 1111 (P3:P0) are converted into the data value 110 (P2:P0) and the data value 110 is supplied to the counter 759.

Further, the 111 decoder 758 detects 1 and this value 1 is held by the latch circuit 762. In response to the output (1 when inputting “000”) of the 0-level decoder 760, the data switch 761 is turned off, the command is supplied to the second input of the switching circuit 712, and the output of this 0-level decoding signal to the second input of the addition/subtraction circuit 713 in rear of the circuit 712 is stopped. The data value is pulled down to 0 by a pulldown resistance, so that a logic value in this case is 0. Alternatively, the same function can be fulfilled using a gate circuit of an AND logic.

The counter 759 counts down the data for every pixel clock from the timing of reading the data from the memory cell 707, and a counter value is 000 at a sixth pixel timing. The 0-level decoder 760 in rear of the counter 759 outputs “1”, and this output signal is used as an initialization signal to initialize the counter 759 at a rising edge of a next pixel clock.

Through the above-stated operation, in a period from the timing of reading the data 1111 (P3:P0) from the memory cell 707 in the second LUT unit 706 to the sixth pixel clock timing period, the second input value of the addition/subtraction circuit 713 relative to the first input value thereof is “0”. At the next pixel timing, the data at the next address is read from the memory cell 707 in the second LUT unit 706.

Namely, if the data read from the memory cell 707 is 1111 (P3:P0), and the initial value is 256, the value 256 is supplied to the latch circuit 715 and the data input terminal of the memory cell 705 of the first LUT unit 702 during a period of six pixel clock timings.

As can be seen, if the data (P3 to P0) read from the memory cell 707 in the second LUT unit 706 is any one of 1110 (P3:P0), 1101 (P3:P0), 1100 (P3:P0) 1011 (P3:P0), 1010 (P3:P0), 1001 (P3:P0), 1000 (P3:P0), and 1111 (P3:P0), the fourth digit (P3) is 1, and the addition/subtraction circuit 713 executes the addition operation.

The extension processing unit 711 shown in FIGS. 8 and 12 is configured and activated as stated above, whereby the color difference gradation correction coded data for the color difference correction values shown in FIG. 10 recorded in each memory cell 707 of the second LUT unit 706 as the coded data can be synchronized with the pixel clock timings for the image display and subjected to an extension operation, and this extension-decoded correction data can be sequentially written to each memory cell 705 of the first LUT unit 702 at every pixel clock timing.

The processing for writing the correction data from the memory cell 707 in the second LUT unit 706 at the circuit block class corresponding to the 255^{th} gradation among the 0^{th} to the 255^{th} gradations to the first LUT unit 702 has been described above. For the remaining 254^{th} to 0^{th} classes in the circuit block configuration having 255 classes shown in FIG. 8, the same extension processing is executed.

As for the processing for reading the data from the memory cell 707 in the second LUT unit 706, the extension and decoding processing performed by the correction data reproducing unit 710, and the processing for writing the correction data to the memory cell 705 in the first LUT unit 702 for the 255^{th} class as stated above, the same processings are performed for each of the 0^{th} to the 254^{th} classes.

(Gradation Correction in First LUT)

In the first LUT unit 702, the 8-bit red image input signal Di-R is input to the address decoder 703 shown in FIG. 3, similarly to the first embodiment. The input image input signal Di-R is subjected to demodulated into a signal in the decimal notation at the address decoder 703.

If input values of the 8-bit red image signal Di-R input to each memory cell 707 of the second LUT unit 706 at the memory address timing 0 as the first pixel in the display unit at the line address L0 are, for example, 1, 1, 1, 1, 1, 1, 1, 1 (MSB:LSB) of 8 bits, then the decoded value decoded by the address decoder 703 is “255”, the output signal from the port S255 of the address decoder 703 is active, and output enable of the memory cell 705 of the 255^{th} class in the first LUT unit 702 is active. From this memory cell 705 of the 255^{th} class, output correction values “1, 1, 1, 1, 1, 1, 1, 1, 1, 1” (MSB:LSB) from the addition/subtraction circuit 713 are supplied to the DA converter 10 in rear of the circuit 713 through the red image signal output unit of the image signal output terminal 716 as a parallel red image output signal Do-R. After the red image output signal Do-R is subjected to DA conversion at this DA converter 10, the liquid crystal driving signal is obtained by the liquid crystal driving unit 13 and supplied to the liquid crystal display unit 16.

10-bit digital outputs of each of the 255 memory cells 705 in the first LUT unit 702 are connected in parallel in binary values to constitute the 10-bit data bus. However, only one memory cell 705 selected by the address decoder 703 is active among the 255 memory cells 705.

Similarly, the input values of the 8-bit red image signal Di-R from the first to the 1920^{th} pixels at the display line address L0 are input through the image signal input unit 701 for the read signal. The input values of the 8-bit red image signal Di-R are continuous signals of 1, 1, 1, 1, 1, 1, 1, 1 (MSB:LSB) in the binary notation, assuming that the signals are input at 100% white according to the second embodiment. In the first LUT unit 702, the memory cell 705 of the 255^{th} class is always active.

Namely, the gradation correction data value output from the first LUT unit 702 at the timing of the pixel address 0 of the display line address L0 is “1023”. Thereafter, the gradation correction data value is gradually attenuated by 1 per every 9.37 pixels, and reduced to about “818” at the pixel address 1919. In this case, the reproduction data is expressed in integer quantization level.

Likewise, output values of the gradation correction data Do-R output from the first LUT unit 702 for the display line addresses L1 to L1079 are similar to those for the display line address L0.

As can be seen, for the color difference that the image is gradually reddy from left to right on the screen and that a red component of the image is increased by 20% on the right end of the screen according to this embodiment, the horizontal color difference on the display screen of this display apparatus according to this embodiment is corrected by the output values of the red image output signal Do-R having a gradual change with an attenuation of 20% on the right end of the screen relative to the left end thereof and output from the first LUT unit 702.

Likewise, at the input level “254”, the 10-bit data of the memory cell 705 of the 254^{th} class in the first LUT unit 702 is output as the red image output signal Do-R of the first LUT unit 702 of the gradation correction unit 7. At each of the input levels “253” to “0”, the 10-bit data of each of the corresponding memory cells 705 of the 253^{rd} to the 0^{th} classes of the first LUT unit 702 is output, thereby correcting the color difference in the display image.

In the above-stated embodiment, the red color difference is reduced by correcting the gradation correction characteristic of the red image signal for each pixel. By correcting the gradation correction characteristics of all the red, green, and blue image signals for every pixel by the gradation correction units 7, 8, and 9 shown in FIG. 1, respectively, the color difference in the display image can be corrected at high accuracy at all gradations of all colors corresponding to logic levels of the input images.

In the first and the second embodiments, the instances of correcting the gradations and correcting the luminance difference and the color difference in the liquid crystal projector have been described. However, the same advantages can be attained for the other display apparatuses such as a plasma display apparatus, a liquid crystal display apparatus, and an EL display apparatus.

### THIRD EMBODIMENT

A display apparatus according to a third embodiment of the present invention will be described. The third embodiment is equal to the second embodiment except for the operation for writing display correction data to the second LUT unit 706. Only the different respects will be, therefore, described herein.

(Operation for Writing Display Correction Data to Second LUT Unit)

Namely, as for the operation for writing the display correction data to the second LUT unit 706 according to the first and the second embodiments, the memory that constitutes the second LUT unit 706 is one of the ROM, the EEPROM, the EPROM, the one time ROM, the flash memory and the like. These memories are classified as nonvolatile memories.

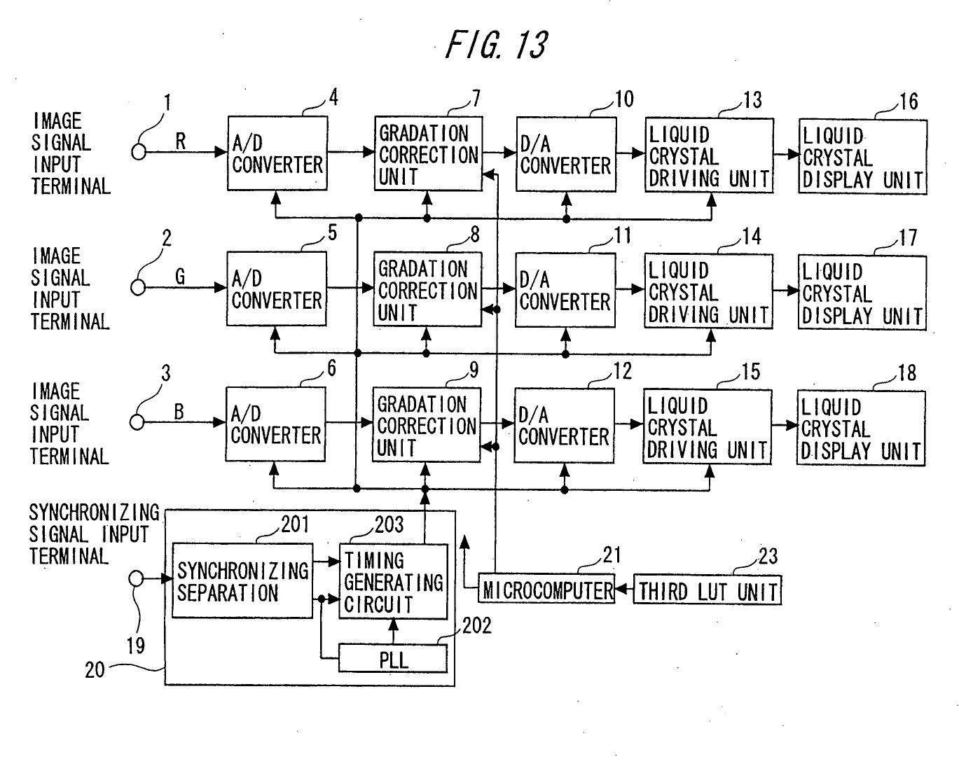

The data is written to the memory based on the operation performed by the PC in the data format to be described later. In this third embodiment, an additional nonvolatile memory is provided so that a third LUT unit 23 serving as a third memory is provided as shown in FIG. 13.

Compressed or uncompressed data based on the gradation correction data written to the second LUT unit according to the first and the second embodiments is recorded in this third LUT unit 23, which is the nonvolatile memory. In a system control microprocessor initial setting sequence such as a time of turning on the apparatus, the data stored in the third LUT unit 23 is copied or transferred to the second LUT unit 706 constituted by the RAM through the microprocessor or a bus controlled by the microprocessor so as to perform the same correction processing as those according to the first and the second embodiments. It is thereby possible to attain the same advantages as those of the first and the second embodiments. Besides, since the device at a high operating rate can be normally provided as compared with the second LUT unit, it is possible to easily realize the circuit.

### FOURTH EMBODIMENT

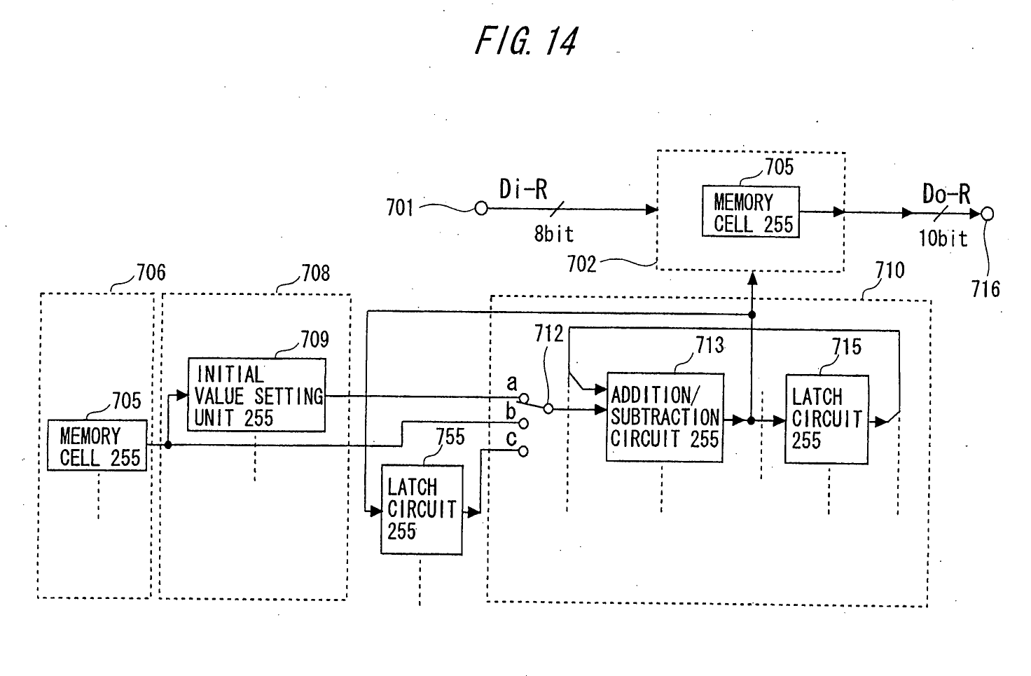

A fourth embodiment of the present invention will be described. As a contrast to the circuit block diagram of the gradation correction unit 7 according to the first embodiment shown in FIG. 3, a circuit block diagram of the gradation correction unit 7 according to this fourth embodiment is shown in FIG. 14. To facilitate understanding, the 255 classes will not be mentioned herein.

In FIG. 14, the gradation correction unit 7 is configured to include 256 second latch circuits 755 corresponding to the 0^{th} to the 255^{th} classes in parallel to the latch circuits 715, with each second latch circuit 755 having a common input to each latch circuit 715. An output of each second latch circuit 755 is connected to a third input c of the switching circuit 713.

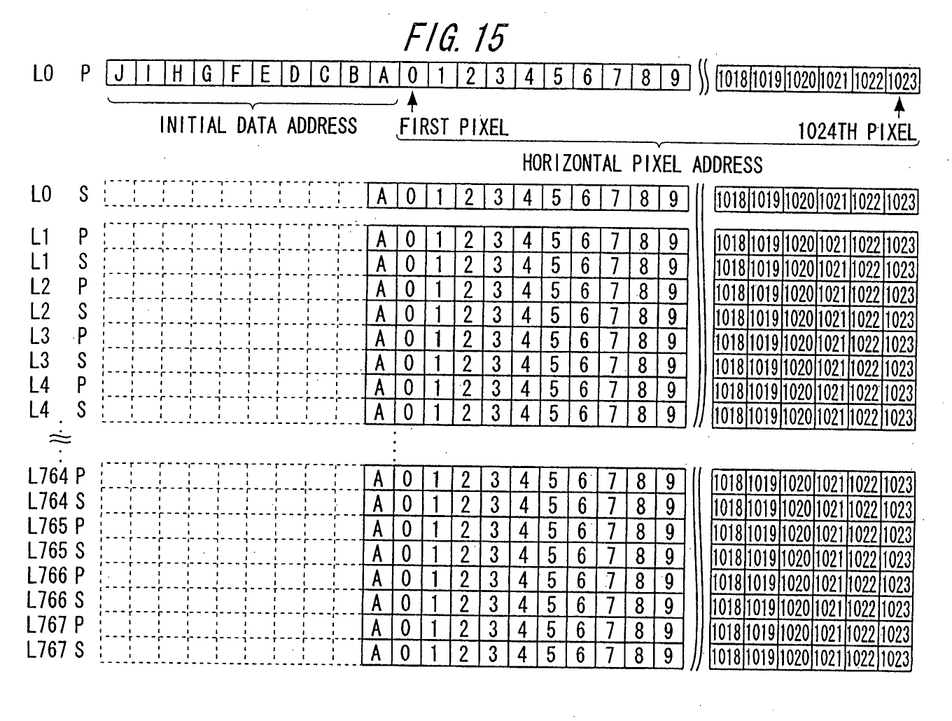

As shown in FIG. 15, in the address structure of memory cells corresponding to 256 classes in the second LUT, 10 bits for initial value data J to A are provided as addresses on a scan line just before the first scan line L0, and 1 bit for initial data A is provided as an address on each of the second to the final scan lines.

These addresses are L0PJ to L0PA of 10 bits, and L1PA, L2PA to L1023PA, L1SA, L2SA to L1023SA for 2-bit A addresses as line addresses on each scan line.

In the initial data addresses L0PJ to L0PA of 10 bits, initial value data on the first scan line L0 is stored. In the initial value address L1PA of 1 bit on the second scan line L1, an absolute value of a differential value of an initial value on the second scan line from that on the first scan line is stored.

Likewise, in the initial value address L1SA of 1 bit on the second scan line L1, a code indicating whether the differential value of the initial value on the second scan line from that on the first scan line is an increase or an attenuation, that is, a code indicating whether the absolute value of the differential value of the L1PA is added or subtracted is stored.

Next, in the initial value address L2PA on the third scan line L2, an absolute value of a differential value of the initial value on the third scan line from that on the second scan line is stored.

Likewise, in the initial value address L2SA on the second scan line L1, a code indicating whether the differential value of the initial value on the second scan line from that on the first scan line is an increase or an attenuation, that is, a code indicating whether the absolute value of the differential value of the L2PA is added or subtracted is stored. Subsequently, initial values are stored in 2 bit, P and S respectively, to 768^{th} line.

After the initial value on each scan line, correction data on each of the 0^{th} to 1023^{rd} pixel addresses to the initial value of each lines similarly to the first scan line L0 as well as a code indicating whether data as the differential value from the gradation correction data on the pixel just before each pixel is an increase or a reduction is stored in each pixel address of 2 bits, similarly to the first embodiment.

With the circuit block configuration of the gradation correction unit 7 stated above and shown in FIG. 14, the initial values of 10 bit at the L0PJ to L0PA on the line address L0 are read from each of the memory cells 707 of the 0^{th} to the 255^{th} classes in the second LUT unit 706 synchronously with sequential displaying the display addresses in the display unit from the first scan line. The initial value is captured in the initial value setting unit 709 corresponding to each class in the initial value generating unit 708 for every clock. The initial values of 10 bits are reproduced at the timing of the pixel address A after 10 clocks, and supplied as parallel data to the correction data reproducing unit 710 in rear of the initial value setting unit 708.

Likewise, this data is supplied to each of the 256 second latch circuit 755 corresponding to the 0^{th} to the 255^{th} classes and held for one scan line period.

Next, similarly to the first embodiment, in the correction data reproducing unit 710, the correction data is reproduced to correspond to the pixel display addresses 0 to 1023 at a timing next to the pixel address timing A, and the reproduced address is supplied to the first LUT unit 702 to change the gradation correction characteristic of the input image signal Di-R and correct the color difference and the gradations.

On the second scan line, at a timing of the initial value address B at the line address L1, the data of the second latch circuit 755 is captured into the addition/subtraction circuit 713 serving as an operation unit in rear of the second latch circuit 755. The addition/subtraction circuit 713 performs an operation between the captured data and the initial value data on the first scan line.

In this case, the addition/subtraction circuit 713 adds or subtract the 1-bit data read next to or from the initial value data on the first scan line. Whether to add or subtract is determined by the 1-bit S data read simultaneously, in which case, whether the L1SA is 1 or 0. In this way, the initial values of the second scan line are reproduced as 10-bit data and the reproduced 10-bit data is supplied to the correction data reproducing unit 710 in rear of the initial value correction unit 708, similarly to the first scan line.

At the same time, this data is supplied to and captured by the 2.56 second latch circuits 755 provided to correspond to the 0^{th} to the 255^{th} classes and held therein for one scan line period.

Next, similarly to the first scan line, in the correction data reproducing unit 710, the correction data is reproduced to correspond to the pixel display addresses 0 to 1023 at a timing next to the pixel address timing A, and the reproduced address is supplied to the first LUT unit 702 to change the gradation correction characteristic of the input image signal Di-R and correct the color difference and the gradations.

Likewise, on the subsequent scan line, at a timing of the initial value address B at each line address, the initial value data on one line before the line in the second latch circuit 755 is read, input to the second input of the addition/subtraction circuit 713 in the correction data reproducing unit 710, and stored in the latch circuit 715. In this case, the first input of the addition/subtraction circuit 713 is “0” just after being reset.

Next, at the initial value address timing A, in the addition/subtraction circuit 713 in the correction data reproducing unit 710, the data is read from the initial value addresses A LnPA and LnSA of the memory cell 707 relative to the initial values on the one line before stored in the latch circuit 755, and the data at the LnPA is supplied to the second input of the addition/subtraction circuit 713. The addition/subtraction circuit 713 performs an operation based on the code “1” or “0” indicating whether to add or subtract data to or from the data at the LnSA, thereby obtaining the initial values on this scan line. In the correction data reproducing unit 710, at a timing next to the pixel address timing A, the correction data is reproduced to correspond to the pixel display addresses 0 to 1023, and the reproduced data is supplied to the first LUT unit 702 to change the gradation correction characteristic of the input image signal Di-R and thus correct the color difference and the gradations.

In the above-stated correction method, the 10-bit initial value addresses is present for each of 768 lines at 256 classes as memory value for initial value in the second LUT unit 706 according to the first embodiment, which amounts to 1582080 bits. According to the fourth embodiment, the 10-bit initial value addresses are present for each of the 256 classes and the 2-bit initial value addresses are present for each of 767 lines at the 256 classes. It, therefore, suffices to use the memory capacity of 395264 bits, which is about 1180 kilobits.

In this fourth embodiment, the number of scan lines is 768. However, if the number of scan lines in the display unit is greater than 768, e.g., 1080 or 1400, it is possible to exhibit far greater advantages.

### FIFTH EMBODIMENT

A fifth embodiment of the present invention will be described. The overall configuration of an image display apparatus according to this fifth embodiment is equal to that shown in FIG. 1, and primary color image signals of red (R), green (G), and blue (B) are input to the image signal input terminals 1, 2, 3, respectively. In addition, the image display apparatus includes the microcomputer unit 21 serving as the information processing unit. In the fifth embodiment, each of the primary color image signals of red (R), green (G), and blue (B) are quantized to 8 bits.

The quantized 8-bit digital image signals of red (R), green (G), and blue (B) are supplied to the gradation correction units 7, 8, and 9, respectively. The gradation correction units 7, 8, and 9 simultaneously perform a gradation correction and a so-called screen difference correction of correcting a luminance difference and a color difference as will be described later. According to this fifth embodiment, 10-bit digital output image signals of red (R), green (G), and blue (B) are output from the gradation correction units 7, 8, and 9, respectively.

The 10-bit digital output signals of red (B) green (G), and blue (B) output from the gradation correction units 7, 8, and 9 are converted into analog image signals of red (R), green (G), and blue (B) by the DA converters 10, 11, and 12, respectively. The liquid crystal driving units 13, 14, and 15 appropriately generate polarity inverting or optimum level drive signals for the liquid crystal display units 16, 17, and 18, and supply the generated drive signals to the liquid crystal display units 16, 17, and 18 in rear of the liquid crystal driving units 13, 14, and 15, respectively. The drive signals are displayed as red (R), green (G), and blue (B) intrinsic images on the liquid crystal display units 16, 17, and 18, respectively.

Each of the liquid crystal display units 16, 17, and 18 is a TFT liquid crystal display unit consisting of so-called transmission polycrystalline silicon or the like, including a plurality of scan lines and a plurality of data lines, and constituted by a liquid crystal driving unit including pixel electrodes and switching elements arranged in a matrix to correspond to intersections between the scan lines and the data lines, a data line driving circuit that supplies a data line signal, a scan signal and the like to the data lines, the scan lines, and the like at predetermined timing, a scan line driving circuit, and the like (not shown).

According to this fifth embodiment, it is assumed that effective display areas are those of red (R), green (G), and blue (B), 1024 pixels are provided in a horizontal direction, and that 768 lines are provided in a vertical direction. Since a 3-LCD projector employed in the fifth embodiment is the same as that employed in the first embodiment, it will not be described herein in detail.

(Second LUT Unit)

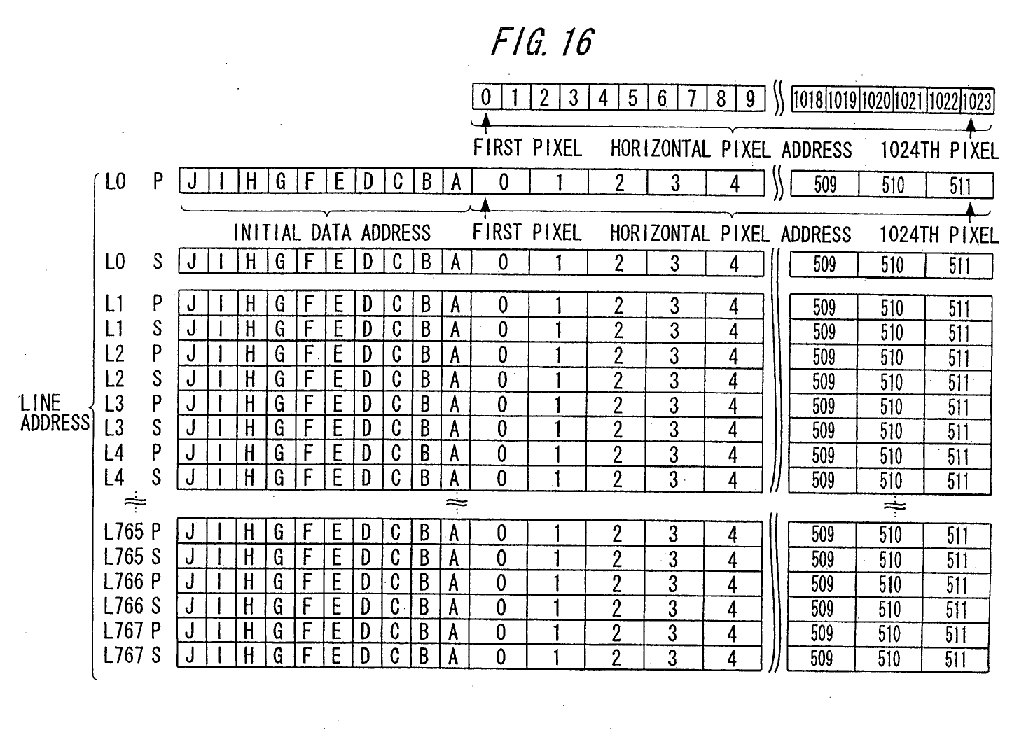

The second LUT unit 706 according to the fifth embodiment stores gradation correction data on the display image in advance to correspond to pixels of entire areas of the display screen, respectively, as will be described later. FIG. 16 depicts an address space of one memory cell 707 according to the fifth embodiment.

As shown in FIG. 16, address configurations of 768 effective scan lines are denoted by L0 to L767, respectively. Each of these scan lines L0 to L767 includes a data width of 2 bits corresponding data P and data S. Accordingly, a line address of each memory cell 707 is constituted by L0P to L767P and L0S to L767S by as much as 768 effective display scan lines.

The respective scan line addresses include 10 initial data addresses J, I, H, G, F, E, D, C, B, and A, and 512 pixel correction data addresses 0 to 511.

In the fifth embodiment, “subtraction” means subtraction of the second input value from the first input value of the addition/subtraction circuit 713 serving as a operating unit. The data S out of the 2-bit output from the second LUT unit 706 is sequentially input to the addition/subtraction control terminal of each addition/subtraction circuit 713.

Data designate addition or subtraction is stored in the data table of S out of 2-bit output of P and S in the second LUT unit 706. In the data table of P, numerical data for addition or subtraction is stored. In the fifth embodiment, either an increase or a reduction is represented by an absolute value of “1”, and no-increase or no-reduction is represented by “0”.

Therefore, the designation of either addition or subtraction by the addition/subtraction control terminal of the addition/subtraction circuit 713 is sequentially supplied from the data table for the S data out of the 2-bit output from each memory cell 707 in the second LUT unit 706, thereby controlling the addition/subtraction circuit 713.

As can be seen, the 256 addition/subtraction circuit 713 of 0^{th} to 255^{th} classes in the correction data reproducing unit 710 allow addition or subtraction results of the first inputs and the second inputs to be supplied to the 256 latch circuits 715 of 0^{th} to 255^{th} classes and to 10-bit data input terminals of the 256 memory cells 705 corresponding to the 0^{th} to 255^{th} classes of the first LUT unit 702, respectively.

(Latch Unit)

A clock input to the latch circuit 715 according to the fifth embodiment has a period twice as high as the above-stated pixel clock timing. Although not shown in the drawings, a pixel drive timing clock output from the PLL circuit 202 serving as a synchronization generating unit shown in FIG. 1 is temporarily divided into two clocks by a dividing means and the two divided clocks are supplied to the clock input terminal of this latch circuit 715 to thereby drive the latch circuit 715.

This latch unit 714 may be data holding unit for causing each latch circuit 715 to hold data for two pixel clock periods, and to provide the operation result of the corresponding addition/subtraction circuit 713 two pixel clock before to the addition/subtraction circuit 713. Therefore, the latch unit 714 can be constituted by memory circuits, delay circuits, or delay elements.

(Measurement of Display Data and Data Processing)

A specific gradation correction operation performed by the functions of the respective constituent elements configured as stated above will next be described.

To measure uncorrected display characteristics of the display apparatus, a gradation correction of each gradation correction unit is turned off. Next, a red signal at a highest input level of the display apparatus is input from a test signal generator, a display image is picked up by, for example, a video camera and captured as a capture image into a PC, and a display difference in the display area is measured. Next, the level of the white signal output from the test signal generator is attenuated to (254/255) and the display difference is similarly measured.

The level of the white signal output from the test signal generator is sequentially attenuated to (253/255), (252/255), and (251/255), and display differences in the display screen at the respective input levels are measured. This measurement is continued until the level of the white signal output from the test signal generator is equal to (1/255) and (0/255). Likewise, display differences in the display area are measured for green (G) and blue (B) at 255 levels from (254/255) to (1/255) and (0/255), respectively.

As a result of the measurement, display difference data on respective colors of red, green, and blue at input levels of 255 to 0 is captured into the PC. Next, color difference correction data is generated by an operation of the PC.

According to this fifth embodiment, the color difference correction data is a correction data group by as much as the number of all pixels, i.e., 1024 pixels in the horizontal direction by 768 lines in the vertical direction corresponding to the number of display pixels. In addition, the correction data is reduced by reducing the horizontal 1024 pixels of the correction data by half to 512 pixels. Namely, the first and the second pixels are reduced to the same correction data. Likewise, the third and the fourth pixels, and the fifth and the sixth pixels are reduced to the same correction data, respectively. In this way, the correction data is generated for every two pixels in the PC.

FIG. 6 depicts an example of the gradation correction for every two pixels as stated above. Examples of the correction characteristic shown in FIG. 6 include a degamma correction characteristic for an input image signal and a correction characteristic to a nonlinear display characteristic that is a so-called voltage-to-transmission (or reflection) characteristic of the display unit (the liquid crystal display unit in the fifth embodiment). In the fifth embodiment, the input image signal is generated as gradations of 8 bits and corrected gradations of 10 bits.

(Operation for Writing Display Correction Data to Second LUT)

Correction data corresponding to the above-stated correction characteristic is written to a total of 393216 2-bit gradation correction addresses corresponding to pixels and each indicated by P and S and a total of 7680 2-bit initial value data addresses corresponding to the scan lines, respectively and each indicated by P and S in 256 memory cells 707 of 0^{th} to 255^{th} classes in the second LUT unit 706 shown in FIG. 14 expressed in the description of “the second LUT unit 706”.

The second LUT unit 706, i.e., the second memory including the 256 memory cells 707 of 0^{th} to 255^{th} classes is constituted by, for example, a ROM, an EEPROM, an EPROM, a one-time ROM, or a flash memory. These memories are classified as nonvolatile memories.

With the address configuration of each memory cell 707 in the second LUT unit 706 as shown in FIG. 16, 10 addresses J to A are provided before the pixel address 0 corresponding to the first effective display pixel in each horizontal scan period, and gradation correction initial data is generated for this period.

(Class)

The gradation correction data in this case is constituted by 0^{th} to 255^{th} 256 classes corresponding to the gradations of the input image signal input to the gradation correction unit 7 shown in FIG. 1. Namely, as shown in the example of the gradation correction characteristic for one pixel shown in FIG. 6, gradation levels of all 256 gradations of the 8-bit image input signal (Di-R) input to the gradation correction unit 7 are allocated to correspond to the 256 memory cells 707 of 0^{th} to 255^{th} classes of the second LUT unit 706, respectively.

(Memory Address Configuration)

Next, FIG. 16 depicts the example of the address configuration of the 255^{th} class memory cell 707 corresponding to the 255^{th} gradation as one class generated by the above-stated PC.

As shown in FIG. 16, L0P serving as a first bit of the scan line L0 corresponding to the first scan line of the display image stores data of 10 bits in all in respective addresses J to A in the initial value data address period. As for the 255^{th} class, as an example of correction data, “1, 1, 1, 1, 1, 1, 1, 1, 1, 1” are stored in the addresses J to A of the L0P, respectively, with the maximum value of the effective display pixel number set as 1023 based on the gradation correction characteristic shown in FIG. 6.

In the example shown in FIG. 16, pieces of data are arranged in the respective addresses while the address A side closest to the address 0 is set as LSB.

The data stored in the addresses J to A of L0S corresponds to an ignorable period in which no data is present according to the fifth embodiment. Needless to say, by using L0P and L0S related to the data at the addresses J to A, the same data can be handled in five clock periods.

Next, in the fifth embodiment, correction data everyone pixel, i.e., correction data common to two pixels is stored as the correction address data of the second LUT unit 706 for the effective display pixel addresses 0 to 1023 subsequent to the address data stored in the addresses J to A on each of L0P and L0S as already described in relation to the generation of the correction data.

The data configuration in this case is such that correction data is stored by 2 bits at L0P and L0S. Here, “S” indicates data for designating either increase” or “reduction” of a certain correction value of “1” for increase or “0” for reduction, and “P” indicates “1” or “0” as an absolute value of a change value from a value of two pixels before, i.e., one data clock before in terms of correction data rate.

For example, if a third pixel value is reduced to “1022” for an initial value, i.e., a first pixel value of “1023” as the gradation correction value of the line address L0, “1” and “0” are stored as correction data in the addresses of the L0P1 and those of the L0S1, corresponding to third pixel and fourth pixel, respectively. Likewise, the correction data by as much as 1024 pixels in the horizontal direction is recorded in L0P2 to L0P512 for every two pixels.

The example of the address configuration of the correction data in one horizontal period of the 255^{th} class memory cell 707 has been described so far. As shown in FIG. 16, a total of 523 pieces of data are recorded in the 10 initial value addresses of J to A and the correction data addresses of 0 to 512 as line addresses L1P to L767P and L1S to L767S for second to 768^{th} lines. Similarly, the correction data is recorded for the 254^{th} to 0^{th} classes.

(Example of Correction Data)

It is assumed, for example, that the measured color difference data indicates that the correction data needs to have a correction characteristic for attenuating the red display image eventually by 20% from left to right (specifically from the pixel addresses 0 to 1023). If a change value per pixel is expressed by quantization level, the change value per pixel is 0.2 quantization level, with a maximum value being 1024 levels, as expressed as follows.
(1023×0.2)/1024=0.2

In addition, a minimum level unit dealt with in the fifth embodiment is 1 quantization level. The number of target pixels in the horizontal direction before the level is changed by 1 quantization level is 1/0.2=5. Thus, the correction data is data attenuated by one for every five pixels.

Further, if this correction value is viewed for every correction data in the second LUT unit 706 shown in FIG. 16, the correction value is changed by 1 for every 2.5 correction data addresses since one correction data period is two pixel addresses. Actually, if the correction data is data the level of which is linearly attenuated as described in this fifth embodiment, the data value is changed alternately for every 2 correction data clocks and 3 correction data clocks.

(Storage of Data)

According to a program operation of the PC, for example, “1, 1, 1, 1, 1, 1, 1, 1, 1, 1” (MSB:LSB) corresponding to 1023 in the decimal notation are sequentially stored in the addresses J to A of L0P, with the MSB and the LSB stored in the addresses J and A, respectively.

Subsequently, “0” is stored in the address 0 of L0P and “0” in the address 0 of L0S corresponding to the first and second pixels, “0” is stored in the address 1 of L0P and “0” in the address 1 of L0S corresponding to the third and fourth pixels, “1” is stored in the address 2 of L0P and “0” in the address 2 of L0S corresponding to the fifth and sixth pixels, and “0” is stored in the address 3 of L0P and “0” in the address 3 of L0S corresponding to the seventh and eighth pixels. In this way, the data having the data configuration in which data is attenuated by one per every five pixel addresses up to the address 512 of L0P and the address 512 of L0S is stored in the PC.

This example according to the fifth embodiment is on premise that no color difference is present in the vertical direction to the screen, i.e., perpendicular direction to the screen from the first to the 768^{th} lines. As the correction value, the same correction data is written to the L0P to L767P and L0S to L767S.

The operation for writing the correction data stated so far is an operation for writing data related to the 255^{th} class to the memory cell 707 in the second LUT unit 706.

Likewise, pieces of correction data related to the 254^{th} to 0^{th} classes are written, as data intrinsic to the respective classes, to the respective memory cells 707 corresponding to the 254^{th} to 0^{th} classes.

(Difference Correction in Vertical Direction)

Next, an instance in which correction data differs along the vertical direction and the image is linearly attenuated by 20% with the first line storing the highest level data of 1023 and the final line (768^{th} line) attenuated by 20% will be described. The initial value of the first line is 1024, an attenuation value of the second line is (1024×0.2)/768=0.2666 less than 1 and the initial value of the second line is, therefore, 1024. Likewise, the initial value of the third line is 1024. The level attenuation by 1 or more starts with 3.75^{th} pixel according to calculation since 1/0.2666=3.75. The initial value of the fourth line is 1023. Likewise, the initial value of the fifth line is 1023 and the level is attenuated by 2 at the 7.5^{th} pixel. The initial value of the eighth line is, therefore, 1022.

By the proportional attenuation, the initial value of the 768^{th} line is 1024−(1024×0.2)=819 with an attenuation of (1024×0.2)/768=0.2666.

As stated, the correction value data on the color difference is stored in the second LUT unit 706 with a small capacity or about half the capacity according to the fifth embodiment. Namely, the initial values of the respective lines in both the horizontal and the vertical directions are stored in the memory cells corresponding to the respective classes at the pixel addresses of the respective lines by one data address for every two pixels, and such that differential values between the correction values and those stored two pixels before, i.e., one data address before are stored as storage data.

(Operation for Writing Data to Second LUT Unit)

The data is written to the second LUT unit 706 by the PC through an interface under control of the microcomputer 21. Alternatively, the same functions can be attained even if the ROM or flash memory to which the data is written in advance is installed in the PC.

(Operation for Reading Correction Data)

As stated, the “differential value data” in the gradation correction value of the value of one pixel, to which the data is written, before the target pixel in the second LUT unit 706 shown in FIG. 16 is read at a clock signal timing synchronously with horizontal synchronization and vertical synchronization from the timing signal generator 20 shown in FIG. 1, and supplied to the initial value generating units 708 as data on the respective classes. According to the fifth embodiment, the timing of a clock signal TCK1 is twice as high as the pixel display clock period. FIG. 15 depicts an example of the data read timing in this case.

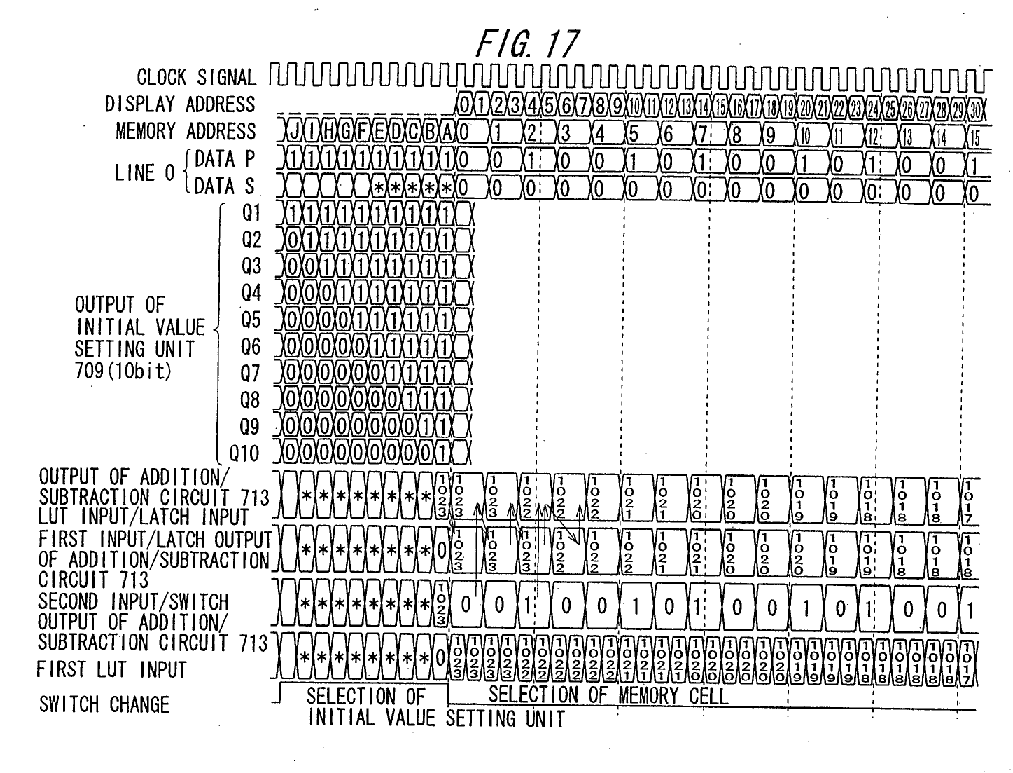

As shown in FIG. 15, the initial value data is read from the initial value data addresses (memory addresses J to A) shown in FIG. 16 for ever pixel display clocks based on the pixel display clock (clock signal). The correction value addresses subsequent to the initial value addresses are set as memory address clocks in a period twice as high as the pixel display clock timing. FIG. 17 depicts an example of the data read timing of the second LUT unit in this case.

In FIG. 17, the data P and the data S are sequentially read along the memory addresses shown in FIG. 17 as a data sequence in clock signals.

(1) At a vertical image start timing, not shown, the initial value data is read from memory addresses J, I, H, G, F, E, D, C, B, and A in response to a horizontal read start pulse on the first scan line. In this fifth embodiment, the initial value data is

(2) Next, the correction value addresses on the same memory address L0P and the correction value addresses 0 to 512 on the L0S are read as shown in FIG. 15 in the period twice as high as the above-stated clock signal. The read correction value data is output by 2 bits of the data P and the data S for every class as stated above.

(3) After reading up to the correction value addresses L0P512 and L05512, reading is a waited until a horizontal synchronizing read start pulse on the next scan line is generated.

(4) In response to the horizontal read start pulse on the second horizontal line, the initial value data address is read from the memory addresses J, I, H, G, F, E, D, C, B, and A on the second line and the correction value data is read from the correction value addresses 0, 1, 2, 3, . . . , and 512 similarly to (1)).

(5) Likewise, the data is read from the third horizontal line to the 768^{th} line, and the reading operation of (1) to (4) is executed at each vertical synchronizing timing according to the clock timing.

(6) The data reading stated above is executed from 255^{th} to 0^{th} class

(Reproduction of Initial Value)

As stated above, the correction data read from the memory cells 707 of 0^{th} to 255^{th} classes in the second LUT unit 706 is supplied to the initial value generating unit 708. Pieces of initial value data P read from the memory addresses J, I, H, G, F, E, D, C, B, and A are sequentially input to the shift registers of the initial value setting units 709 provided to correspond to the 0^{th} to 255^{th} classes in the initial value generating unit 708 for every clock, and stored in the 10 flip-flops (denoted by Q1 to Q10) as serial data.

Examples of the data stored in the flip-flops Q1 to Q10 of the respective initial value setting units 709 for each of the memory addresses J, I, H, G, F, E, D, C, B, and A are denoted by Q1 to Q10 in FIG. 17. As already stated, the address L0P on the first line of the memory cell 707 of the 255^{th} class is sequentially read as “1, 1, 1, 1, 1, 1, 1, 1, 1, 1” from each of the memory addresses J, I, H, G, F, E, D, C, B, and A. Further, all pieces of data Q1 to Q10 in the shift registers are stored at the timing of reading the data from the address L0PA. At the next timing of accessing the memory address 0, the data Q1 to Q10 are input to the second inputs of the addition/subtraction circuits 713 through the respective switching circuits 712.

At this stage, the outputs from the latch circuits 715 are input to the first inputs of the respective addition/subtraction circuits 713. At the timing of accessing the memory address 0, the latch circuits 715 are just reset. Therefore, the parallel data of 10 bits of “0, 0, 0, 0, 0, 0, 0, 0, 0, 0” is input to the first input of each addition/subtraction circuit 713.

Due to this, at the timing of accessing the memory address 0 shown in FIG. 17, the initial value data of “1, 1, 1, 1, 1, 1, 1, 1, 1, 1” corresponding to “1023” in the decimal notation and input to the second input of each addition/subtraction circuit 713 is output from the addition/subtraction circuit 713.

Through the above-stated operation, the correction value data on the 255^{th} class at the timing of the address 0 of the line 0 is output from the addition/subtraction circuit 713 of the corrected data reproducing unit 710 and stored in the memory cell 705 corresponding to the 255^{th} class in the first LUT unit 702 through the 10-bit input.

At the same time, the data at the pixel address timing 0 output from the addition/subtraction circuit 713 in the correction data reproducing unit 710 is captured into the latch circuit 715 corresponding to the 255^{th} class in the latch unit 714 by the memory data clock signal timing, and stored before generation of the next memory data clock timing period (period of two pixel clocks).

Thereafter, the data output from the addition/subtraction circuit 713 of the corresponding class in the correction data reproducing unit 710 connected at each clock is stored for one memory data clock timing period (period of two pixel clocks).

(Generation of Correction Value from Differential Value)

(Pixel Address Timing 0)

As shown in the data reproducing timing shown in FIG. 17, the data P is output as “0” and the data S is output as “0” at the memory address timing 0 of the line address 0 of the memory cell 707 denoted by L0P0 and L0S0 in the second LUT unit 706 corresponding to the first and second pixel as display timing of the display unit. Using this data S, addition or subtraction is designated to the addition/subtraction circuit 713 corresponding to the 255^{th} class in the correction data reproducing unit 710. In the designation according to this fifth embodiment, “1” functions as addition and “0” functions as subtraction.

The data P is input as the absolute value of the differential data between the correction value of the target pixel and that of one pixel before. At this timing, the read correction value data P is “0”. In addition, the correction value data at the 255^{th} class at the memory address timing 0 of the line 0 is output as the decimal value “1023” equal to the initial value data of “1, 1, 1, 1, 1, 1, 1, 1, 1, 1 (MSB:LSB)” from the addition/subtraction circuit 713 of the 255^{th} class in the correction data reproducing unit 710, and stored in the memory cell 705 of the 255^{th} class in the first LUT unit 702 as 10-bit data.

(Address Timing 1)

Likewise, at memory address timing 1 corresponding to the third and fourth pixels of the line address L0, “0” is output as the data P and “0” is output as the data S, the data P and the data S being denoted by the L0P1 and L0S1 of the memory cell 707, respectively.

Accordingly, the output of the addition/subtraction circuit 713 of the 255^{th} class in the correction data reproducing unit 710 is not changed and the data corresponding to “1023” in the decimal notation is sequentially stored in the 10-bit data input of the memory cell 705 of the 255^{th} class among the 0^{th} to 255^{th} classes in the first LUT unit 701.

(Address Timing 2)

At the memory address timing 2 of the line address L0, “1” is output as the data P and “0” is output as the data S. This corresponds to the address timings 4 and 5 corresponding to the pixels of the line address L0.

Accordingly, at this timing, the addition/subtraction circuit 713 at the 255^{th} class in the correction data reproducing unit 710 subtracts the second input data from the first input data. From the first input, the correction value “1023” at the timing two pixel clocks before, i.e., 1 memory address timing before is input. From the second input, the value “1” of the data P is input. The output from the addition/subtraction circuit 713 at the 255^{th} class in the correction data reproducing unit 710 is 1022 (1023−1=1022), which value is stored in the memory cell 705 of the 255^{th} class in the first LUT unit 701.

(Address Timings 3 to 4)

Next, up to memory address timings 3 and 4 of the line address L0, no addition or subtraction is performed in the addition/subtraction circuit 713, and the output of the addition/subtraction circuit 713 of the 255^{th} class in the correction data reproducing unit 710 remains 1022, which value is sequentially written to the memory cell 705 of the 255^{th} class in the first LUT unit 702.

(Up to Address Timings 511)

Thereafter, in the fifth embodiment, up to the memory address 511 of the line address L0, i.e., the pixel address timing 1023, “1” is output as the data P and “0” is output as the data S alternately once for 2 data timings and 3 data timings as memory address timings, the addition/subtraction circuit 713 of the 255^{th} class in the correction data reproducing unit 710 subtracts 1 from the data output value one memory address before. This value is sequentially stored in the memory cell 705 of the 255^{th} class in the first LUT unit 702. At the same time, the same correction data is reproduced from the line addresses L1 to L767

(Data Reproduction of 0^{th} to 255^{th} Class)

As can be seen, the differential value between the correction initial value data on each of the scan lines of 256 classes written to the 256 memory cells 707 of the 0^{th} to the 255^{th} classes in the second LUT unit 706 and gradation correction values between the memory address data is reproduced as color difference correction values for the respective pixels by the 256 addition/subtraction circuits 713 of the 0^{th} to 255^{th} classes. The gradation correction values are sequentially written to the 256 memory cells 705 corresponding to 0^{th} to 255^{th} classes in the first LUT unit 702 for every two pixel clock timings corresponding to the read data unit of each memory cell 707.

In this case, a timing of the memory address 0 read from the memory cell 707 is a timing corresponding to two pixel display addresses in sequential 1-data addresses to correspond to the display pixel addresses 0 and 1, respectively.

(Gradation Correction in First LUT Unit)

In the first LUT unit 702, the 8-bit red image signal Di-R is input to and decoded by the address decoder 703 shown in FIG. 3.

(Correction at Address 0)

If input values of the 8-bit red image input signal Di-R input to each memory cell 707 of the second LUT unit 706 at the memory address timing 0 as the first pixel in the display unit at the line address L0 are, for example, 1, 1, 1, 1, 1, 1, 1, 1 (MSB:LSB) of 8 bits, then the decoded value decoded by the address decoder 703 is “255”, the output signal from the port S255 of the address decoder 703 is active, and output enable of the memory cell 705 of the 255^{th} class in the first LUT unit 702 is active. From this memory cell 705 of the 255^{th} class, 10-bit output correction values “1, 1, 1, 1, 1, 1, 1, 1, 1, 1” (MSB:LSB) from the addition/subtraction circuit 713 are supplied to the DA converter 10 in rear of the circuit 713 shown in FIG. 1 through the image signal output terminal 716 as a parallel red image output signal Do-R.

10-bit digital outputs of each of the 255 memory cells 705 in the first LUT unit 702 are connected in parallel in binary values to constitute the 10-bit data bus. However, only one memory cell 705 selected by the address decoder 703 is active among the 255 memory cells 705.

Subsequent to the timings of the display pixel addresses 0 and 1 of the line address L0 in the display unit stated above, the red signal is input for every pixel clock unit through the image signal input unit 701 continuously until timings of the display pixel addresses 2 to 1023 of the line address L0.

The input values of the 8-bit red image signal Di-R are continuous signals of 1, 1, 1, 1, 1, 1, 1, 1 (MSB:LSB) in the binary notation, assuming that the signals are input at 100% white according to the fifth embodiment. In the first LUT unit 702, the memory cell 705 of the 255^{th} class is always active during these values are input.

As stated, the table value of the memory cell 705 of the 255^{th} class in the first LUT unit 702 is rewritten for every two pixels. At the timings of the pixel addresses 0 and 1 of the line address L0, the signal output from the first LUT unit 702 is “1023”, which is the table value of the memory cell 705, corresponding to the input signal level of the first LUT unit 702.

Thereafter, the table value of this memory cell 705 is reduced by two for every 10 pixel addresses, i.e., by one alternately for every 2 memory addresses and every 3 memory addresses. At the pixel addresses 1022 and 1023, i.e., the memory address 512, the table value is reduced down to about “819”.

Accordingly, the output of this memory cell 705, that is, input decimal value of “1023” is reduced from “1023” to “819” for every two pixel clock periods. This value is supplied to the DA converter 10 in rear of the gradation correction unit 7 as the red output image signal Do-R of the first LUT unit 702 through the image signal output terminal 716.

Likewise, the red output image signal Do-R of the first LUT unit 702 from the line addresses L1 to L767 is the same value as that output from the line address L0 according to this fifth embodiment. As a result, the color balance is kept between right and left.

As can be seen, for the color difference according to the fifth embodiment that a red component of the image is greater from left to right on the screen and that the red component is increased by 20% on the right end of the screen, the horizontal color difference on the display screen of this display apparatus is corrected by the output values of the red image signal Do-R having a linearly and gradual change with an attenuation of 20% on the right end of the screen relative to the left end thereof and output from the first LUT unit 702.

(Correction at Classes Equal to or Lower than Input Level 254)

Likewise, at the input level “254”, the 10-bit data of the memory cell 705 of the 254^{th} class in the first LUT unit 702 is output as the red image output signal Do-R of the first LUT unit 702 of the gradation correction unit 7. At each of the input levels “253” to “0”, the 10-bit data of each of the corresponding memory cells 705 of the 253^{rd} to the 0^{th} classes of the first LUT unit 702 is output, thereby correcting the color difference in the display image.

(Correction in Red, Green, and Blue)

In the above-stated embodiment, the red color difference is reduced by correcting the gradation correction characteristic of the red image signal for every pixel unit. By correcting the gradation correction characteristics of all the red, green, and blue image signals by the gradation correction units 7, 8, and 9 shown in FIG. 1 for every pixel or pixels, respectively, the color difference in the display image can be corrected at high accuracy at all gradations of all colors corresponding to logic levels of the input images.

As stated so far, according to the fifth embodiment, color correction data in the horizontal direction is stored as the differential value data between the correction values of the target pixel and the pixel adjacent thereto and two pixels before the target pixel of each memory cell 707 in the second LUT unit 706 for every two pixels. The correction data reproducing unit 710 reproduces the correction value data synchronously with the display pixel address, and supplies the color difference correction value to the first LUT unit 702 for every two pixels. The table value of the target class of the first LUT unit 702 is rewritten for every two pixel display periods, the table value corresponding to the input image signal is output as the output image signal to display an image. By so configuring, as compared with the preceding first embodiment, the memory capacity value required in the second LUT unit 706 can be reduced substantially by half. Therefore, it is possible to further reduce the cost and make the apparatus small in size.

(Data Unit of 3 Pixels or More)

Further, the color difference correction data in the horizontal direction is stored as one typical data for every two pixel periods in the second LUT unit 706 in advance and reproduced as correction data for every two pixel display periods during display of the data. Alternatively, the correction data is stored in the second LUT unit 706 as one typical data for every plural pixels of three pixel periods or more, and reproduced for every plural pixels stored in the second LUT unit 706 during display of the data, and the color difference is corrected. It is thereby possible to further reduce the memory capacity required in the second LUT unit 706.

### SIXTH EMBODIMENT

(Difference Correction for Every Plurality of Lines)

In the fifth embodiment, the color difference correction in the horizontal direction of the display image is stored in the second LUT unit 706 for every plural pixels. At the time of displaying the image, the correction data common to the plural pixels is reproduced by the correction data reproducing unit 710 for every plural pixels, the reproduced correction data is supplied to the second LUT unit 706, and the color difference in the input image signal is corrected. By contrast, an embodiment in which a common correction value to a plurality of lines is stored, the correction data for every plural lines is similarly reproduced at plural lines at the time of displaying the image, the reproduced correction data is supplied to the second LUT unit 706, and the color difference in the input image signal is corrected will now be described in detail.

(Recording of Correction Data)

Similarly to the first embodiment, when a white signal is input, the display characteristic of the display screen is such that white balance is kept in an upper portion in the vertical direction. As the portion of the screen is lower, red is emphasized proportionally to the screen position and red is emphasized by 20% on the lower end of the screen. In this case, if the color difference correction characteristic needs to linearly attenuate the red by 20% from the first scan line to the final line or 768^{th} line, then the initial value data represented by the L0PJ to L0PA on the first line is “1023” in the decimal notation, that on the second to third line is also 1023” in the decimal notation, and that on the fourth line is “1022” in the decimal notation. The initial value data on the eighth line is equal to or greater than “1021”. Thus, the initial value data is attenuated proportionally, so that the initial value data on the 768^{th} line is “819”.

According to the sixth embodiment, if such correction data is stored in the second LUT unit 706 in advance, memory addresses corresponding to one class, e.g., the 255^{th} class in the second LUT unit 706 are configured as shown in FIG. 16.

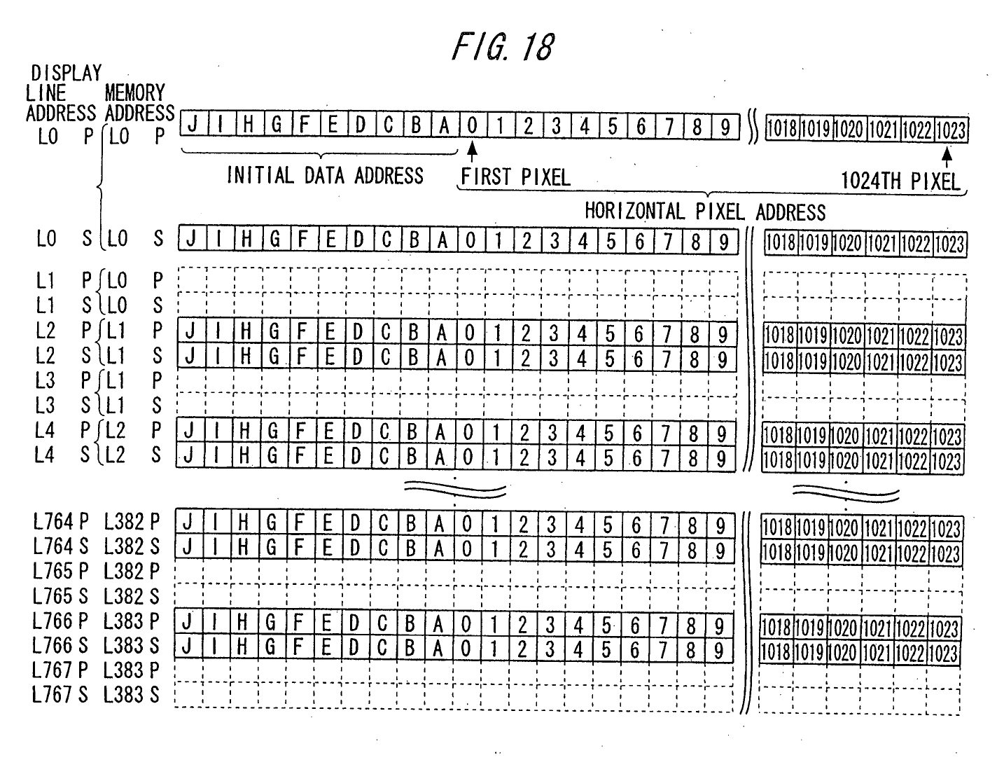

In the memory addresses of the second LUT unit 706 shown in FIG. 18, initial value data common to the first and the second lines corresponding to the display addresses is stored by 10 bits in addresses L0PJ to L0PA. The initial value data in this case, “1023” in the decimal notation or “1, 1, 1, 1, 1, 1, 1, 1, 1, 1” in the binary notation according to this sixth embodiment.

Next, correction data as the differential values corresponding to the respective pixels from the first to the 1024^{th} pixels is stored in addresses L0P0 to L0P1023 and L0S0 to L0S1023 with the initial value data common to the first and the second lines.

The initial value data common to the third and the fourth lines is stored by 10 bits as “1023” in addresses L1PJ to L1PA, similarly to the above.

Next, correction data as the differential values corresponding to the respective pixels from the first to the 1024^{th} pixels is stored in addresses LLP0 to L1P1023 and LLS0 to L1S1023 with the initial value data common to the third and the fourth lines.

The initial value data common to the fifth and the sixth lines is stored by 10 bits as “1022” in addresses L2PJ to L2PA, similarly to the above.

Next, correction data as the differential values corresponding to the respective pixels from the first to the 1024^{th} pixels is stored in addresses L2P0 to L2P1023 and L2S0 to L2S1023 with the initial value data common to the fifth and the sixth lines.

Likewise, the initial value data and the correction data as the differential values corresponding to the respective pixels of the first to the 1024^{th} pixels are stored for every two lines. In the sixth embodiment, the initial value data on the final line is attenuated by about 20% to about “819”. Similarly to the 0^{th} to the 254^{th} classes, the memory addresses are configured in the second LUT unit 706 and data is stored.

As stated so far, in the memory addresses shown in FIG. 18, an area indicated by a solid line is an area for storing data and an area indicated by a broken line is an area unnecessary to store in this sixth embodiment. As compared with the first embodiment, the memory capacity value required in the second LUT unit 706 can be reduced substantially by half, so that further cost reduction and scale-down can be realized.

(In Case of Display)

In case of displaying an image signal, as the correction data stored in the second LUT unit 706, the initial value data stored in the addresses L0PJ to L0PA of the corresponding memory cell 707 in the second LUT unit 706 stated above is read for the first line of the image display screen (not shown). Thereafter, the data stored in the addresses L0P0 to L0P1023 and L0S0 to L0S1023 from the first to the 1024^{th} pixels is sequentially reproduced as correction data in the correction data reproducing unit 710 as described in the first embodiment, the reproduced correction data is supplied to the first LUT unit 702, and the table value of the first LUT unit 702 is rewritten.

In the first LUT unit 702, the red input image signal Di-R is converted into the red output image signal Do-R in which the color difference is corrected based on the above-stated input correction table value. The red output image signal Do-R is output to the DA converter shown in FIG. 1 through the image signal output terminal 716, and the image is displayed.

On the second line of the image display screen, similarly to the first line, the initial value data stored in the addresses L0PJ to L0PA of the corresponding memory cell 707 in the second LUT unit 706 and the data stored in the addresses L0P0 to L0P1023 and L0S0 to L0S1023 are reproduced, and the table value of the first LUT unit 702 is rewritten. In the first LUT unit 702, the red input image signal Di-R is converted into the red output image signal Do-R in which the color difference is corrected based on the above-stated input correction table value. The red output image signal Do-R is output to the DA converter shown in FIG. 1 through the image signal output terminal 716, and the image is displayed.

On the third and the fourth lines of the image display screen, similarly to the first and the second lines, the initial value data stored in the addresses L1PJ to L1PA of the corresponding memory cell 707 in the second LUT unit 706 is read at the timing common to the third and the fourth lines. Thereafter, in the correction data reproducing unit 710, the correction data stored in the addresses LLP0 to L1P1023 and L1S0 to L1S1023 is sequentially reproduced, and supplied to the first LUT unit 702. In the first LUT unit 702, the red input image signal Di-R is converted into the red output image signal Do-R in which the color difference is corrected based on the above-stated input correction table value. The red output image signal Do-R is output to the DA converter shown in FIG. 1 through the image signal output terminal 716, and the image is displayed.

On the fifth and the sixth lines of the image display screen, the 10-bit initial value data stored in the addresses L2PJ to L2PA of the corresponding memory cell 707 in the second LUT unit 706 is read. The correction data stored in the addresses L2P0 to L2P1023 and L2S0 to L2S1023 is sequentially reproduced and supplied to the first LUT unit 702. In the first LUT unit 702, the red input image signal Di-R is converted into the red output image signal Do-R in which the color difference is corrected based on the input correction table value. The red output image signal Do-R is output to the DA converter shown in FIG. 1 through the image signal output terminal 716, and the image is displayed.

The initial value of the addresses L2PJ to L2PA is “1022” in the decimal notation. The value “1022” is output through the image signal output unit 716 to the DA converter with respect to the value “255” of the input image signal Di-R in the first LUT unit 702 for the first pixel on each of the two scan lines.

Thereafter, up to the final line, the initial value data is attenuated for every two scan lines. The initial value data on the final line is almost “819” in the decimal notation as described in relation to the recording of correction data in the second LUT unit 706.

As can be seen, the initial value data indicated by the data P and the pixel correction data indicated by the data P and S subsequent to the data P are read for every two scan lines. The correction data reproducing unit 710 reproduces the correction value data and the reproduced correction data is sequentially supplied to the first LUT unit 702. The table value of the first LUT unit 702 is thereby rewritten. The output image signal Do-R in which the color difference is corrected and which corresponds to the input image signal DI-R input to the first LUT unit 702 is output to the DA converter in rear of the gradation correction unit shown in FIG. 1 through the image signal output terminal 716 by the table value of the first LUT unit 702. The image in which the color difference is corrected in the vertical direction is displayed.

(Correction at 0^{th} to 254^{th} Classes)

Through the above-stated operation, the color difference in the vertical direction for the 255^{th} class of the input image signal can be corrected. Further, similarly to the first embodiment, the initial value and the pixel correction data for every two lines are reproduced from the memory addresses of the memory cells 707 corresponding to the 254^{th} to the 0^{th} classes in the second LUT unit 706, and the table values of the memory cells 705 corresponding to the 254^{th} to the 0^{th} classes in the first LUT unit 702 are rewritten, respectively synchronously with the pixel display addresses of the display. As a result, the first LUT unit 702 executes the 10-bit gradation correction to each of the 0^{th} to the 255^{th} classes of the red input image signal Di-R. The output image signal Do-R in which the color difference is corrected is output to the DA converter in rear of the gradation correction unit shown in FIG. 1 through the image signal output terminal 716. Therefore, the image in which the color difference is corrected in the vertical direction can be displayed at all gradations from the 0^{th} gradation corresponding to input of the image to the 255^{th} gradation.

The color difference correction by the above-stated processings has been described, taking the processings of the red signal processing circuit as an example. Likewise, for blue and green signals, the color difference and the luminance difference can be corrected by performing the same processings as those for the red signal while maintaining and correcting the continuous gradations intrinsic to the display pixels of the respective blue and green signals. According to the sixth embodiment, it suffices to store the correction value for every two lines. As compared with the color difference correction in the vertical direction according to the first embodiment, the data amount can be halved.

In this embodiment, the correction data for every two lines is stored in the second LUT unit 706 so as to reduce the memory capacity. Alternatively, if the correction data for every plural lines exceeding two lines is stored in the second LUT unit 706, the correction data is continuously reproduced for every plural lines during display of the image on the display unit, and the reproduced correction data is supplied to the first LUT unit 702, it is possible to further reduce the memory capacity of the second LUT unit 706.

### SEVENTH EMBODIMENT

(Correction for Every Plural Lines and Every Plural Pixels)

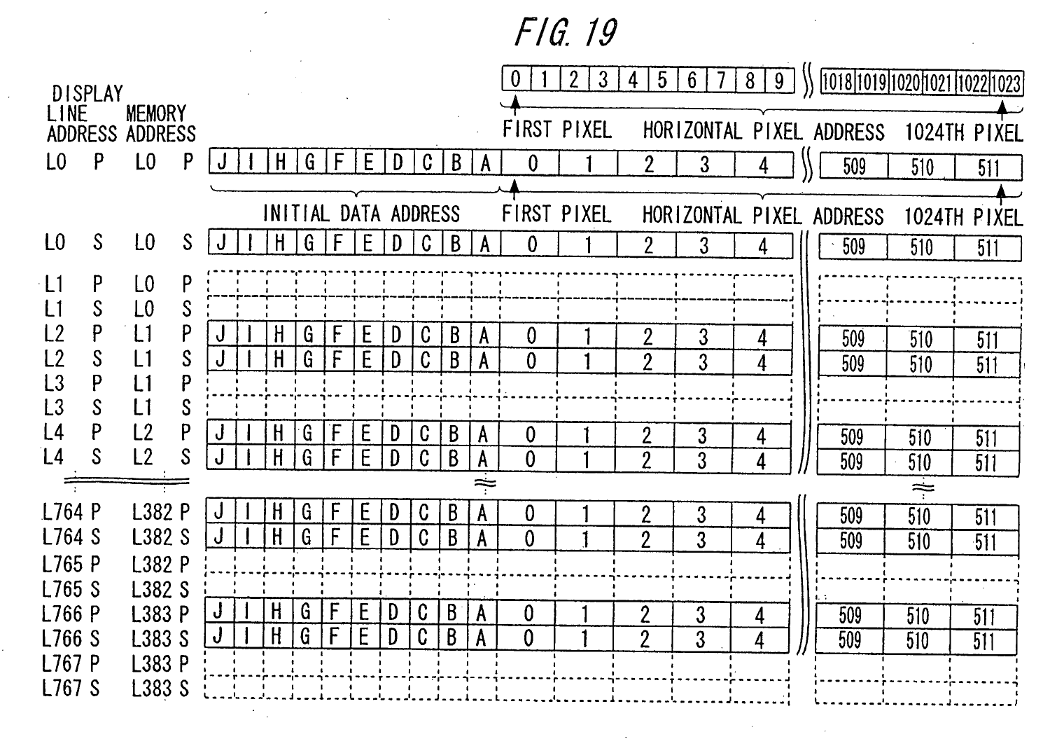

A seventh embodiment of the present invention will be described. In the fifth and the sixth embodiments, the correction data common to every two pixels and that common to every two lines are stored in the second LUT unit 706, respectively. By doing so, as compared with the first embodiment, the storage capacity of this second LUT unit 706 is reduced to a quarter and, therefore, the practical luminance and color differences including the gradations can be corrected for all the gradations. FIG. 19 depicts an example of the data configuration of a memory cell corresponding to one class.

In the vertical direction, memory areas for every other scan line indicated by broken lines are unnecessary. In the horizontal direction, a memory area by as much as one data for two pixels is unnecessary.

Furthermore, if the correction processings are performed for every n pixels and every m lines, respectively, the difference can be corrected by a data amount that is substantially an inverse multiple of a product between n and m. Namely, if n is 3 and m is 3, the correction can be made generally with the memory-capacity a one-ninth as large as that according to the first embodiment.

### EIGHTH EMBODIMENT

An eighth embodiment of the present invention will be described. In the preceding embodiment, the correction data is stored for every plural lines in the second LUT unit 706. This correction data is constituted by the initial values in the horizontal direction of a plurality of lines, and the differential data, subsequent to the initial values, between the difference correction values of the pixels or among the difference correction values of a plurality of pixels with respect to the correction value of color difference of each pixels in horizontal direction subsequent to the initial value. By contrast, if the horizontal difference correction data for every plural scan lines is constituted by the initial values of the lines and the difference correction data, subsequent to the initial values, obtained by coding values indicated by the number of pixels changed by as much as a predetermined value in the horizontal direction in advance or values indicated by time for every plural pixels. E.g., run-length coded, the memory capacity of the second LUT unit 702 can be further reduced.

### NINTH EMBODIMENT

In the embodiments stated above, as the storage addresses of the memory cells in the second LUT unit 706, storage addresses shared between the horizontal and the vertical directions to correspond to the image are used. By doing so, the storage capacity of the second LUT unit 706 is reduced. According to a ninth embodiment, memory cells are shared for every plural classes, as compared with the memory cells 707 of the 0^{th} to the 255^{th} classes in the second LUT unit 706 according to the first embodiment.

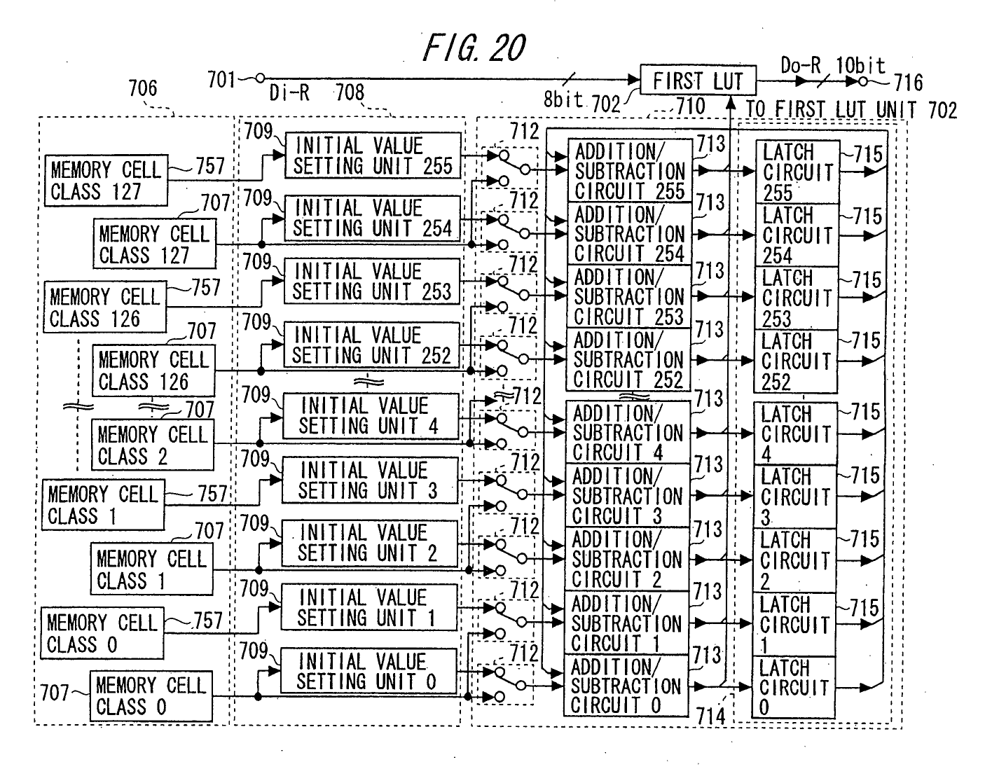

A configuration and an operation of the image display apparatus according to the ninth embodiment will be described. FIG. 20 is a circuit block diagram of the second LUT unit 706, the initial value generating unit 708, and a part of the correction data reproducing unit 710 according to the ninth embodiment.

As shown in FIG. 20, the second LUT unit 706, the initial value generating unit 708, and a part of the correction data reproducing unit 710 according to the ninth embodiment are equal to those shown in the circuit block diagram according to the first embodiment shown in FIG. 3 except for a few respects. The second LUT unit 706, the initial value generating unit 708, and the correction data reproducing unit 710 will not be described herein.

Namely, the image signal input unit 701 for inputting the red signal converted into a digital signal according to the ninth embodiment, the first LUT unit 702, the address decoder 703, the first memory table unit 704, and the 256 memory cells 705 of the 0^{th} to the 255^{th} classes constituting the first memory table unit 704 are not shown in FIG. 20. The gradation correction unit 7 includes the second LUT unit 706 for storing the color difference data and gradation correction data on the display image in advance, 128 memory cells 707 of the 0^{th} to the 127^{th} classes constituting half the second LUT unit 706, and 128 memory cells 717 of the 0^{th} to the 127^{th} classes constituting half the second LUT unit 706.

The initial value generating unit 708 includes 256 initial value setting units 709. The initial value generating unit 708 also includes the correction data reproducing unit 710, 256 switching circuits 712 of the 0^{th} to the 255^{th} classes, the 25.6 addition/subtraction circuits 713 of the 0^{th} to the 255^{th} classes, the latch unit 714 including 256 latch circuits 715 of the 0^{th} to the 255^{th} classes, and the image signal output terminal 716 for the red signal.

In the above-stated circuit block diagram, the second LUT unit 706 includes 128 memory cells 707 according to the first embodiment, which is a half of 256. One memory cell 707 constitutes the addresses shown in FIG. 5. The second LUT unit 706 also includes 128 memory cells 717.

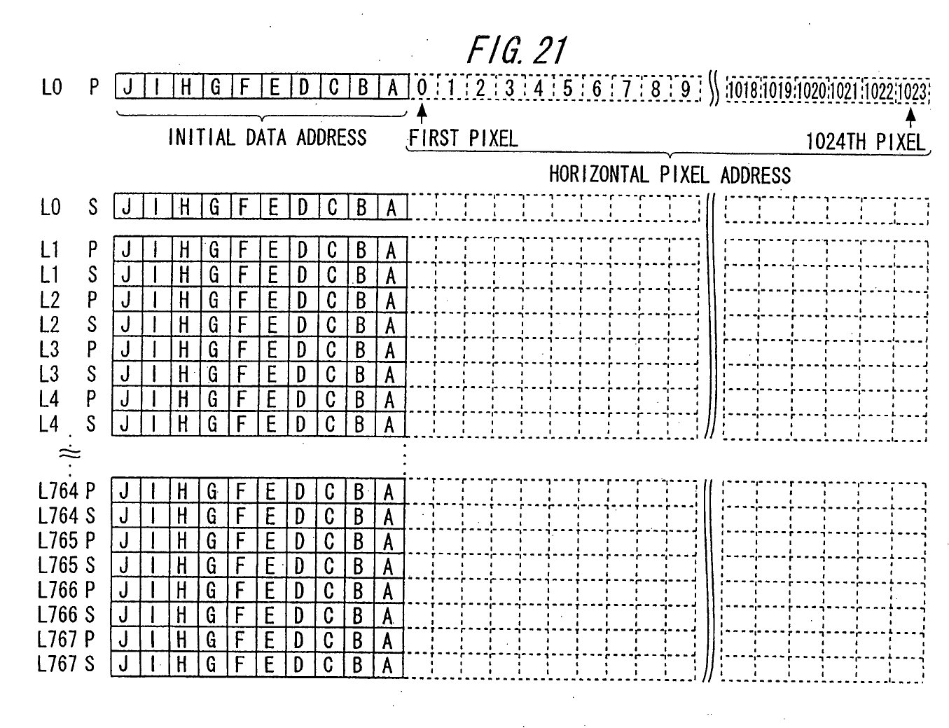

FIG. 21 depicts an address configuration of one memory cell 717. As shown in FIG. 21, one memory cell 717 includes line addresses L0 to L767. In addition, similarly to the address configuration shown in FIG. 5 according to the first embodiment, the memory cell 717 includes initial value data addresses J to A of 10 bits.

Differently from the first embodiment, however, with the address configuration of the memory cell 717 according to the ninth embodiment, horizontal pixel addresses 0 to 1023 are not provided. The second LUT unit 706 is configured so that the 128 memory cells 707 and the 128 memory cells 717 alternately correspond to the 0^{th} to the 255^{th} classes. This configuration will now be described.

At the 0^{th} class, the data in the memory cell 707 at the 0^{th} class is supplied to the initial value setting unit 709 of the 0^{th} class in the initial value generating unit 780. At the same time, the data is supplied to the second input of the switching circuit 712 of the 0^{th} class in the correction data reproducing unit 710, and to the second input of the switching circuit 712 of the first class in the correction data reproducing unit 710.

At the first class, the data in the memory cell 717 of the 0^{th} class is supplied to the initial value setting unit 709 of the first class in the initial value generating unit 708.

At the second class, the data in the memory cell 707 at the first class is supplied to the initial value setting unit 709 of the second class in the initial value generating unit 780. At the same time, the data is supplied to the second input of the switching circuit 712 of the second class in the correction data reproducing unit 710, and to the second input of the switching circuit 712 of the third class in the correction data reproducing unit 710.

At the third class, the data in the memory cell 717 of the first class is supplied to the initial value setting unit 709 of the third class in the initial value generating unit 708.

At the fourth class, the data in the memory cell 707 at the second class is supplied to the initial value setting unit 709 of the fourth class in the initial value generating unit 780. At the same time, the data is supplied to the second input of the switching circuit 712 of the fourth class in the correction data reproducing unit 710, and to the second input of the switching circuit 712 of the fifth class in the correction data reproducing unit 710.

At the fifth class, the data in the memory cell 717 of the second class is supplied to the initial value setting unit 709 of the fifth class in the initial value generating unit 708.

Likewise, at each of sixth and the following gradations, the data in the memory cell 707 of each class and the data in the memory cell 717 at each class are alternately supplied to a predetermined class corresponding to each initial value generating unit 708. At the 254^{th} class, the data in the memory cell 707 at the 127^{th} class is supplied to the initial value setting unit 709 of the 254^{th} class in the initial value generating unit 780.

At the same time, the data is supplied to the second input of the switching circuit 712 of the 254^{th} class in the correction data reproducing unit 710, and to the second input of the switching circuit 712 of the 255^{th} class in the correction data reproducing unit 710. At the 255^{th} class, the data in the memory cell 717 of the 127^{th} class is supplied to the initial value setting unit 709 of the 255^{th} class in the initial value generating unit 708.

With the connection configuration shown in FIG. 20 as stated above, as display addresses of the display unit, 10 addresses J to A on the initial value addresses L0PJ to L0PA of the memory cell 707 shown in FIG. 5 are fetched into the initial value setting unit 709 of each class connected to the initial value generating unit 708 shown in FIG. 20 at a display pixel clock rate first for a blanking period before display of the scan line L0 at display timings of sequentially displaying the scan lines L0 to L767. At the display address A, the data is supplied to the first input of the switching circuit 712 of each class in the correction data reproducing unit 710 in rear of the initial value generating unit 708 as parallel data, similarly to the first embodiment.

At the same time, 10 addresses J to A on the initial value addresses L0PJ to L0PA of the memory cell 717 shown in FIG. 21 are fetched into the initial value setting unit 709 of each class connected to the initial value generating unit 708 shown in FIG. 20 at the display pixel clock rate first. At the display address A, the data is supplied to the first input of the switching circuit 712 of each class in the correction data reproducing unit 710 in rear of the initial value generating unit 708 as parallel data, similarly to the first embodiment.

All the switching circuits 712 at the 255 classes corresponding to the 255 classes in all for the memory cells 707 and 717 select the first inputs at the display address A, and the selected data is supplied to the second inputs of the addition/subtraction circuits 713 corresponding to all the classes in rear of the switching circuits 712, respectively.

Accordingly, at the timing of this display address A, initial values intrinsic to the respective addition/subtraction circuits 713 of the 0^{th} to the 255^{th} classes are supplied to the second inputs of the circuits 713.

At the timing of this display address A, the outputs of the addition/subtraction circuits 713 of the 0^{th} to the 255^{th} classes are “0” since the latch circuits 715 of the 0^{th} to the 255^{th} classes, not shown in FIG. 20 but shown in FIG. 3, connected to the first inputs of the respective addition/subtraction circuits 713 serving as operation units of the 0^{th} to the 255^{th} classes are just reset. Each addition/subtraction circuit 713 outputs the initial value and supplies the initial value to the data input terminal of each of the latch circuits 715 of the 0^{th} to the 255^{th} classes shown in FIG. 20 and similar to that shown in FIG. 3 and to the memory cell 705 of each of the 0^{th} to the 255^{th} classes in the first LUT unit 702 shown in FIG. 20 and similar to that shown in FIG. 3.

The data value generated at this timing and supplied to the memory cell 705 of each of the 0^{th} to the 255^{th} classes in the first LUT unit 702 has a smooth gradation correction characteristic at accuracy of 10 bits shown in a data ranges of 0 to 1023 so as to correspond to the 256 input gradations of the 0^{th} to the 255^{th} gradations.

Next, at the display address 0, the switching circuits 712 of the classes in the correction data reproducing unit 710 are all changed to select the second inputs, respectively, at a timing next to the initial value address A.

Next, 2-bit data is read from the L0P0 and L0S0 of the data address 0 of the line address 0 shown in FIG. 5 of the memory cell 707 of each of the 0^{th} to the 127^{th} classes in the second LUT unit 706.

At this display address 0, similarly to the first embodiment, the data at the L0P0 is the absolute value of the change in the correction data. The data on the L0S0 is data for designating either addition or subtraction to be performed by the addition/subtraction unit 713. The data on the L0P0 is supplied to the second input of the addition/subtraction circuit 713 of each of the 0^{th} to the 255^{th} classes through the second input of the switching circuit 712 of each of the 0^{th} to the 255^{th} classes.

As shown in the connection configuration shown in the circuit block diagram of FIG. 20, the 128 memory cells 707 at the 0^{th} to the 127^{th} classes are selected and connected to every other class of the 256 addition/subtraction circuits 713 corresponding to the 0^{th} to the 255^{th} classes, that is, in the ninth embodiment, to even-numbered classes of the 0^{th}, the second, the fourth classes and the like, and data is supplied thereto. Further, as shown in the connection configuration shown in the circuit block diagram of FIG. 20, the same data in the 128 memory cells 707 corresponding to the 0^{th} to the 127^{th} classes is supplied to the odd-numbered classes of the remaining first, third, fifth, and the like of the 256 addition/subtraction circuit 713 corresponding to the 0^{th} to the 255^{th} classes, respectively.

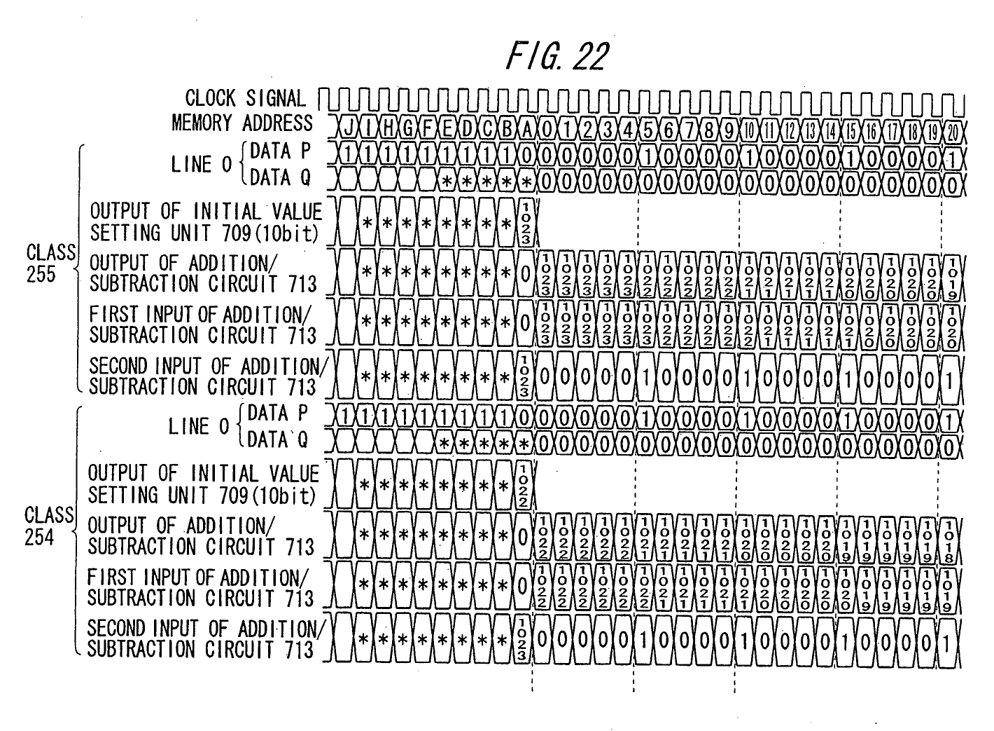

That is, the same data value is supplied to the second inputs of the addition/subtraction circuits 713 corresponding to each pair of the 0^{th} and first classes, the second and third classes, the fourth and fifth classes, . . . , and the 254^{th} to 255^{th} classes FIG. 22 is a timing chart for describing input and output values of the addition/subtraction circuits 713 at the 255^{th} and the 254^{th} classes, respectively and operations thereof. In FIG. 22, a clock signal coincident with the pixel display timing and memory addresses J to A and 0 to 20 of timings corresponding to the line L1 of the memory cell 707 are shown.

Further, the read values of the data P and the data S at the 255^{th} and the 254^{th} classes, the output value (in the decimal notation) of the initial value control circuit, and data values (in the decimal notation) of the first input, the second input, and the output of the addition/subtraction circuit are expressed for every clock to correspond to the memory addresses J to A and 0 to 20. The memory addresses on each line of the memory cell 707 continues up to 1023. FIG. 21 does not depict the memory address 1023 part.

In FIG. 22, the data is sequentially read from J to A of the memory address L0P of the 127^{th} class of the memory cell 717 for every clock, and the data is sequentially read from J to A of the memory address L0P of the 127^{th} class of the memory cell 707.

For the serial data thus read for each 10 clock period, parallel data is output as initial values in the initial value setting unit 709 of the 255^{th} class and that of the 254^{th} class similarly to the first embodiment, though not shown in FIG. 22.

At the timing A shown in FIG. 22, “1023” and “1022” are supplied from the initial value setting unit 709 of the 255^{th} class and that of the 254^{th} class to the second inputs of the switching circuits of the 255^{th} and the 254^{th} classes to be selected by the respective switching circuits, and supplied to the second inputs of the addition/subtraction circuits 713 of the 255^{th} and the 254^{th} classes, respectively. At the timing A, the first input value of the addition/subtraction circuit 713 is “0” as described, and the second input values thereof are input to the latch circuits of the 255^{th} and the 254^{th} classes, respectively, and held until the next clock timing.

As shown in FIG. 22, at the read timing 0 of the addresses L0P0 and L0S0 of the memory cell 707, the switching circuits 713 of the 255^{th} and the 254^{th} classes are changed, the P data in the memory cell 707 of the 127^{th} class is connected to the second inputs of the addition/subtraction circuits 713 of the 255^{th} and the 254^{th} classes at predetermined timing, respectively. In addition, the S data in the memory cell 707 of the 127^{th} class is supplied to the addition/subtraction control terminal of the addition/subtraction circuits 713 at the 255^{th} and the 254^{th} classes, respectively in parallel without processing it.

At the same time, the initial value at the 255^{th} class and that at the 254^{th} class at the timing A held in the latch circuits of the 255^{th} and the 254^{th} classes, respectively are input to the first inputs of the addition/subtraction circuits 713 of the 255^{th} and the 254^{th} classes and output from the addition/subtraction circuits 713 of the 255^{th} and the 254^{th} classes. These values are “1023” and “1022”, respectively as shown in FIG. 21.

Likewise, at the addresses 1 to 4 of the memory cell 707, the P data and the S data are both “0” and have no change. As shown in FIG. 21, the values output from the addition/subtraction circuits 713 of the 255^{th} and the 254^{th} classes are “1023” and “1022”, respectively.

Next, at the address 5 of the memory cell 707, the P data is “1” and the S data is “0”. The P data “1” and the S data “0” designate the values “1023” and “1022” held in the latch circuits of the 255^{th} and the 254^{th} classes to be subjected to reduction, so that “1022” and “1021” are output from the addition/subtraction circuits 713 of the 255^{th} and the 254^{th} classes, respectively. The output values are held in the latch circuits 715 of the 255^{th} and the 254^{th} classes in rear of the respective addition/subtraction circuits 713 and supplied to the memory cells 705 of the 255^{th} and the 254^{th} classes in the first LUT unit 702, not shown.

Likewise, as shown in FIG. 22, according to this ninth embodiment, the addition/subtraction circuits 713 of the 255^{th} and the 254^{th} classes outputs values each reduced by “1” for every five pixel clocks such as at the addresses 5, 10, and 15 of the memory cells 707, the values are held by the latch circuits of the 255^{th} and the 254^{th} classes for one clock period, and then supplied to the memory cells 705 of the 255^{th} and the 254^{th} classes in the first LUT unit 702, respectively.

From the 253^{rd} to the 0^{th} classes, similarly to the above, data at the 126^{th} to the 0^{th} classes of the memory cells 707 of the 253^{rd} to the 0^{th} classes are reproduced by the data P and S for every two classes and the reproduced data is supplied to the memory cells 705 of the 253^{rd} to the 0^{th} classes in the first LUT unit 702.

As can be seen, the correction value data is stored in the second LUT unit 706 such that the initial values are stored for every class and the inter-pixel correction values are stored for every two classes, the correction data is reproduced at the time of displaying the image, the reproduced data is supplied to the first LUT unit 702, and the difference correction in the pixel display addresses 0 to 1023 is corrected.

The line address 0 has been described so far. Subsequently, similarly to the above, the initial values of the respective lines up to the line address 767 are reproduced, the difference correction is executed to the same classes using the difference correction values at the pixel addresses 1 to 1024 by as much as the number of horizontal pixels.

If the correction stated above is executed to the image signals of blue and green besides the red signal in the similar manner, the difference correction can be executed for all the colors of the input image. Due to this, the optimum correction of the unevenness of brightness and optimum color difference correction can be realized for every plural pixels while executing the optimum gradation correction. Thanks to this, as compared with the first embodiment, the memory capacity necessary in the second LUT unit 706 can be reduced by half, so that cost reduction and scale-down of the circuit can be realized.

(For Every Plurality of Classes)

Moreover, with the structure of the memory cells of the 0^{th} to the 255^{th} classes in the second LUT unit 706 corresponding to the 256 gradations, respectively, the memory cells 707 each consisting of an initial value data area and an inter-pixel correction data area and the memory cells 717 each consisting only of an initial value data area are configured for every other gradation, the intrinsic values to the respective classes are stored as the initial values, the data common to two classes is stored as the inter-pixel correction values, and the difference correction is executed. As stated above, the memory cells 717 are configured for every plural classes equal to or greater than two classes relative to the memory cells 707 configured for every class, the intrinsic values to the respective classes are stored as the initial values, and the data common to every plural classes equal to or greater than three classes is stored as the inter-pixel correction value. It is thereby possible to further reduce the memory capacity required in the second LUT unit.

### TENTH EMBODIMENT

(Correction for Every Plural Classes, Every Plural Lines, and Every Plural Pixels)

In the first to the ninth embodiments stated above, the difference correction data is stored in the pixel display address area of the second LUT unit 706 for every plural classes so as to reduce the memory capacity of the second LUT unit 706. By contrast, the difference correction data is stored in the pixel display address area of this second LUT unit 706 to be common to a plurality of classes, and the correction data is shared between, for example, two pixels or between two lines and stored in the second LUT unit 706. It is thereby possible to further reduce the memory capacity required in the second LUT unit 706.

For example, by sharing the data at the pixel correction addresses in the second LUT unit 706 between, for example, two classes, two pixels, or two lines, the memory capacity necessary for the pixel correction addresses in the second LUT unit 706 can be reduced to a cube of 2 as compared with the memory capacity according to the first embodiment. The memory capacity can be, therefore, reduced to substantially one-eighth.

Moreover, by sharing the data at the pixel correction addresses in the second LUT unit 706 among, for example, three classes, three pixels, or three lines, the memory capacity necessary for the pixel correction addresses in the second LUT unit 706 can be reduced to a cube of 3 as compared with the memory capacity according to the first embodiment. The memory capacity can be, therefore, reduced to substantially one twenty-sevenths.

### ELEVENTH EMBODIMENT

(Storage of Correction Data by Run-Length Code for Every Plurality of Classes)

As already described in the second embodiment, a difference correction method, for the scan lines of, for example, 0 to 767, constituting the initial values of the lines and the difference correction data subsequent to this initial value data in the horizontal direction that constitute the difference correction data in the horizontal direction by data, e.g., run-length coded data, obtained by coding a value indicated by the number of pixels changed by a predetermined value in the horizontal direction or by the time for every plural pixels will be described. The initial values on the scan lines J to A on the difference correction data stored in the second LUT unit 706 are stored at initial value data addresses for all classes, e.g., the 0^{th} to the 255^{th} classes.

The difference correction data in the horizontal direction subsequent to the initial values on each scan line is stored as data common to a plurality of gradations at correction value data address, if the difference correction data is the data obtained by coding the value indicated by the number of pixels changed by the predetermined value in the horizontal direction or by the time for every plural pixels. During difference correction, the initial value is reproduced for ever plural gradations and the difference correction data for every scan line are reproduced in common for plural gradation unit, the difference is then corrected, whereby the memory capacity of the second LUT unit 706 can be reduced.

The embodiments of the present invention have been specifically described so far. However, the present invention is not limited to the embodiments but various changes and medications can be made to the invention based on the technical concept of the invention.

For example, the numeric values mentioned in the embodiments are given only for illustrative explanation and different values may be used if it is necessary.

According to the present invention, the color difference correction at least in each pixel of the input image signal can be executed at a smaller memory capacity and lower cost for all of the digital input signal gradations so as to correspond to all pixels in all display areas simultaneously with the gradation correction.

This application claims priority from Japanese Patent Application No. 2004-315604 filed Oct. 29, 2004 and Japanese Patent Application No. 2005-256773 filed Sep. 5, 2005, which are hereby incorporated by reference herein.

What is claimed is:

1. A correction apparatus of an image display apparatus for correcting an unevenness of brightness or color in a plurality of pixels in a display unit, comprising:
a correction circuit that corrects the unevenness of brightness or color by correcting an image input signal for the each gradation level of the image input signal using correction data for correcting the unevenness in a display surface of the display unit, the correction data being provided independently for each displayable gradation level,
wherein said correction circuit includes:
a first memory that has rewritable data for the each pixel and that holds the correction data;
a second memory that holds data on a differential value between initial correction data and the correction data between the pixels; wherein
an operation unit that reproduces the correction data on the pixel to be corrected by an operation processing based on the data on the differential value read from the second memory, and
the correction data of the first memory is rewritten by the operation unit.

2. A correction apparatus of an image display apparatus according to claim 1, wherein
the second memory holds the initial correction data and the data on the differential value between the pixels in a horizontal direction, for every horizontal scan line of the display unit, and rewrites the data of the first memory for the each pixel based on the initial correction data and the data on the differential value.

3. A correction apparatus of an image display apparatus according to claim 1, wherein
the second memory holds the initial correction data and data obtained by coding the number of pixels in a horizontal direction until the correction data on the pixels in the horizontal direction is changed to a predetermined value, for every horizontal scan line of the display unit, and rewrites the data of the first memory for the each pixel based on the initial correction data and the data on the differential value.

4. An image display apparatus for correcting an unevenness of brightness or color in a plurality of pixels in a display unit, comprising:
a correction circuit that corrects the unevenness of brightness or color in the pixels by correcting an image input signal using correction data for correcting the unevenness in the pixels of the display unit, wherein
said correction circuit includes:
a first memory that holds the correction data;
a second memory that holds compressed data obtained by compressing the correction data; and
an operation unit that performs a processing for sequentially extending the compressed data for every part of the compressed data based on the compressed data read from the second memory, to provide the correction data on a part of corresponding pixels to be corrected, wherein
the correction data held in the first memory is sequentially rewritten for the every part of the correction data by the operation unit.

5. An image display apparatus according to claim 4, wherein
the correction data corresponding to a plurality of gradation levels of at least correction target pixels is stored in the first memory at a time.

6. An image display apparatus comprising:
a first memory capable of rewriting gradation correction data at least for each display pixel clock;
a second memory that prestored correction value data on an unevenness of brightness in a display screen for every horizontal scan line as initial value data on each horizontal line for generating gradation correction data and differential compressed data including a code indicating an increase and a reduction of a correction value between the pixels in the horizontal direction for every class of a gradation correction value subsequent to the initial value data;
an initial value data reproducing unit that reads the correction data from the second memory for the every scan line;
an addition/subtraction unit that executes one of or both of an addition operation processing and a subtraction operation processing;
a correction data reproducing unit that includes a data holding unit holding the gradation correction data one pixel clock period before for one pixel clock in the addition/subtraction unit; and
a timing signal generating unit that generates a timing signal for controlling the first memory, the second memory, the initial value data reproducing unit, and the correction data reproducing unit at a predetermined timing,
wherein the initial value data reproducing unit reproduces the initial value data sequentially read from the second memory for the every scan line,
the correction data reproducing unit sequentially reproduces the differential compressed data on the correction values between the pixels in the horizontal direction for every class of the gradation correction value, the differential compressed data sequentially read from the second memory based on the reproduced initial value data, and
the image display apparatus further comprises a correction unit that rewrites a correction table value in the first memory as the gradation correction data intrinsic to each pixel for every pixel clock, that converts the image signal input to the first memory into a table value adaptable to a correction table of the first memory for every pixel clock, and that executes a correction.

7. An image display apparatus, comprising:
a first memory capable of rewriting gradation correction data at least for each display pixel clock;
a second memory that prestored horizontal line initial value data for generating gradation correction data for every horizontal scan line, data subsequent to the horizontal line initial value data and indicating whether a correction value between pixels in a horizontal direction at each class of a gradation correction value is increased or reduced by a predetermined value, and compressed code data on the number of pixels in the horizontal direction changed by the predetermined value;
an initial value data reproducing unit that reads the data from the second memory for every scan line;
decoding means for decoding the compressed coded data for the every class of the gradation correction value; and
a timing signal generating unit that generates a timing signal for controlling the first memory, the second memory, the initial value data reproducing unit, and the decoding means at a predetermined timing,
wherein the initial value data reproducing unit reproduces the initial value data sequentially read from the second memory for the every scan line,
the decoding means decodes the data indicating whether the correction value between the pixels in the horizontal direction for the every class of the gradation correction value is increased or reduced by the predetermined value, the data sequentially read from the second memory based on the reproduced initial value data, and the compressed coded data represented by data indicating the number of pixels in the horizontal direction changed by the predetermined value, and reproduces correction data, and a correction table value of the first memory is rewritten as the gradation correction data intrinsic to the each pixel for every pixel clock or synchronously with a pixel clock based on the correction data, and
the image display apparatus further comprises a correction unit that converts an image signal input to the first memory into a table value corresponding to a correction table in the first memory for the every pixel clock, and that executes a correction.

8. An image display apparatus according to claim 5, further comprising:
a third memory having rewritable data,
wherein an information processing unit constituted to be able to execute an operation processing rewrites the data held in the second memory based on the data of the third memory.

9. An image display apparatus according to any one of claim 6, wherein
the addition/subtraction unit includes:
a data holding unit that holds gradation correction initial value data on one scan line before for one line period; and
a control timing generating unit that controls the second memory,
at least in the second memory, a data area from which the gradation correction data can be read before timing of reading the gradation correction data on a first scan line, and a data area from which a differential value of the initial value data on the line from at least one change value and data indicating whether the change value is subjected to an increase or a reduction can be read as the initial value data on one line before, for a second line to a final line are constituted,
on the first scan line, correction is executed by initial values of memory addresses corresponding to the first scan line and inter-pixel correction data on the memory addresses corresponding to the first scan line,
on each of scan lines following the first scan line, the correction is executed by initial values obtained by performing an operation between the initial value data on one line before and initial value differential data on the initial value data on the memory addresses of the scan line, and the inter-pixel correction data on the memory addresses corresponding to the scan line.

10. An image display apparatus according to claim 6, wherein
a memory address for storing a correction value corresponding to a scan line of each of the class of the second memory has a memory address configuration in which a correction value of a pixel sequence on the each scan line to be read following an initial value data address for the correction value on the each scan line is stored as differential data on typical values of predetermined correction values for every plural pixels, wherein
correction value of pixel sequence of each of the scan line prestored as differential value data between the initial value of each of the scan line and the typical value of the correction value for every plural pixels are stored in the second memory,
in displaying image, the correction is executed for every plural pixels in the horizontal direction of the each scan line based on the initial value data on the correction value stored in the second memory on the each scan line, and the correction value data on the pixel sequence on the each scan line stored as the differential value data on the typical values of the correction values for the every plural pixels.

11. An image display apparatus according to claim 6, wherein
memory addresses for the each class of the second memory has a data address configuration in which an initial value data address for storing the initial value of the correction value on the each scan line for the each scan line and a pixel correction value data address read subsequent to the initial value data address for storing a correction differential value of a pixel sequence on the each scan line as data as data common to every n scan lines, where n is an integer equal to or greater than 2,
the initial value data common to the every n scan lines and pixel correction value data as a correction value of the pixel sequence on the each scan line are prestored in the second memory, and
in displaying image, the pixel correction data constituted by the initial value data and the correction value of the pixel sequence on the each scan line is read from the second memory n times for the every n scan lines, the correction data is reproduced by a predetermined processing, and a correction processing is executed based on a difference correction value to be common to the n scan lines.

12. An image display apparatus according to claim 11, wherein
memory addresses for the each class of the second memory has a data address configuration in which an initial value data address for storing the initial value of the correction value on the each scan line for the each scan line and a pixel correction value data address read subsequent to the initial value data address for storing a correction differential value of a pixel sequence on the each scan line as data of correction differential value for every plural pixels are stored as data common to every n scan lines, where n is an integer equal to or greater than 2,
the initial value data common to the every n scan lines and pixel correction value data as a correction value of the pixel sequence on the each scan line are prestored in the second memory as correction value data common to every plural pixels, and
in displaying image, the pixel correction value data constituted by the initial value data and the correction value of the pixel sequence on the each scan line is read from the second memory n times for the every n scan lines, the initial value data and the correction differential value for every plural pixels are reproduced, and a correction processing is executed based on a correction value to be common to the plural pixels and the n scan lines.

13. An image display apparatus according to claim 11, wherein
the memory addresses for the each class of the second memory has the data address configuration in which the initial value data address for storing the initial value of the correction value on the each scan line for the each scan line and the pixel correction value data address read subsequent to the initial value data address, for storing the correction data obtained by coding a value indicated by the number of pixels for which the correction value of the pixel sequence in the horizontal direction is changed by a predetermined value or indicated by a time for every plural pixels, are stored as the common data to the every n scan lines, where n is the integer equal to or greater than 2,
the initial value data common to the every n scan lines and the correction value data obtained by coding the value indicated by the number of pixels for which the correction value of the pixel sequence on the scan line in the horizontal direction is changed by the predetermined value or indicated by the time for the every plural pixels are prestored, as typical correction value data common to a plurality of scan lines, in the second memory, and
in displaying image, the initial value data on the each scan line the correction value data and the correction differential value data obtained by coding the value indicated by the number of pixels for which the correction value of the pixel sequence in the horizontal direction is changed by the predetermined value or indicated by the time for the every plural pixels are reproduced by the correction data reproducing unit n times for each scan line period, and the correction processing is executed for the every plural scan lines.

14. An image display apparatus according to claim 4, wherein
the correction data held in the first memory is the correction data for correcting an image signal for designating a brightness or color of a predetermined pixel, and correction data corresponding to a plurality of gradation levels which the image signal possibly has are simultaneously stored in the first memory.
